(19) United States
(12) Patent Application Publication
(10) Pub. No.: US 2018/0204381 A1
(43) Pub. Date: Jul. 19, 2018

(54) IMAGE PROCESSING APPARATUS FOR GENERATING VIRTUAL VIEWPOINT IMAGE AND METHOD THEREFOR

(71) Applicant: CANON KABUSHIKI KAISHA, Tokyo (JP)

(72) Inventors: Tomotoshi Kanatsu, Tokyo (JP); Kitahiro Kaneda, Yokohama-shi (JP); Kenichi Fujii, Tokyo (JP); Hiroaki Sato, Tokyo (JP)

(21) Appl. No.: 15/868,795

(22) Filed: Jan. 11, 2018

(30) Foreign Application Priority Data
Jan. 13, 2017 (JP) 2017-004681

(51) Int. Cl. G06T 19/00; G06T 15/20; G06T 7/246

(52) U.S. Cl. CPC G06T 19/003; H04N 13/0282; G06T 15/20; H04N 5/23203; G06T 2207/10016; G06T 2207/30241; G06T 2207/20081; G06T 7/248

(57) ABSTRACT

An image processing apparatus includes a generation unit configured to generate a virtual viewpoint image corresponding to a virtual viewpoint based on images captured from a plurality of viewpoints, a storage unit configured to store, for each of a plurality of virtual viewpoints, a trajectory of previous movement of the each virtual viewpoint and information about a virtual viewpoint image corresponding to the each virtual viewpoint, a search unit configured to search for a trajectory associated with a current virtual viewpoint image from previous trajectories stored in the storage unit, and obtain a search result comprising a plurality of trajectories, an evaluation unit configured to make an evaluation of the search result obtained from the search for the associated trajectory conducted by the search unit, and a selection unit configured to select, based on the evaluation, at least one trajectory from the plurality of trajectories contained in the search result.

### BACKGROUND

### Field

Aspects of the present disclosure generally relate to a technique to generate a virtual viewpoint image.

### Description of the Related Art

There is a method for generating a virtual viewpoint image, which is viewed from a virtual viewpoint different from a viewpoint used for actual image capturing, based on a plurality of images captured from a plurality of different viewpoints. Japanese Patent Application Laid-Open No. 2016-24490 discusses a method which enables the user to set a virtual viewpoint to an intended position and orientation by moving and rotating an icon corresponding to a virtual imaging unit on a display, with an operation on an operation unit.

However, the method discussed in Japanese Patent Application Laid-Open No. 2016-24490 requires the user to personally consider and set the position and orientation of a virtual viewpoint and, thus, does not enable the user to easily obtain a desired virtual viewpoint image.

### SUMMARY

According to various embodiments of the present disclosure, an image processing apparatus includes a generation unit configured to generate a virtual viewpoint image corresponding to a virtual viewpoint based on images captured from a plurality of viewpoints, a storage unit configured to store, for each of a plurality of virtual viewpoints, a trajectory of previous movement of the each virtual viewpoint and information about a virtual viewpoint image corresponding to the each virtual viewpoint, a search unit configured to search for a trajectory associated with a current virtual viewpoint image from previous trajectories stored in the storage unit, and obtain a search result comprising a plurality of trajectories, an evaluation unit configured to make an evaluation of the search result obtained from the search for the associated trajectory conducted by the search unit, and a selection unit configured to select, based on the evaluation, at least one trajectory from among the plurality of trajectories contained in the search result.

Further features will become apparent from the following description of exemplary embodiments with reference to the attached drawings.

### BRIEF DESCRIPTION OF THE DRAWINGS

FIG. 1 is a diagram illustrating a configuration of an image processing system.

FIG. 2 is a block diagram illustrating a functional configuration of a camera adapter.

FIG. 3 is a block diagram illustrating a configuration of an image processing unit.

FIG. 4 is a block diagram illustrating a functional configuration of a front-end server.

FIG. 5 is a block diagram illustrating a configuration of a data input control unit of the front-end server.

FIG. 6 is a block diagram illustrating a functional configuration of a database.

FIG. 7 is a block diagram illustrating a functional configuration of a back-end server.

FIG. 8 is a block diagram illustrating a functional configuration of a virtual camera operation user interface (UI).

FIG. 9 is a diagram illustrating a connection configuration of an end-user terminal.

FIG. 10 is a block diagram illustrating a functional configuration of the end-user terminal.

FIG. 11 is a flowchart illustrating an overall workflow.

FIG. 12 is a flowchart illustrating a confirmation workflow during image capturing at the side of a control station.

FIG. 13 is a flowchart illustrating a user workflow during image capturing at the side of the virtual camera operation user UI.

FIG. 14 is a flowchart illustrating processing for generating three-dimensional model information.

FIG. 15 is a diagram illustrating a gaze point group.

FIG. 16 is a flowchart illustrating file generation processing.

FIGS. 17A, 17B, and 17C are diagrams illustrating examples of captured images.

FIGS. 18A, 18B, 18C, 18D, and 18E are flowcharts illustrating foreground and background separation.

FIG. 19 is a sequence diagram illustrating processing for generating a virtual camera image.

FIGS. 20A and 20B are diagrams illustrating virtual cameras.

FIGS. 21A and 21B are flowcharts illustrating processing for generating a live image.

FIG. 22 is a flowchart illustrating the details of operation input processing performed by the operator.

FIG. 23 is a flowchart illustrating the details of processing for estimating a recommended operation.

FIG. 24 is a flowchart illustrating processing for generating a replay image.

FIG. 25 is a flowchart illustrating selection of a virtual camera path.

FIG. 26 is a diagram illustrating an example of a screen which is displayed by an end-user terminal.

FIG. 27 is a flowchart illustrating processing performed by an application management unit concerning manual maneuvering.

FIG. 28 is a flowchart illustrating processing performed by the application management unit concerning automatic maneuvering.

FIG. 29 is a flowchart illustrating rendering processing.

FIG. 30 is a flowchart illustrating processing for generating a foreground image.

FIG. 31 is a flowchart illustrating a setting list which is generated in a post-installation workflow.

FIG. 32 is a block diagram illustrating a hardware configuration of the camera adapter.

### DESCRIPTION OF THE EMBODIMENTS

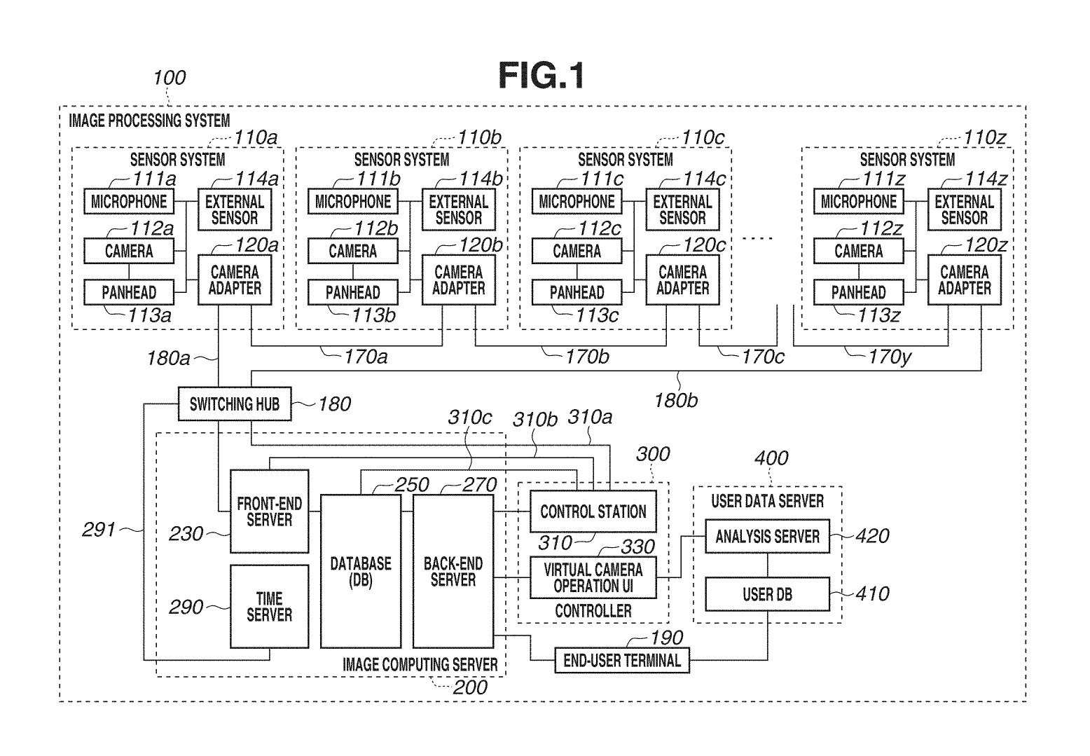

A system which performs image capturing and sound collection using a plurality of cameras and a plurality of microphones installed at a facility, such as a sports arena (stadium) or a concert hall, is described with reference to the system configuration diagram of FIG. 1. An image processing system 100 includes a sensor system 110a to a sensor system 110z, an image computing server 200, a controller 300, a switching hub 180, a user data server 400, and an end-user terminal 190.

The user data server 400 includes a user database (DB) 410, which accumulates user data related to end-users, and an analysis server 420, which analysis the user data. The user data includes, for example, information directly acquired from the end-user terminal 190, such as operation information about an operation performed on the end-user terminal 190, attribute information registered with the end-user terminal 190, or sensor information. Alternatively, the user data can be indirect information, such as a statement on a web page or social media published by an end-user via the Internet. Furthermore, the user data can contain, besides the end-user's own information, information about a social situation to which the end-user belongs or environmental information about, for example, weather and temperature. The user database 410 can be a unit of closed storage device, such as a personal computer (PC), or a dynamic unit of information obtained by searching for related information in real time from the Internet. Moreover, the analysis server 420 can be a server which performs what is called big data analysis using, as a source, a wide variety of extensive pieces of information directly or indirectly related to end-users.

The controller 300 includes a control station 310 and a virtual camera operation user interface (UI) 330. The control station 310 performs, for example, management of operation conditions and parameter setting control with respect to the blocks which constitute the image processing system 100 via networks 310a to 310c, 180a, 180b, and 170a to 170y. Here, each network can be Gigabit Ethernet (GbE) or 10 Gigabit Ethernet (10 GbE) compliant with Institute of Electrical and Electronics Engineers (IEEE) standards as Ethernet or can be configured with, for example, InfiniBand as an interconnect and the Industrial Internet used in combination. Furthermore, each network is not limited to these, but can be another type of network.

First, an operation of transmitting 26 sets of images and sounds output from the sensor system 110a to the sensor system 110z from the sensor system 110z to the image computing server 200 is described. In the image processing system 100 according to the present exemplary embodiment, the sensor system 110a to the sensor system 110z are interconnected via a daisy chain.

In the present exemplary embodiment, unless specifically described, each of 26 sets of systems, i.e., the sensor system 110a to the sensor system 110z, is referred to as a “sensor system 110” without any distinction. Similarly, devices included in each sensor system 110 are also referred to as a “microphone 111”, a “camera 112, a “panhead 113”, an “external sensor 114”, and a “camera adapter 120” without any distinction unless specifically described. Furthermore, although the number of sensor systems is described as 26 sets, this is merely an example, and the number of sensor systems is not limited to this. Moreover, a plurality of sensor systems 110 does not need to have the same configuration, but can be configured with, for example, devices of the respective different types.

Furthermore, in the description of the present exemplary embodiment, unless otherwise stated, the term “image” includes the concepts of “moving image” and “still image”. In other words, the image processing system 100 according to the present exemplary embodiment is able to process every one of a still image and a moving image. Moreover, while, in the present exemplary embodiment, an example in which virtual viewpoint content that is provided by the image processing system 100 includes a virtual viewpoint image and a virtual viewpoint sound is mainly described, the present exemplary embodiment is not limited to this example. For example, any sound does not need to be included in the virtual viewpoint content. Moreover, for example, a sound included in virtual viewpoint content can be a sound collected by a microphone situated closest to a virtual viewpoint. Additionally, while, in the present exemplary embodiment, for ease of description, a description about sounds is partially omitted, basically, an image and a sound are assumed to be concurrently processed.

The sensor system 110a to the sensor system 110z include a camera 112a to a camera 112z, respectively. In other words, the image processing system 100 includes a plurality of cameras 112 arranged to perform image capturing of a subject from a plurality of directions. Furthermore, while the plurality of cameras 112 is described with use of the same reference character, the performance or type thereof can be varied. The plurality of sensor systems 110 is interconnected via a daisy chain. This connection configuration enables reducing the number of connection cables or saving wiring work in the case of using a large amount of capacity of image data caused by a high-resolution conversion to, for example, 4K or 8K or a high frame rate conversion of captured images. Furthermore, the connection configuration is not limited to this, and the sensor systems 110a to 110z can be a network configuration of the star type in which transmission and reception of data between the sensor systems 110 are performed via the switching hub 180.

Moreover, while, in FIG. 1, a configuration in which all of the sensor systems 110a to 110z are connected in cascade in such a way as to form a daisy chain is illustrated, the present exemplary embodiment is not limited to this configuration. For example, a plurality of sensor systems 110 can be divided into some groups and sensor systems 110 of each group obtained as a unit by division can be interconnected via a daisy chain. Then, a camera adapter 120 which serves as the final end of units of division can be connected to the switching hub 180 so as to enable an image to be input to the image computing server 200. Such a configuration is particularly effective in a stadium. For example, a case in which a stadium is constructed with a plurality of floors and the sensor systems 110 are installed in each floor can be considered. This case enables an image to be input to the image computing server 200 with respect to each floor or each semiperimeter of the stadium and also enables attaining the simplification of installation even in a place where wiring of connecting all of the sensor systems 110 via a single daisy chain is difficult and improving the flexibility of systems.

Furthermore, control of image processing performed at the image computing server 200 is switched according to whether the number of camera adapters 120 which are interconnected via a daisy chain and perform inputting of images to the image computing server 200 is one or two or more. In other words, control is switched according to whether the sensor systems 110 are divided into a plurality of groups. In a case where only one camera adapter 120 performs inputting of an image, since a stadium entire-perimeter image is generated while image transmission is performed with use of daisy chain connection, the timings at which pieces of image data for the entire perimeter are fully acquired by the image computing server 200 are in synchronization. In other words, if the sensor systems 110 are not divided into groups, synchronization is attained.

However, in a case where a plurality of camera adapters 120 performs inputting of images, a case in which the delay occurring from when an image is captured until the image is input to the image computing server 200 varies with lanes (paths) of the daisy chain can be considered. In other words, in a case where the sensor systems 110 are divided into groups, the timings at which pieces of image data for the entire perimeter are input to the image computing server 200 may be out of synchronization. Therefore, in the image computing server 200, it is necessary to perform later-stage image processing while checking for aggregation of pieces of image data by synchronization control to perform synchronization after waiting for pieces of image data for the entire perimeter to be fully acquired.

In the present exemplary embodiment, the sensor system 110a includes a microphone 111a, a camera 112a, a panhead 113a, an external sensor 114a, and a camera adapter 120a. Furthermore, the sensor system 110a is not limited to this configuration, but only needs to include at least one camera adapter 120a and one camera 112a or one microphone 111a. Furthermore, for example, the sensor system 110a can be configured with one camera adapter 120a and a plurality of cameras 112a, or can be configured with one camera 112a and a plurality of camera adapters 120a. Thus, a plurality of cameras 112 and a plurality of camera adapters 120 included in the image processing system 100 are provided in the ratio of N to M in number (N and M each being an integer of 1 or more).

Moreover, the sensor system 110 can include a device other than the microphone 111a, the camera 112a, the panhead 113a, and the camera adapter 120a. Additionally, the camera 112 and the camera adapter 120 can be configured integrally with each other. Besides, at least a part of the function of the camera adapter 120 can be included in a front-end server 230. In the present exemplary embodiment, each of the sensor system 110b to the sensor system 110z has a configuration similar to that of the sensor system 110a, and is, therefore, omitted from description. Furthermore, each sensor system 110 is not limited to the same configuration as that of the sensor system 110a, but the sensor systems 110 can have respective different configurations.

A sound collected by the microphone 111a and an image captured by the camera 112a are subjected to image processing, which is described below, by the camera adapter 120a and are then transmitted to the camera adapter 120b of the sensor system 110b via a daisy chain 170a. Similarly, the sensor system 110b transmits, to the sensor system 110c, a collected sound and a captured image together with the image and sound acquired from the sensor system 110a. According to the above-mentioned operation being performed, the images and sounds acquired by the sensor systems 110a to 110z are transferred from the sensor system 110z to the switching hub 180 via a network 180b, and are then transmitted to the image computing server 200. Furthermore, each of the cameras 112a to 112z and a corresponding one of the camera adapters 120a to 120z can be configured not in separate units but in an integrated unit with the same chassis. In that case, each of the microphones 111a to 111z can be incorporated in each integrated camera 112 or can be connected to the outside of each integrated camera 112.

Next, a configuration and an operation of the image computing server 200 are described. The image computing server 200 in the present exemplary embodiment performs processing of data acquired from the sensor system 110z. The image computing server 200 includes a front-end server 230, a database 250 (hereinafter also referred to as “DB”), a back-end server 270, and a time server 290.

The time server 290 has the function to deliver time and a synchronization signal, and delivers time and a synchronization signal to the sensor system 110a to the sensor system 110z via the switching hub 180. The camera adapters 120a to 120z, which have received time and a synchronization signal, genlock the cameras 112a to 112z based on the time and the synchronization signal, thus performing image frame synchronization. Thus, the time server 290 synchronizes image capturing timings of a plurality of cameras 112. With this, the image processing system 100 is able to generate a virtual viewpoint image based on a plurality of captured images captured at the same timing, and is, therefore, able to prevent or reduce a decrease in quality of a virtual viewpoint image caused by the variation of timings. Furthermore, while, in the present exemplary embodiment, the time server 290 manages time and a synchronization signal for a plurality of cameras 112, the present exemplary embodiment is not limited to this, but each camera 112 or each camera adapter 120 can independently perform processing for time and a synchronization signal.

The front-end server 230 reconstructs a segmented transmission packet from the image and sound acquired from the sensor system 110z to convert the data format thereof, and then writes the converted data in the database 250 according to the identifiers of the cameras, data types, and frame numbers. The back-end server 270 receives a designation of a viewpoint from the virtual camera operation UI 330, reads corresponding image data and sound data from the database 250 based on the received viewpoint, and performs rendering processing on the read data, thus generating a virtual viewpoint image.

Furthermore, the configuration of the image computing server 200 is not limited to this. For example, at least two of the front-end server 230, the database 250, the back-end server 270, and the user data server 400 can be configured in a single integrated unit. Moreover, at least one of the front-end server 230, the database 250, the back-end server 270, and the user data server 400 can include a plurality of units. Moreover, a device other than the above-mentioned devices can be included at an optional position inside the image computing server 200. Additionally, at least a part of the function of the image computing server 200 can be included in the end-user terminal 190 or the virtual camera operation UI 330.

The image subjected to rendering processing is transmitted from the back-end server 270 to the end-user terminal 190, so that the user who operates the end-user terminal 190 can view an image and listen to a sound according to the designation of a viewpoint. Specifically, the back-end server 270 generates virtual viewpoint content which is based on captured images captured by a plurality of cameras 112 (multi-viewpoint images) and viewpoint information. More specifically, the back-end server 270 generates virtual viewpoint content, for example, based on image data in a predetermined area extracted by a plurality of camera adapters 120 from the captured images captured by a plurality of cameras 112 and a viewpoint designated by the user operation. Then, the back-end server 270 supplies the generated virtual viewpoint content to the end-user terminal 190. The end-user terminal 190 can include a terminal which only receives virtual viewpoint content acquired by the operation of another end-user terminal. For example, the end-user terminal 190 can be a terminal which unilaterally receives virtual viewpoint content generated by a broadcasting company, as with a television receiver. Details of extraction of a predetermined area by the camera adapter 120 are described below. Furthermore, in the present exemplary embodiment, virtual viewpoint content is content generated by the image computing server 200, and, particularly, a case in which virtual viewpoint content is generated by the back-end server 270 is mainly described. However, the present exemplary embodiment is not limited to this, but virtual viewpoint content can be generated by a device other than the back-end server 270 included in the image computing server 200, or can be generated by the controller 300 or the end-user terminal 190.

The virtual viewpoint content in the present exemplary embodiment is content including a virtual viewpoint image as an image which would be obtained by performing image capturing of a subject from a virtually-set viewpoint. In other words, the virtual viewpoint image can be said to be an image representing an apparent view from a designated viewpoint. The virtually-set viewpoint (virtual viewpoint) can be designated by the user, or can be automatically designated based on, for example, a result of image analysis. In other words, an optional viewpoint image (free viewpoint image) corresponding to a viewpoint optionally designated by the user is included in the virtual viewpoint image. Moreover, an image corresponding to a viewpoint designated by the user from among a plurality of candidates or an image corresponding to a viewpoint automatically designated by the apparatus is included in the virtual viewpoint image.

Furthermore, while, in the present exemplary embodiment, a case in which sound data (audio data) is included in virtual viewpoint content is mainly described, the sound data does not necessarily need to be included therein. Moreover, the back-end server 270 can perform compression coding of a virtual viewpoint image according to a coding method, such as H.264 or High Efficiency Video Coding (HEVC), and then transmit the coded image to the end-user terminal 190 with use of MPEG-DASH protocol. Additionally, the virtual viewpoint image can be transmitted to the end-user terminal 190 without being compressed. Particularly, the former method, which performs compression coding, is assumed to be used for a smartphone or a tablet as the end-user terminal 190, and the latter method is assumed to be used for a display capable of displaying an uncompressed image. In other words, it should be noted that an image format can be switched according to types of the end-user terminal 190. Furthermore, the transmission protocol for an image is not limited to MPEG-DASH protocol, but, for example, HTTP Live Streaming (HLS) or other methods can be used.

In the above-described way, the image processing system 100 includes three functional domains, i.e., a video collection domain, a data storage domain, and a video generation domain. The video collection domain includes the sensor system 110a to the sensor system 110z, the data storage domain includes the database 250, the front-end server 230, and the back-end server 270, and the video generation domain includes the virtual camera operation UI 330 and the end-user terminal 190. Furthermore, the present exemplary embodiment is not limited to this configuration, and, for example, the virtual camera operation UI 330 can directly acquire an image from the sensor system 110a to the sensor system 110z. However, in the present exemplary embodiment, not a method of directly acquiring an image from the sensor system 110a to the sensor system 110z but a method of locating a data storage function midway is employed. Specifically, the front-end server 230 converts image data or sound data generated by the sensor system 110a to the sensor system 110z and meta-information about such data into a common schema and a data type for the database 250. With this, even if the cameras 112 of the sensor system 110a to the sensor system 110z are changed to cameras of another type, a difference caused by the change is absorbed by the front-end server 230 and is thus able to be registered in the database 250. This enables reducing the possibility that, in a case where the cameras 112 are changed to cameras of another type, the virtual camera operation UI 330 would not appropriately operate.

Furthermore, the virtual camera operation UI 330 is configured not to directly access the database 250 but to access the database 250 via the back-end server 270. While common processing concerning image generation processing is performed by the back-end server 270, a difference component of an application concerning an operation UI is performed by the virtual camera operation UI 330. With this, in developing a virtual camera operation UI 330, effort can be focused on development about a function request of a UI operation device or a UI used to operate a virtual viewpoint image intended to be generated. Moreover, the back-end server 270 is also able to add or delete common processing concerning image generation processing in response to a request from the virtual camera operation UI 330. This enables responding flexibly to a request from the virtual camera operation UI 330.

In this way, in the image processing system 100, a virtual viewpoint image is generated by the back-end server 270 based on image data that is based on image capturing performed by a plurality of cameras 112 used to perform image capturing of a subject from a plurality of directions. Furthermore, the image processing system 100 in the present exemplary embodiment is not limited to a physical configuration described above, but can be configured in a logical manner. Moreover, while, in the present exemplary embodiment, a technique which generates a virtual viewpoint image based on images captured by cameras 112 is described, the present exemplary embodiment can also be applied to, for example, the case of generating a virtual viewpoint image based on images generated by, for example, computer graphics without using captured images.

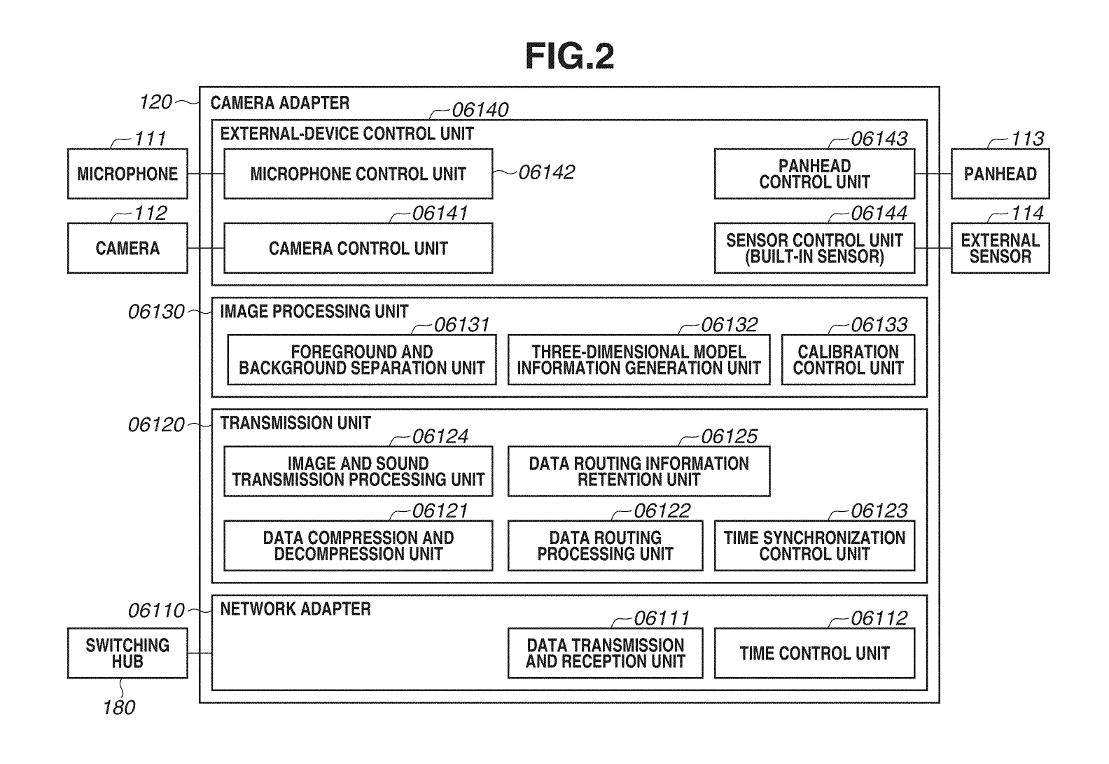

Next, functional block diagrams of the respective nodes (the camera adapter 120, the front-end server 230, the database 250, the back-end server 270, the virtual camera operation UI 330, and the end-user terminal 190) in the system illustrated in FIG. 1 are described. First, the functional block diagram of the camera adapter 120 is described with reference to FIG. 2. The camera adapter 120 is configured with a network adapter 06110, a transmission unit 06120, an image processing unit 06130, and an external-device control unit 06140. The network adapter 06110 is configured with a data transmission and reception unit 06111 and a time control unit 06112.

The data transmission and reception unit 06111 performs data communication with the other camera adapters 120, the front-end server 230, the time server 290, and the control station 310 via the daisy chain 170, the network 291, and the network 310a. For example, the data transmission and reception unit 06111 outputs, to another camera adapter 120, a foreground image and a background image separated by a foreground and background separation unit 06131 from a captured image obtained by the camera 112. The camera adapter 120 serving as an output destination is a next camera adapter 120 in an order previously determined according to processing performed by a data routing processing unit 06122 among the camera adapters 120 included in the image processing system 100. Since each camera adapter 120 outputs a foreground image and a background image, a virtual viewpoint image is generated based on foreground images and background images captured from a plurality of viewpoints. Furthermore, a camera adapter 120 which outputs a foreground image separated from the captured image but does not output a background image can be present.

The time control unit 06112, which is compliant with, for example, Ordinary Clock of the IEEE 1588 standard, has the function to store a time stamp of data transmitted or received with respect to the time server 290 and performs time synchronization with the time server 290. Furthermore, time synchronization with the time server 290 can be implemented according to not only the IEEE 1588 standard but also another standard, such as EtherAVB, or a unique protocol. While, in the present exemplary embodiment, a network interface card (NIC) is uses as the network adapter 06110, the present exemplary embodiment is not limited to using the NIC, but can use another similar interface. Furthermore, the IEEE 1588 standard is updated as a revised standard protocol such as IEEE 1588-2002 and IEEE 1588-2008, and the latter is also called “Precision Time Protocol Version 2 (PTPv2)”.

The transmission unit 06120 has the function to control transmission of data to, for example, the switching hub 180 performed via the network adapter 06110, and is configured with the following functional units. A data compression and decompression unit 06121 has the function to perform compression on data received via the data transmission and reception unit 06111 while applying a predetermined compression method, compression ratio, and frame rate thereto and the function to decompress the compressed data. The data routing processing unit 06122 has the function to determine routing destinations of data received by the data transmission and reception unit 06111 and data processed by the image processing unit 06130 with use of data retained by a data routing information retention unit 06125, which is described below. Moreover, the data routing processing unit 06122 has also the function to transmit the data to the determined routing destinations. Determining camera adapters 120 corresponding to cameras 112 focused on the same gaze point as the routing destinations is advantageous to performing image processing because an image frame correlation between the cameras 112 is high. The order of the camera adapters 120 which output foreground images and background images in a relay method in the image processing system 100 is determined according to determinations made by the respective data routing processing units 06122 of a plurality of camera adapters 120.

A time synchronization control unit 06123, which is compliant with Precision Time Protocol (PTP) in the IEEE 1588 standard, has the function to perform processing concerning time synchronization with the time server 290. Furthermore, the time synchronization control unit 06123 can perform time synchronization using not PTP but another similar protocol. An image and sound transmission processing unit 06124 has the function to generate a message for transferring image data or sound data to another camera adapter 120 or the front-end server 230 via the data transmission and reception unit 06111. The message includes image data or sound data and meta-information about each piece of data. The meta-information in the present exemplary embodiment includes a time code or sequence number obtained when image capturing or sound sampling was performed, a data type, and an identifier indicating an individual camera 112 or an individual microphone 111. Furthermore, image data or sound data to be transmitted can be data compressed by the data compression and decompression unit 06121. Moreover, the image and sound transmission processing unit 06124 receives a message from another camera adapter 120 via the data transmission and reception unit 06111. Then, the image and sound transmission processing unit 06124 restores data information fragmented in a packet size prescribed by the transmission protocol to image data or sound data according to the data type included in the message. Furthermore, in a case where data to be restored is the compressed data, the data compression and decompression unit 06121 performs decompression processing. The data routing information retention unit 06125 has the function to retain address information for determining a transmission destination of data to be transmitted or received by the data transmission and reception unit 06111. The routing method is described below.

The image processing unit 06130 has the function to perform processing on image data captured by the camera 112 under the control of a camera control unit 06141 and image data received from another camera adapter 120, and is configured with the following functional units.

The foreground and background separation unit 06131 has the function to separate image data captured by the camera 112 into a foreground image and a background image. More specifically, each of a plurality of camera adapters 120 operates as an image processing apparatus which extracts a predetermined area from a captured image obtained by a corresponding camera 112 among a plurality of cameras 112. The predetermined area is, for example, a foreground image obtained as a result of object detection performed on the captured image, and, according to this extraction, the foreground and background separation unit 06131 separate the captured image into a foreground image and a background image. Furthermore, the term “object” refers to, for example, a person. However, the object can be a specific person (for example, player, manager (coach), and/or umpire (judge)), or can be an object with an image pattern previously determined, such as a ball or a goal. Furthermore, a moving body can be detected as the object. Performing processing while separating a foreground image including a significant object, such as a person, from a background area not including such an object enables improving the quality of an image of a portion corresponding to the above-mentioned object of a virtual viewpoint image generated in the image processing system 100. Moreover, each of a plurality of cameras 120 performing separation into a foreground and a background enables dispersing a load in the image processing system 100 including the plurality of cameras 112. Additionally, the predetermined area is not limited to a foreground image, but can be, for example, a background image.

A three-dimensional model information generation unit 06132 has the function to generate image information concerning a three-dimensional model with use of, for example, the principle of a stereo camera using a foreground image separated by the foreground and background separation unit 06131 and a foreground image received from another camera adapter 120. A calibration control unit 06133 has the function to acquire image data required for calibration from the camera 112 via the camera control unit 06141 and transmit the acquired image data to the front-end server 230, which performs computation processing concerning calibration. The calibration in the present exemplary embodiment is processing for associating and matching parameters respectively concerning a plurality of cameras 112. As the calibration, for example, processing for making an adjustment in such a manner that the world coordinate systems respectively retained by the installed cameras 112 coincide with each other or color correction processing for preventing any variation of colors for each camera 112 is performed. Furthermore, the specific processing content of the calibration is not limited to this.

Moreover, while, in the present exemplary embodiment, computation processing concerning calibration is performed by the front-end server 230, the node which performs the computation processing is not limited to the front-end server 230. For example, the computation processing can be performed by another node, such as the control station 310 or the camera adapter 120 (including another camera adapter 120). Additionally, the calibration control unit 06133 has the function to perform calibration in the process of image capturing according to a previously-set parameter with respect to image data acquired from the camera 112 via the camera control unit 06141. The external-device control unit 06140 has the function to control a device connected to the camera adapter 120, and is configured with the following functional units.

The camera control unit 06141 is connected to the camera 112 and has the function to perform, for example, control of the camera 112, acquisition of a captured image, supply of a synchronization signal, and setting of time. The control of the camera 112 includes, for example, setting and reference of image capturing parameters (for example, the number of pixels, color depth, frame rate, and setting of white balance), acquisition of the status of the camera 112 (for example, image capturing in progress, in pause, in synchronization, and in error), starting and stopping of image capturing, and focus adjustment. Furthermore, while, in the present exemplary embodiment, focus adjustment is performed via the camera 112, in a case where a detachable lens is mounted on the camera 112, the camera adapter 120 can be connected to the lens to directly adjust the lens. Moreover, the camera adapter 120 can perform lens adjustment, such as zooming, via the camera 112. The supply of a synchronization signal is performed by the time synchronization control unit 06123 supplying image capturing timing (a control clock) to the camera 112 with use of time synchronized with the time server 290. The setting of time is performed by the time synchronization control unit 06123 supplying time synchronized with the time server 290 as a time code compliant with, for example, the format of Society of Motion Picture and Television Engineers (SMPTE) 12M. With this, the supplied time code is appended to image data received from the camera 112. Furthermore, the format of the time code is not limited to SMPTE 12M, but can be another format. Moreover, the camera control unit 06141 can be configured not to supply a time code to the camera 112 but to directly append a time code to image data received from the camera 112.

A microphone control unit 06142 is connected to the microphone 111 and has the function to perform, for example, control of the microphone 111, starting and stopping of sound collection, and acquisition of collected sound data. The control of the microphone 111 includes, for example, gain adjustment and status acquisition. Moreover, as with the camera control unit 06141, the microphone control unit 06142 supplies timing for sound sampling and a time code to the microphone 111. As clock information serving as timing for sound sampling, time information output from the time server 290 is converted into, for example, a word clock of 48 kHz and is then supplied to the microphone 111. A panhead control unit 06143 is connected to the panhead 113 and has the function to perform control of the panhead 113. The control of the panhead 113 includes, for example, panning and tilting control and status acquisition.

A sensor control unit 06144 is connected to the external sensor 114 and has the function to acquire sensor information sensed by the external sensor 114. For example, in a case where a gyro sensor is used as the external sensor 114, the sensor control unit 06144 is able to acquire information indicating vibration. Then, with use of vibration information acquired by the sensor control unit 06144, the image processing unit 06130 is able to generate an image with an influence of vibration of the camera 112 reduced, prior to processing performed by the foreground and background separation unit 06131. The vibration information is used for a case where, for example, image data obtained by an 8K camera is clipped in a size smaller than the original 8K size in consideration of the vibration information and position adjustment with an image obtained by an adjacently-installed camera 112 is performed. With this, even if the frame vibration of a building is transmitted to the cameras at respective different frequencies, position adjustment is performed with use of the above function included in the camera adapter 120. As a result, an effect capable of generating image data with an influence of vibration reduced by image processing (electronically stabilized image data) and capable of reducing a processing load for position adjustment required for the number of cameras 112 in the image computing server 200 is brought about. Furthermore, the sensor of the sensor system 110 is not limited to the external sensor 114, and even a sensor incorporated in the camera adapter 120 can obtain a similar effect.

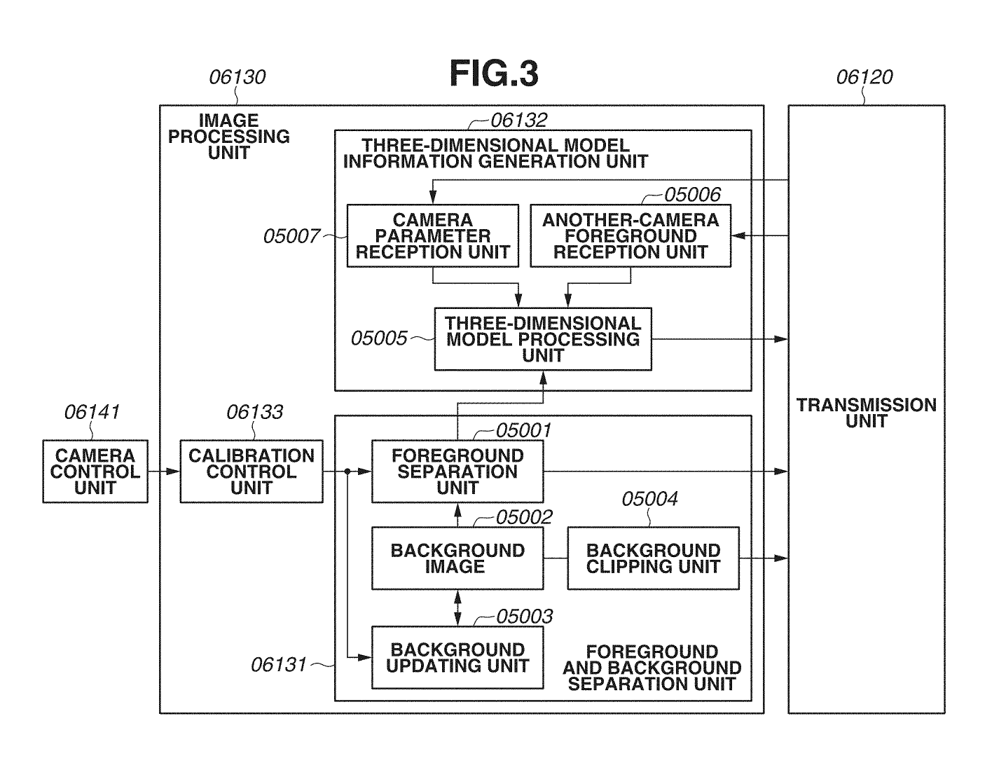

FIG. 3 is a functional block diagram of the image processing unit 06130 included in the camera adapter 120. The calibration control unit 06133 performs, with respect to an input image, for example, color correction processing for preventing any variation in color for each camera and shake (blur) correction processing (electronic image stabilization processing) for reducing image shaking (blurring) caused by vibration of each camera to stabilize the image.

Functional blocks of the foreground and background separation unit 06131 are described. A foreground separation unit 05001 performs, with respect to image data obtained by performing position adjustment on an image output from the camera 112, separation processing for a foreground image using a comparison with a background image 05002. A background updating unit 05003 generates a new background image using an image subjected to position adjustment between the background image 05002 and the camera 112 and updates the background image 05002 to the new background image. A background clipping unit 05004 performs control to clip a part of the background image 05002.

Here, the function of the three-dimensional model information generation unit 06132 is described. A three-dimensional model processing unit 05005 sequentially generates image information concerning a three-dimensional model according to, for example, the principle of a stereo camera using a foreground image separated by the foreground separation unit 05001 and a foreground image output from another camera 112 and received via the transmission unit 06120. An another-camera foreground reception unit 05006 receives a foreground image obtained by foreground and background separation in another camera adapter 120.

A camera parameter reception unit 05007 receives internal parameters inherent in a camera (for example, a focal length, an image center, and a lens distortion parameter) and external parameters representing the position and orientation of the camera (for example, a rotation matrix and a position vector). These parameters are information which is obtained by calibration processing described below, and are transmitted and set from the control station 310 to the targeted camera adapter 120. Next, the three-dimensional model processing unit 05005 generates three-dimensional model information based on outputs of the camera parameter reception unit 05007 and the another-camera foreground reception unit 05006.

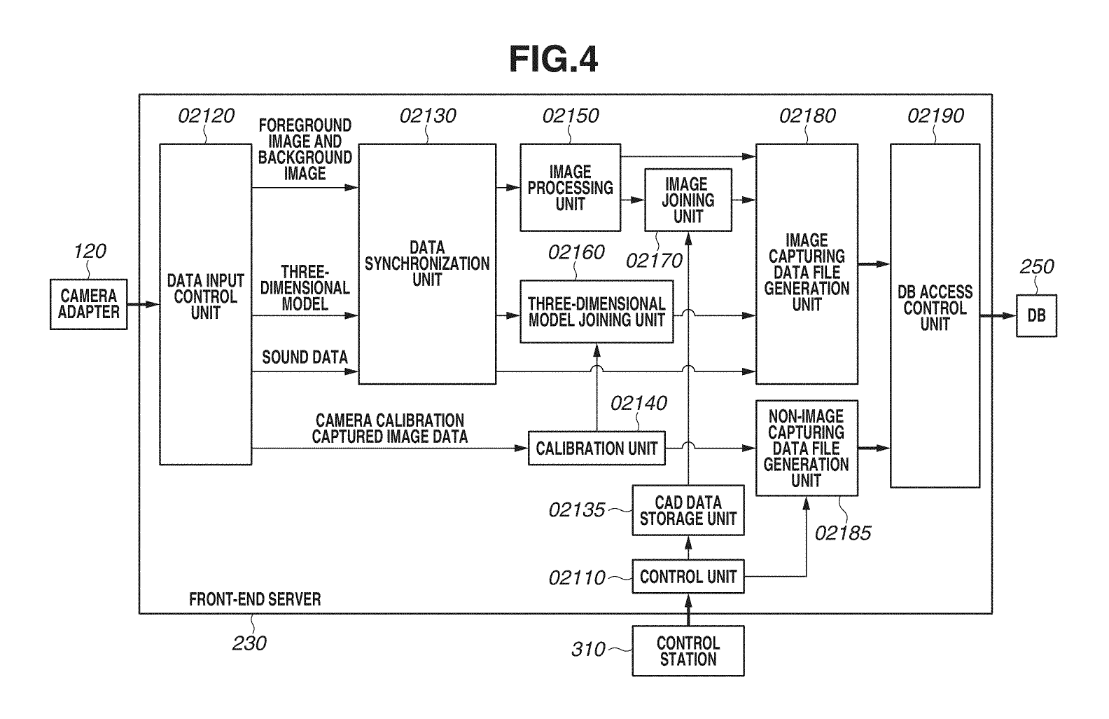

FIG. 4 is a diagram illustrating functional blocks of the front-end server 230. A control unit 02110 is configured with hardware, such as a central processing unit (CPU), a dynamic random access memory (DRAM), a storage medium, such as a hard disk drive (HDD) or a NAND memory, storing program data and various pieces of data, and Ethernet. Then, the control unit 02110 controls each functional block of the front-end server 230 and the entire system of the front-end server 230. Moreover, the control unit 02110 performs mode control to switch between operation modes, such as a calibration operation, a preparatory operation to be performed before image capturing, and an image capturing in-progress operation. Moreover, the control unit 02110 receives a control instruction issued from the control station 310 via Ethernet and performs, for example, switching of modes or inputting and outputting of data. Additionally, the control unit 02110 acquires stadium computer-aided design (CAD) data (stadium shape data) similarly from the control station 310 via a network, and transmits the stadium CAD data to a CAD data storage unit 02135 and a non-image capturing data file generation unit 02185. Furthermore, the stadium CAD data (stadium shape data) in the present exemplary embodiment is three-dimensional data indicating the shape of a stadium and only needs to be data representing a mesh model or another three-dimensional shape, and is not limited by CAD formats.

A data input control unit 02120 is network-connected to the camera adapter 120 via a communication path, such as Ethernet, and the switching hub 180. Then, the data input control unit 02120 acquires a foreground image, a background image, a three-dimensional model of a subject, sound data, and camera calibration captured image data from the camera adapter 120 via a network. Here, the foreground image is image data which is based on the foreground area of a captured image used to generate a virtual viewpoint image, and the background image is image data which is based on the background area of the captured image. The camera adapter 120 specifies a foreground area and a background area according to a result of detection of a predetermined object performed on a captured image obtained by the camera 112 and thus forms a foreground image and a background image. The predetermined object is, for example, a person. Furthermore, the predetermined object can be a specific person (for example, player, manager (coach), and/or umpire (judge)). Moreover, the predetermined object can include an object with an image pattern previously determined, such as a ball or a goal. Additionally, a moving body can be detected as the predetermined object.

Furthermore, the data input control unit 02120 transmits the acquired foreground image and background image to a data synchronization unit 02130 and transmits the camera calibration captured image data to a calibration unit 02140. Moreover, the data input control unit 02120 has the function to perform, for example, compression or decompression of the received data and data routing processing. Additionally, while each of the control unit 02110 and the data input control unit 02120 has a communication function using a network such as Ethernet, the communication function can be shared by these units. In that case, a method in which an instruction indicated by a control command output from the control station 310 and stadium CAD data are received by the data input control unit 02120 and are then sent to the control unit 02110 can be employed.

The data synchronization unit 02130 temporarily stores data acquired from the camera adapter 120 on a DRAM to buffer the data until a foreground image, a background image, sound data, and three-dimensional model data are fully acquired. Furthermore, in the following description, a foreground image, a background image, sound data, and three-dimensional model data are collectively referred to as “image capturing data”. Meta-information, such as routing information, time code information (time information), and a camera identifier, is appended to the image capturing data, and the data synchronization unit 02130 checks for an attribute of data based on the meta-information. With this, the data synchronization unit 02130 determines that, for example, the received data is data obtained at the same time and confirms that the various pieces of data are fully received. This is because, with regard to data transferred from each camera adapter 120 via a network, the order of reception of network packets is not ensured and buffering is required until various pieces of data required for file generation are fully received. When the various pieces of data are fully received, the data synchronization unit 02130 transmits a foreground image and a background image to an image processing unit 02150, three-dimensional model data to a three-dimensional model joining unit 02160, and sound data to an image capturing data file generation unit 02180. Furthermore, the data to be fully received is data required to be used to perform file generation in the image capturing data file generation unit 02180, which is described below. Moreover, the background image can be captured at a frame rate different from that of the foreground image. For example, in a case where the frame rate of the background image is 1 fps (frames per second), since one background image is acquired per second, with respect to a time period in which no background image is acquired, it can be determined that all of the pieces of data have been fully received with the absence of any background image. Additionally, in a case where the pieces of data are not fully received even after elapse of a predetermined time, the data synchronization unit 02130 notifies the database 250 of information indicating that the pieces of data are not yet fully received. Then, when storing data, the database 250, which is a subsequent stage, stores information indicating the lack of data together with a camera number and a frame number. This enables automatically issuing a notification indicating whether an intended image is able to be formed from captured images obtained from the cameras 112 and collected to the database 250, prior to rendering being performed according to a viewpoint instruction issued from the virtual camera operation UI 330 to the back-end server 270. As a result, a visual load on the operator of the virtual camera operation UI 330 can be reduced.

The CAD data storage unit 02135 stores three-dimensional data indicating a stadium shape received from the control unit 02110 in a storage medium, such as a DRAM, an HDD, or a NAND memory. Then, the CAD data storage unit 02135 transmits stadium shape data stored upon receiving a request for stadium shape data to an image joining unit 02170. The calibration unit 02140 performs a calibration operation for the cameras, and transmits camera parameters obtained by the calibration operation to the non-image capturing data file generation unit 02185, which is described below. Moreover, at the same time, the calibration unit 02140 also stores the camera parameters in its own storage region, and supplies camera parameter information to the three-dimensional model joining unit 02160, which is described below.

The image processing unit 02150 performs various processing operations on a foreground image and a background image, such as mutual adjustment of colors or luminance values between cameras, development processing in a case where RAW image data is input, and correction of lens distortion of a camera. Then, the image processing unit 02150 transmits the foreground image subjected to image processing to the image capturing data file generation unit 02180 and transmits the background image subjected to image processing to the image joining unit 02170. The three-dimensional model joining unit 02160 joins pieces of three-dimensional model data obtained at the same time and acquired from the camera adapter 120 with use of the camera parameters generated by the calibration unit 02140. Then, the three-dimensional model joining unit 02160 generates three-dimensional model data about a foreground image of the entire stadium with use of a method called “Visual Hull”. The generated three-dimensional model data is transmitted to the image capturing data file generation unit 02180.

The image joining unit 02170 acquires a background image from the image processing unit 02150 and acquires three-dimensional shape data about a stadium (stadium shape data) from the CAD data storage unit 02135, and specifies the position of the background image relative to the coordinates of the acquired three-dimensional shape data about a stadium. After completely specifying the position relative to the coordinates of the acquired three-dimensional shape data about a stadium with respect to each of the acquired background images, the image joining unit 02170 joins the background images to form one background image. Furthermore, generation of three-dimensional shape data about the background image can be performed by the back-end server 270.

The image capturing data file generation unit 02180 acquires sound data from the data synchronization unit 02130, a foreground image from the image processing unit 02150, three-dimensional model data from the three-dimensional model joining unit 02160, and a background image joined in a three-dimensional shape from the image joining unit 02170. Then, the image capturing data file generation unit 02180 outputs these acquired pieces of data to a DB access control unit 02190. Here, the image capturing data file generation unit 02180 associates these pieces of data with respective pieces of time information thereof and outputs them. However, the image capturing data file generation unit 02180 can associate a part of the pieces of data with respective pieces of time information thereof and output them. For example, the image capturing data file generation unit 02180 respectively associates a foreground image and a background image with time information of the foreground image and time information of the background image and outputs them. Alternatively, for example, the image capturing data file generation unit 02180 respectively associates a foreground image, a background image and three-dimensional model data with time information of the foreground image, time information of the background image, and time information of the three-dimensional model data and outputs them. Furthermore, the image capturing data file generation unit 02180 can convert the associated pieces of data into files for the respective types of data and output the files, or can sort out a plurality of types of data for each time indicated by the time information, convert the plurality of types of data into files, and output them. Since image capturing data associated in this way is output from the front-end server 230, which serves as an information processing apparatus that performs association, to the database 250, the back-end server 270 is able to generate a virtual viewpoint image from a foreground image and a background image which are associated with each other with regard to time information.

Furthermore, in a case where a foreground image and a background image, which are acquired by the data input control unit 02120, differ in frame rate, it is difficult for the image capturing data file generation unit 02180 to constantly associate a foreground image and a background image obtained at the same time with each other and output them. Therefore, the image capturing data file generation unit 02180 associates a foreground image with a background image having time information having a relationship defined by a predetermined rule with time information of the foreground image, and outputs the associated foreground image and background image. Here, the background image having time information having a relationship defined by a predetermined rule with time information of the foreground image is a background image having time information closest to the time information of the foreground image among background images acquired by the image capturing data file generation unit 02180. In this way, associating a foreground image and a background image with each other based on a predetermined rule enables, even if frame rates of the foreground image and the background image are different from each other, generating a virtual viewpoint image from the foreground image and the background image captured at close times. Furthermore, the method of associating a foreground image and a background image with each other is not limited to the above-mentioned method. For example, the background image having time information having a relationship defined by a predetermined rule with time information of the foreground image can be a background image having time information closest to the time information of the foreground image among acquired background images having pieces of time information corresponding to times earlier than that of the foreground image. According to this method, without waiting for acquisition of a background image, which is lower in frame rate than a foreground image, the associated foreground image and background image can be output at a low delay. Moreover, the background image having time information having a relationship defined by a predetermined rule with time information of the foreground image can be a background image having time information closest to the time information of the foreground image among acquired background images having pieces of time information corresponding to times later than that of the foreground image.

The non-image capturing data file generation unit 02185 acquires camera parameters from the calibration unit 02140 and three-dimensional shape data about a stadium from the control unit 02110, and, after shaping the data according to a file format, transmits the data to the DB access control unit 02190. Furthermore, camera parameters or stadium shape data, which is data input to the non-image capturing data file generation unit 02185, is individually shaped according to a file format. In other words, when receiving either one of the two pieces of data, the non-image capturing data file generation unit 02185 individually transmits the received data to the DB access control unit 02190.

The DB access control unit 02190 is connected to the database 250 in such a way as to be able to perform high-speed communication via, for example, InfiniBand. Then, the DB access control unit 02190 transmits files received from the image capturing data file generation unit 02180 and the non-image capturing data file generation unit 02185 to the database 250. In the present exemplary embodiment, image capturing data associated by the image capturing data file generation unit 02180 based on time information is output, via the DB access control unit 02190, to the database 250, which is a storage device connected to the front-end server 230 via a network. However, the output destination of the associated image capturing data is not limited to this. For example, the front-end server 230 can output the image capturing data associated based on time information to the back-end server 270, which is an image generation apparatus connected to the front-end server 230 via a network and configured to generate a virtual viewpoint image. Moreover, the front-end server 230 can output the associated image capturing data to both the database 250 and the back-end server 270.

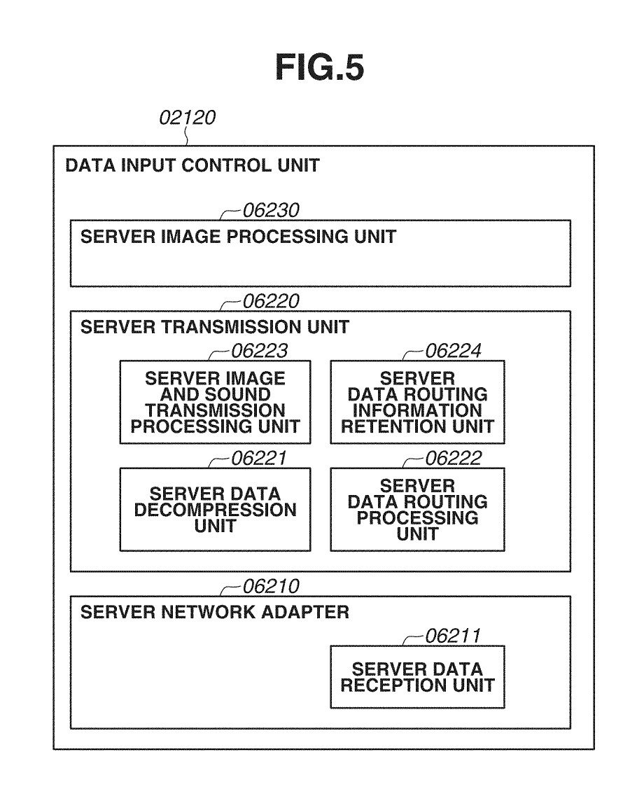

Furthermore, while, in the present exemplary embodiment, the front-end server 230 performs association of a foreground image with a background image, the present exemplary embodiment is not limited to this, but the database 250 can perform the association. For example, the database 250 can acquire a foreground image and a background image having respective pieces of time information from the front-end server 230. Then, the database 250 can associate the foreground image with the background image based on the time information of the foreground image and the time information of the background image, and can output the associated foreground image and background image to a storage unit included in the database 250. The data input control unit 02120 of the front-end server 230 is described with reference to the functional block diagram of FIG. 5.

The data input control unit 02120 includes a server network adapter 06210, a server transmission unit 06220, and a server image processing unit 06230. The server network adapter 06210 includes a server data reception unit 06211, and has the function to receive data transmitted from the camera adapter 120. The server transmission unit 06220 has the function to perform processing with respect to data received from the server data reception unit 06211, and is configured with the following functional units. A server data decompression unit 06221 has the function to decompress compressed data.

A server data routing processing unit 06222 determines a transfer destination of data based on routing information, such as an address, retained by a server data routing information retention unit 06224, which is described below, and transfers data received from the server data reception unit 06211 to the transfer destination. A server image and sound transmission processing unit 06223 receives a message from the camera adapter 120 via the server data reception unit 06211, and restores fragmented data to image data or sound data according to a data type included in the message. Furthermore, in a case where the image data or sound data obtained by restoration is compressed data, the server data decompression unit 06221 performs decompression processing.

The server data routing information retention unit 06224 has the function to retain address information for determining a transmission destination of data received by the server data reception unit 06211. Furthermore, the routing method is described below. The server image processing unit 06230 has the function to perform processing concerning image data or sound data received from the camera adapter 120. The processing content includes, for example, shaping processing into a format assigned with, for example, a camera number, image capturing time of an image frame, an image size, an image format, and attribute information about coordinates of an image according to a data entity of image data (a foreground image, a background image, and three-dimensional model information).

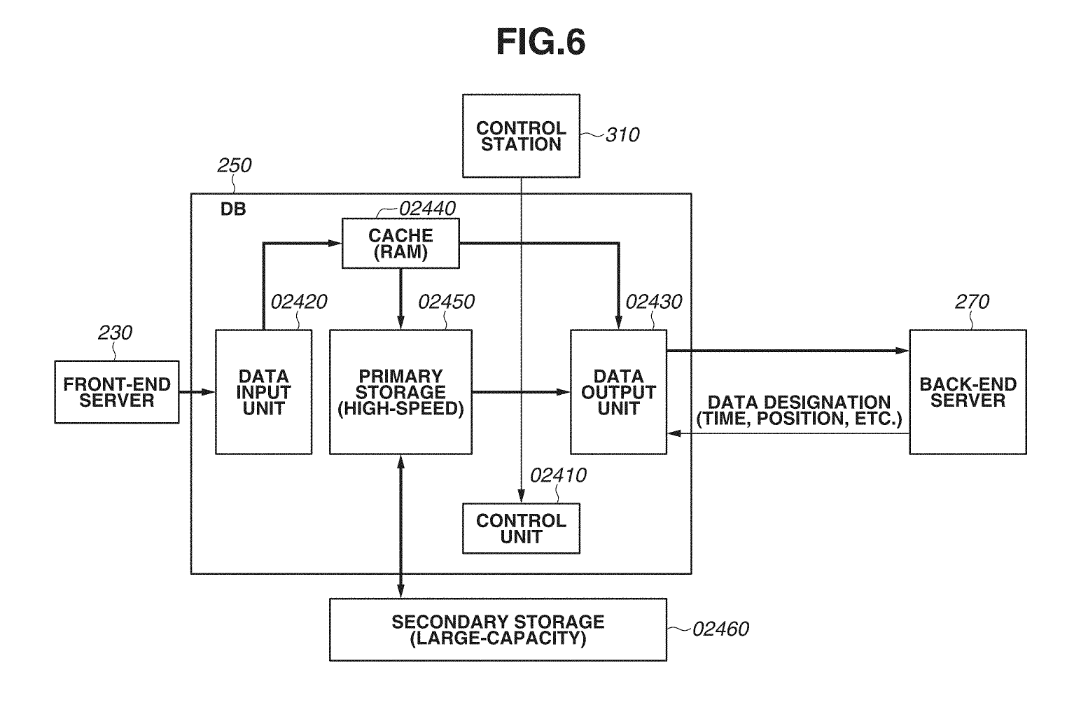

FIG. 6 is a diagram illustrating functional blocks of the database 250. A control unit 02410 is configured with hardware, such as a CPU, a DRAM, a storage medium, such as an HDD or NAND memory storing program data and various pieces of data, and Ethernet. Then, the control unit 02410 controls each functional block of the database 250 and the entire system of the database 250. A data input unit 02420 receives a file of image capturing data or non-image capturing data from the front-end server 230 via a high-speed communication such as InfiniBand. The received file is sent to a cache 02440. Moreover, the data input unit 02420 reads out meta-information of the received image capturing data, and generates a database table in such a way as to enable access to the acquired data, based on information, such as time code information, routing information, and a camera identifier, recorded in the meta-information. A data output unit 02430 determines in which of the cache 02440, a primary storage 02450, and a secondary storage 02460 the data requested by the back-end server 270 is stored. Then, the data output unit 02430 reads out and transmits the data from the storage location to the back-end server 270 via a high-speed communication such as InfiniBand.

The cache 02440 includes a storage device, such as a DRAM, capable of implementing a high-speed input and output throughput, and stores image capturing data or non-image capturing data acquired from the data input unit 02420 in the storage device. The stored data is retained as much as a predetermined amount, and, when data exceeding the predetermined amount is input, data is continually read out and written into the primary storage 02450 in order of older data and the data read out and written is overwritten with new data. Here, data stored in the cache 02440 as much as the predetermined amount is image capturing data for at least one frame. With this, when rendering processing of an image is performed in the back-end server 270, a throughput in the database 250 can be reduced to a minimum and rendering can be performed on the latest image frame at a low delay and in a continuous manner. Here, in order to attain the above-mentioned object, it is necessary that a background image be included in data which is cached. Therefore, in a case where image capturing data of a frame which includes no background image is cached, a background image stored on a cache is not updated and is retained as it is on the cache. The capacity of a DRAM capable of caching is determined by a cache frame size previously set in the system or by an instruction issued from the control station 310. Furthermore, non-image capturing data is low in the frequency of input and output and is not required to have a high-speed throughput, for example, before the game, and is, therefore, immediately copied to the primary storage 02450. The cached data is read out by the data output unit 02430.

The primary storage 02450 is configured with storage media, such as solid state drives (SSDs), for example, connected in parallel, and is configured to have a high-speed performance in such a way as to be able to concurrently implement writing of a large amount of data from the data input unit 02420 and reading-out of data to the data output unit 02430. Then, data stored on the cache 02440 is written into the primary storage 02450 in order of older data. The secondary storage 02460 is configured with, for example, an HDD or a tape medium, and, since emphasis is put on a large capacity rather than a high-speed performance, the secondary storage 02460 is required to be a medium which is more inexpensive and is available for longer-term storage than the primary storage 02450. After completion of image capturing, data stored in the primary storage 02450 is written into the secondary storage 02460 as backed-up data.

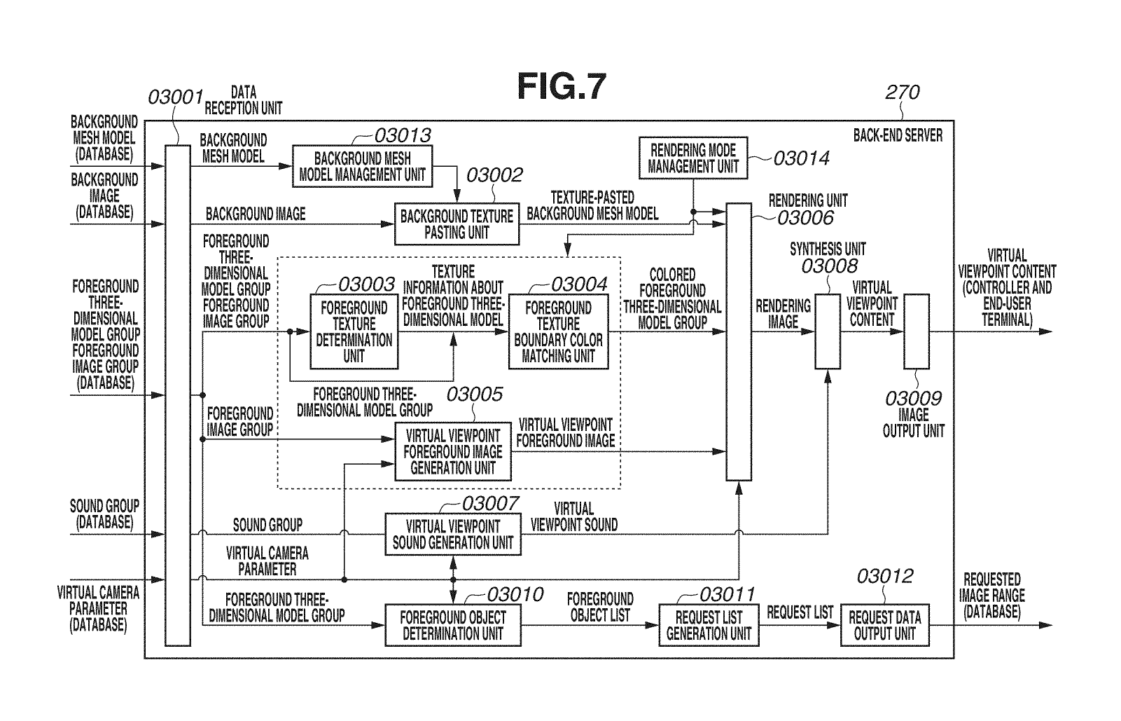

FIG. 7 illustrates a configuration of the back-end server 270 according to the present exemplary embodiment. The back-end server 270 includes a data reception unit 03001, a background texture pasting unit 03002, a foreground texture determination unit 03003, a foreground texture boundary color matching unit 03004, a virtual viewpoint foreground image generation unit 03005, and a rendering unit 03006. Moreover, the back-end server 270 includes a virtual viewpoint sound generation unit 03007, a synthesis unit 03008, an image output unit 03009, a foreground object determination unit 03010, a request list generation unit 03011, a request data output unit 03012, and a background mesh model management unit 03013, and a rendering mode management unit 03014.

The data reception unit 03001 receives data transmitted from the database 250 and data transmitted from the controller 300. Furthermore, the data reception unit 03001 receives, from the database 250, three-dimensional data indicating the shape of a stadium (stadium shape data), a foreground image, a background image, a three-dimensional model of the foreground image (hereinafter referred to as “foreground three-dimensional model”), and a sound. Moreover, the data reception unit 03001 receives a virtual camera parameter output from the controller 300, which serves as a designation device that designates a viewpoint concerning generation of a virtual viewpoint image. The virtual camera parameter is data representing, for example, the position and orientation of a virtual viewpoint, and is configured with, for example, a matrix of external parameters and a matrix of internal parameters.

Furthermore, data which the data reception unit 03001 acquires from the controller 300 is not limited to the virtual camera parameter. For example, the information to be output from the controller 300 can include at least one of a method of designating a viewpoint, information identifying an application caused to operate by the controller 300, identification information about the controller 300, and identification information about the user who uses the controller 300. Moreover, the data reception unit 03001 can also acquire, from the end-user terminal 190, information similar to the above-mentioned information output from the controller 300. Additionally, the data reception unit 03001 can acquire information about a plurality of cameras 112 from an external device, such as the database 250 or the controller 300. The information about a plurality of cameras 112 is, for example, information about the number of cameras of the plurality of cameras 112 or information about operating states of the plurality of cameras 112. The operating state of the camera 112 includes, for example, at least one of a normal state, a failure state, a waiting state, a start-up state, and a restart state of the camera 112.

The background texture pasting unit 03002 pastes a background image as a texture to a three-dimensional spatial shape indicated by a background mesh model (stadium shape data) acquired from the background mesh model management unit 03013. With this, the background texture pasting unit 03002 generates a texture-pasted background mesh model. The term “mesh model” refers to data in which a three-dimensional spatial shape, such as CAD data, is expressed by a set of surfaces. The term “texture” refers to an image to be pasted so as to express the feel or shape of a surface of an object. The foreground texture determination unit 03003 determines texture information about a foreground three-dimensional model from a foreground image and a foreground three-dimensional model group. The foreground texture boundary color matching unit 03004 performs color matching of a boundary of the texture based on texture information about each foreground three-dimensional model and each three-dimensional model group, thus generating a colored foreground three-dimensional model group for each foreground object.

The virtual viewpoint foreground image generation unit 03005 performs perspective transformation on a foreground image group based on the virtual camera parameter in such a manner that the foreground image group becomes an appearance viewed as if from a virtual viewpoint. The rendering unit 03006 generates a full-view virtual viewpoint image by performing rendering on a foreground image and a background image based on a generation method for use in generation of a virtual viewpoint image, determined by the rendering mode management unit 03014. In the present exemplary embodiment, as the generation method for a virtual viewpoint image, two rendering modes, i.e., model-based rendering (MBR) and image-based rendering (IBR), are used. MBR is a method of generating a virtual viewpoint image using a three-dimensional model generated based on a plurality of captured images obtained by performing image capturing of a subject from a plurality of directions. Specifically, MBR is a technique to generate an appearance of a scene viewed from a virtual viewpoint as an image using a three-dimensional shape (model) of a target scene obtained by a three-dimensional shape reconstruction method, such as a visual volume intersection method and multi-view stereo (MVS). IBR is a technique to generate a virtual viewpoint image in which an appearance viewed from a virtual viewpoint is reconstructed by deforming and combining an input image group obtained by performing image capturing of a target scene from a plurality of viewpoints.

In the present exemplary embodiment, in a case where IBR is used, a virtual viewpoint image is generated based on one or a plurality of captured images smaller in number than a plurality of captured images which is used to generate a three-dimensional model using MBR. In a case where the rendering mode is MBR, a full-view model is generated by combining a background mesh model and a foreground three-dimensional model group generated by the foreground texture boundary color matching unit 03004, and a virtual viewpoint image is generated from the generated full-view model. In a case where the rendering mode is IBR, a background image viewed from a virtual viewpoint is generated based on a background texture model, and a virtual viewpoint image is generated by combining a foreground image generated by the virtual viewpoint foreground image generation unit 03005 with the generated background image.

Furthermore, the rendering unit 03006 can use a rendering method other than MBR and IBR. Moreover, the generation method for a virtual viewpoint image which is determined by the rendering mode management unit 03014 is not limited to a method of rendering, and the rendering mode management unit 03014 can determine a method of processing other than rendering for generating a virtual viewpoint image. The rendering mode management unit 03014 determines a rendering mode as the generation method for use in generation of a virtual viewpoint image, and retains a result of such determination.

In the present exemplary embodiment, the rendering mode management unit 03014 determines a rendering mode to be used from among a plurality of rendering modes. This determination is performed based on information acquired by the data reception unit 03001. For example, in a case where the number of cameras specified by the acquired information is equal to or less than a threshold value, the rendering mode management unit 03014 determines to set the generation method for use in generation of a virtual viewpoint image to IBR. On the other hand, in a case where the number of cameras is greater than the threshold value, the rendering mode management unit 03014 determines to set the generation method to MBR. With this, in a case where the number of cameras is large, a virtual viewpoint image is generated with use of MBR, so that a range available for designating a viewpoint becomes wide. Moreover, in a case where the number of cameras is small, IBR is used, so that a decrease in image quality of a virtual viewpoint image caused by a decrease in precision of a three-dimensional model in a case where MBR is used can be avoided.

Furthermore, for example, the generation method can be determined based on the length of a processing delay time allowable from the time of image capturing to the time of image outputting. In a case where the freedom of a viewpoint is prioritized even when the delay time is long, MBR is used, and, in a case where the delay time is requested to be short, IBR is used. Moreover, for example, in a case where the data reception unit 03001 has acquired information indicating that the controller 300 or the end-user terminal 190 is able to designate the height of a viewpoint, MBR is determined as the generation method for use in generation of a virtual viewpoint image. This enables preventing the occurrence of such a situation that the user's request for changing the height of a viewpoint becomes unacceptable due to IBR being set as the generation method. In this way, the generation method for a virtual viewpoint image is determined according to the situation, so that a virtual viewpoint image can be generated by an appropriately determined generation method. Moreover, since a configuration in which a plurality of rendering modes is able to be switched according to a request is employed, the system can be flexibly configured, so that the present exemplary embodiment can also be applied to a subject other than stadiums. Furthermore, rendering modes which are retained by the rendering mode management unit 03014 can be rendering modes previously set in the system. Additionally, the rendering modes can be configured to be able to be optionally set by the user who operates the virtual camera operation UI 330 or the end-user terminal 190.

The virtual viewpoint sound generation unit 03007 generates a sound (sound group) which would be heard at a virtual viewpoint based on the virtual camera parameter. The synthesis unit 03008 generates virtual viewpoint content by combining an image group generated by the rendering unit 03006 and a sound generated by the virtual viewpoint sound generation unit 03007. The image output unit 03009 outputs the virtual viewpoint content to the controller 300 and the end-user terminal 190 via Ethernet. However, the outward transmission method is not limited to Ethernet, and another signal transmission method, such as serial digital interface (SDI), DisplayPort, or High-Definition Multimedia Interface (HDMI®), can be used. Furthermore, the back-end server 270 can output a virtual viewpoint image which contains no sound, which is generated by the rendering unit 03006.

The foreground object determination unit 03010 determines a foreground object group to be displayed from the virtual camera parameter and position information about a foreground object indicating a spatial position of a foreground object included in the foreground three-dimensional model, and outputs a foreground object list. In other words, the foreground object determination unit 03010 performs processing for mapping image information concerning a virtual viewpoint to a physical camera 112. With regard to the present virtual viewpoint, the result of mapping varies according to a rendering mode determined by the rendering mode management unit 03014. Therefore, it should be noted that a control unit which determines a plurality of foreground objects is included in the foreground object determination unit 03010 and performs control in conjunction with the set rendering mode.

The request list generation unit 03011 generates a request list used to request, from the database 250, a foreground image group and a foreground three-dimensional model group corresponding to a foreground object list related to a designated time, a background image, and sound data. With regard to a foreground object, data selected in consideration of a virtual viewpoint is requested from the database 250, and, with regard to a background image and sound data, all of the pieces of data concerning the corresponding frame are requested. After start-up of the back-end server 270, a request list for a background mesh model is generated until the background mesh model is acquired. The request data output unit 03012 outputs a command for data request to the database 250 based on the input request list. The background mesh model management unit 03013 stores a background mesh model received from the database 250.

While, in the present exemplary embodiment, a case in which the back-end server 270 performs both determination of the generation method for a virtual viewpoint image and generation of the virtual viewpoint image is mainly described, the present exemplary embodiment is not limited to this. Thus, an information processing apparatus which determines the generation method can output data corresponding to a result of the determination. For example, the front-end server 230 can determine a generation method for use in generation of a virtual viewpoint image based on, for example, information concerning a plurality of cameras 112 and information output from a device which designates a viewpoint concerning generation of a virtual viewpoint image. Then, the front-end server 230 can output image data acquired based on image capturing performed by the camera 112 and information indicating the determined generation method to at least one of a storage device, such as the database 250, and an image generation device, such as the back-end server 270. In this case, for example, the back-end server 270 generates a virtual viewpoint image based on the information indicating the generation method output from the front-end server 230. Since the front-end server 230 determines the generation method, a processing load caused by the database 250 or the back-end server 270 processing data for image generation in a method different from the determined generation method can be reduced. On the other hand, in a case where the back-end server 270 determines the generation method as in the present exemplary embodiment, the database 250 retains data compatible with a plurality of generation methods and is, therefore, able to generate a plurality of virtual viewpoint images respectively compatible with the plurality of generation methods.

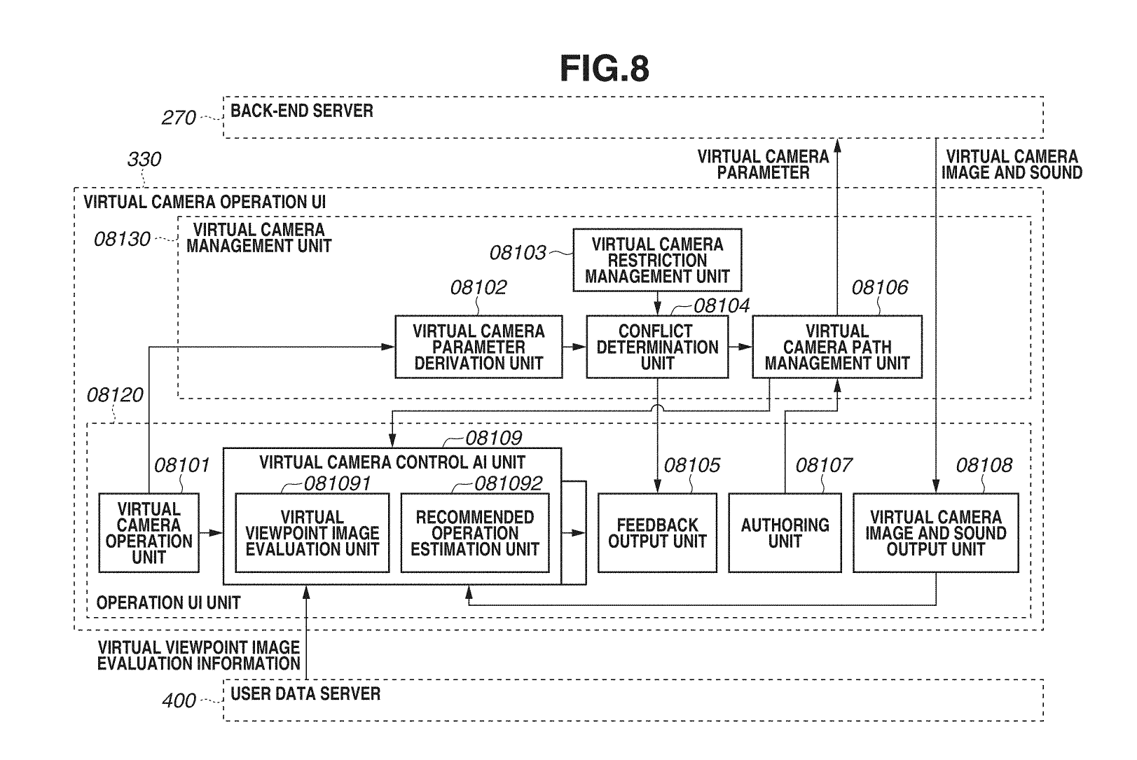

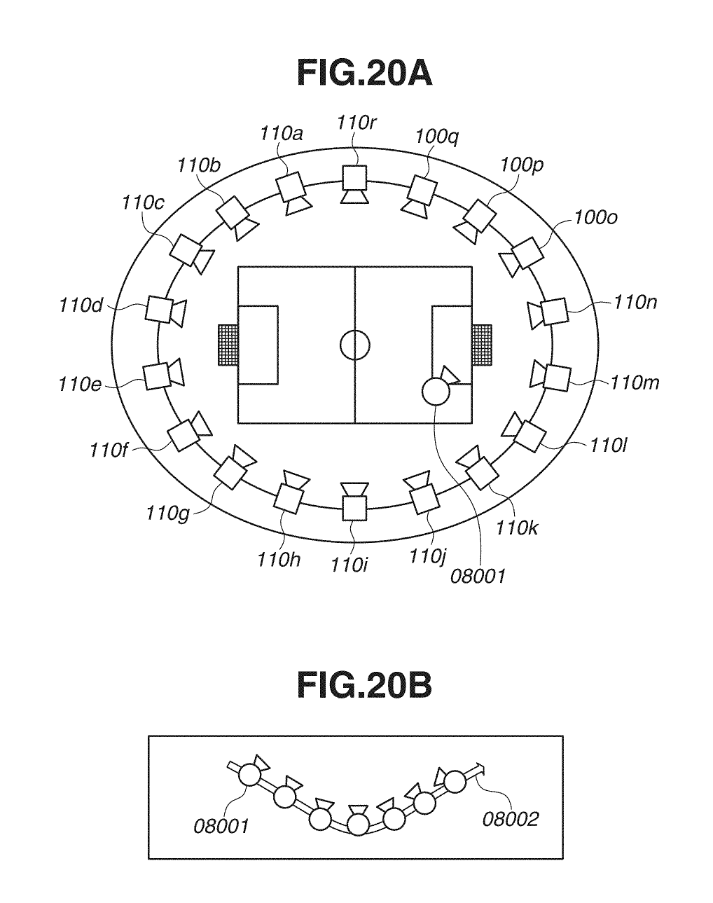

FIG. 8 is a block diagram illustrating a functional configuration of the virtual camera operation UI 330. A virtual camera 08001 is described with reference to FIG. 20A. The virtual camera 08001 is a simulated camera capable of performing image capturing at a viewpoint different from that of any one of the installed cameras 112. In other words, a virtual viewpoint image generated by the image processing system 100 is a captured image obtained by the virtual camera 08001. Referring to FIG. 20A, each of a plurality of sensor systems 110 installed on the circumference of a circle includes a camera 112. For example, generating a virtual viewpoint image enables generating an image as if captured by the virtual camera 08001 located near a soccer goal. A virtual viewpoint image which is a captured image obtained by the virtual camera 08001 is generated by performing image processing on images obtained by a plurality of installed cameras 112. The operator (user) can acquire a captured image from an optional viewpoint by operating, for example, the position of the virtual camera 08001.

The virtual camera operation UI 330 includes a virtual camera management unit 08130 and an operation UI unit 08120. These units can be mounted on the same apparatus or can be separately mounted on an apparatus serving as a server and an apparatus serving as a client, respectively. For example, in a virtual camera operation UI 330 which is used in a broadcast station, the virtual camera management unit 08130 and the operation UI unit 08120 can be mounted in a workstation located in an outside broadcast van. Moreover, for example, a similar function can be implemented by mounting the virtual camera management unit 08130 in a web server and mounting the operation UI unit 08120 in the end-user terminal 190.

A virtual camera operation unit 08101 performs processing upon receiving an operation performed by the user on the virtual camera 08001, in other words, an instruction from the user to designate a viewpoint concerning generation of a virtual viewpoint image. The content of the operation performed by the user includes, for example, changing the position (movement), changing the orientation (rotation), and changing a zoom magnification. To operate the virtual camera 08001, the user uses input devices, such as a joystick, a joy dial, a touch-screen, a keyboard, and a mouse. The correspondence relationship between inputs performed via the respective input devices and operations of the virtual camera 08001 is previously determined. For example, key “W” of the keyboard is associated with an operation of moving the virtual camera 08001 forward by one meter. Moreover, the operator can operate the virtual camera 08001 by designating a trajectory. For example, the operator designates a trajectory in which the virtual camera 08001 revolves on the circumference of a circle centering on a goal post, by touching on a touchpad in such a way as to draw a circle. The virtual camera 08001 moves around the goal post along the designated trajectory. At this time, the orientation of the virtual camera 08001 can be automatically changed in such a manner that the virtual camera 08001 constantly turns to face the goal post. The virtual camera operation unit 08101 can be used in generating a live image and a replay image. At the time of generation of a replay image, an operation of designating time besides the position and orientation of the camera is performed. In a replay image, for example, an operation of moving the virtual camera 08001 while stopping time can be performed.

A virtual camera parameter derivation unit 08102 derives a virtual camera parameter indicating, for example, the position and orientation of the virtual camera 08001. The virtual camera parameter can be derived by computation or can be derived by, for example, reference to a look-up table. As the virtual camera parameter, for example, a matrix representing external parameters and a matrix representing internal parameters are used. Here, the external parameters include the position and orientation of the virtual camera 08001, and the internal parameters include a zoom value.

A virtual camera restriction management unit 08103 acquires and manages information for specifying a restriction area in which the designation of a viewpoint performed based on an instruction received by the virtual camera operation unit 08101 is restricted. This information is, for example, a restriction concerning, for example, the position and orientation of the virtual camera 08001 or a zoom value. The virtual camera 08001, unlike the camera 112, is able to perform image capturing while freely moving a viewpoint, but is not necessarily able to generate an image captured from every viewpoint. For example, even if the virtual camera 08001 turns to face in a direction in which an object that is not contained in any image captured by any camera 112 would be contained in a captured image, the virtual camera 08001 is not able to acquire such a captured image. Moreover, if the zoom magnification of the virtual camera 08001 is increased, the image quality deteriorates due to a restriction of resolution. Therefore, for example, a zoom magnification in such a range as to keep a predetermined standard of image quality can be set as a virtual camera restriction. The virtual camera restriction can be derived in advance from, for example, the location of a camera. Additionally, the transmission unit 06120 may perform an operation to reduce the amount of transmitted data according to a load of the network. This data amount reduction causes parameters concerning captured images to change, so that a range available to generate an image or a range available to keep image quality dynamically changes. The virtual camera restriction management unit 08103 can be configured to receive, from the transmission unit 06120, information indicating a method which has been used to reduce the amount of output data, and to dynamically update the virtual camera restriction according to the received information. With this, even when the data amount reduction is performed by the transmission unit 06120, the image quality of a virtual viewpoint image can be kept at a predetermined standard.

Furthermore, the restriction concerning a virtual camera is not limited to the above-mentioned restriction. In the present exemplary embodiment, a restriction area in which the designation of a viewpoint is restricted (an area in which the virtual camera restriction is not fulfilled) changes according to at least one of an operating state of a device included in the image processing system 100 and a parameter concerning image data used to generate a virtual viewpoint image. For example, the restriction area changes according to a parameter which is controlled in such a manner that the data amount of image data transferred in the image processing system 100 is kept within a predetermined range. The parameter includes at least one of, for example, a frame rate, a resolution, a quantization step, and an image capturing range of image data. For example, when the resolution of image data is reduced to reduce the amount of transferred data, the range of zoom magnification available to keep a predetermined image quality changes. In such a case, when the virtual camera restriction management unit 08103 acquires information specifying a restriction area which changes according to the parameter, the virtual camera operation UI 330 is able to perform control in such a way as to allow the user to designate a viewpoint within a range corresponding to changing of the parameter. Furthermore, the content of the parameter is not limited to the above-mentioned content. Additionally, while, in the present exemplary embodiment, the above-mentioned image data the data amount of which is controlled is data generated based on a difference between a plurality of captured images obtained by a plurality of cameras 112, the present exemplary embodiment is not limited to this, but the above-mentioned image data can be, for example, just a captured image.

Furthermore, for example, the restriction area changes according to the operating state of a device included in the image processing system 100. Here, the device included in the image processing system 100 includes, for example, at least one of the camera 112 and the camera adapter 120, which generates image data by performing image processing on a captured image obtained by the camera 112. Then, the operating state of a device includes, for example, at least one of a normal state, a failure state, a start-up preparatory state, and restart state of the device. For example, in a case where any camera 112 is in a failure state or restart state, a case where it becomes impossible to designate a viewpoint at a position around the camera 112 can be considered. In such a case, the virtual camera restriction management unit 08103 acquires information specifying a restriction area which changes according to the operating state of a device, so that the virtual camera operation UI 330 is able to perform control in such a way as to allow the user to designate a viewpoint within a range corresponding to changing of the operating state of the device. Furthermore, the device and the operating state thereof related to changing of the restriction area are not limited to the above-mentioned ones.

A conflict determination unit 08104 determines whether the virtual camera parameter derived by the virtual camera parameter derivation unit 08102 fulfills the virtual camera restriction. If the restriction is not fulfilled, for example, control is performed in such a way as to cancel an operation input performed by the operator and prevent the virtual camera 08001 from moving from the position in which the restriction is fulfilled or return the virtual camera 08001 to the position in which the restriction is fulfilled.

A feedback output unit 08105 feeds back a result of determination performed by the conflict determination unit 08104 to the operator. For example, in a case where the operation of the operator causes the virtual camera restriction not to be fulfilled, the feedback output unit 08105 notifies the operator of that effect. For example, suppose that, while the operator performs an operation to try to move up the virtual camera 08001, the destination of movement does not fulfill the virtual camera restriction. In that case, the feedback output unit 08105 notifies the operator that it is impossible to move up the virtual camera 08001 any further. The notification method includes, for example, outputting of a sound or a message, color change of a screen, and locking of the virtual camera operation unit 08101. Furthermore, the position of the virtual camera can be automatically returned to a position in which the virtual camera restriction is fulfilled, and this brings about an effect of leading to simplifying an operation of the operator. In a case where the feedback is effected via image display, the feedback output unit 08105 causes a display unit to display an image which is based on display control corresponding to the restriction area based on information acquired by the virtual camera restriction management unit 08103. For example, in response to an instruction received by the virtual camera operation unit 08101, the feedback output unit 08105 causes the display unit to display an image indicating that a viewpoint corresponding to the instruction is within the restriction area. With this, the operator can recognize that, since the designated viewpoint is within the restriction area, it may be impossible to generate an intended virtual viewpoint image, and can re-designate a viewpoint to a position outside the restriction area (a position in which the virtual camera restriction is fulfilled). Thus, in generation of a virtual viewpoint image, a viewpoint can be designated within a range which changes according to the situation. Furthermore, the content which the virtual camera operation UI 330 serving as a control device that performs display control corresponding to the restriction area causes the display unit to display is not limited to this. For example, an image obtained by filling, with a predetermined color, a portion corresponding to the restriction area included in an area that is targeted for destination of a viewpoint (for example, the inside of a stadium) can be displayed. While, in the present exemplary embodiment, the display unit is assumed to be an external display connected to the virtual camera operation UI 330, the present exemplary embodiment is not limited to this, but the display unit can be located inside the virtual camera operation UI 330.

A virtual camera path management unit 08106 manages a path of the virtual camera 08001 (a virtual camera path 08002 (FIG. 20B)) corresponding to an operation of the operator. The virtual camera path 08002 is a sequence of pieces of information indicating the position or orientation of the virtual camera 08001 at intervals of one frame. The following description is made with reference to FIG. 20B. For example, a virtual camera parameter is used as information indicating the position or orientation of the virtual camera 08001. For example, information for one second in setting of a frame rate of 60 frames per second becomes a sequence of 60 virtual camera parameters. The virtual camera path management unit 08106 transmits the virtual camera parameter determined by the conflict determination unit 08104 to the back-end server 270. The back-end server 270 generates a virtual viewpoint image and a virtual viewpoint sound using the received virtual camera parameter. Moreover, the virtual camera path management unit 08106 has the function to append the virtual camera parameter to the virtual camera path 08002 and retain the virtual camera path 08002 with the virtual camera parameter appended thereto. For example, in a case where virtual viewpoint images and virtual viewpoint sounds for one hour are generated with use of the virtual camera operation UI 330, virtual camera parameters for one hour are stored as the virtual camera path 08002. Since the present virtual camera path is stored, later referring to image information and a virtual camera path accumulated in the secondary storage 02460 of the database 250 enables re-generating a virtual viewpoint image and a virtual viewpoint sound. Thus, a virtual camera path generated by an operator who performs a sophisticated virtual camera operation and image information stored in the secondary storage 02460 can be reused by another user. Furthermore, a plurality of virtual camera paths can be accumulated in the virtual camera management unit 08130 in such way as to enable selecting a plurality of scenes corresponding to the plurality of virtual camera paths. When a plurality of virtual camera paths is accumulated in the virtual camera management unit 08130, meta-information, such as a script of a scene corresponding to each virtual camera path, an elapsed time of a game, times specifying the start and end of a scene, and information about players, can also be input and accumulated together. The virtual camera operation UI 330 notifies the back-end server 270 of these virtual camera paths as virtual camera parameters.

The end-user terminal 190 is able to select a virtual camera path based on, for example, a scene name, a player, and an elapsed time of a game by requesting selection information for selecting a virtual camera path from the back-end server 270. The back-end server 270 notifies the end-user terminal 190 of candidates for a selectable virtual camera path, and the end-user operates the end-user terminal 190 to select an intended virtual camera path from among a plurality of candidates. Then, the end-user terminal 190 requests the back-end server 270 to generate an image corresponding to the selected virtual camera path, so that the end-user can interactively enjoy an image delivery service.

An authoring unit 08107 provides an editing function which is used when the operator generates a replay image. In response to a user operation, the authoring unit 08107 extracts a part of the virtual camera path 08002 retained by the virtual camera path management unit 08106, as an initial value of the virtual camera path 08002 for a replay image. As mentioned above, the virtual camera path management unit 08106 retains meta-information, such as a scene name, a player, and times specifying the start and end of a scene, in association with the virtual camera path 08002. For example, a virtual camera path 08002 in which the scene name is “goal scene” and the times specifying the start and end of a scene are 10 seconds in total is extracted. Furthermore, the authoring unit 08107 sets a playback speed to the edited camera path. For example, the authoring unit 08107 sets slow playback to a virtual camera path 08002 obtained in a period during which a ball flies into the goal. Moreover, in the case of changing to an image obtained from a different viewpoint, in other words, in the case of changing the virtual camera path 08002, the user operates the virtual camera 08001 again using the virtual camera operation unit 08101.

A virtual camera image and sound output unit 08108 outputs a virtual camera image and sound received from the back-end server 270. The operator operates the virtual camera 08001 while confirming the output image and sound. Furthermore, depending on the content of feedback performed by the feedback output unit 08105, the virtual camera image and sound output unit 08108 causes the display unit to display an image which is based on display control corresponding to the restriction area. For example, in a case where the position of a viewpoint designated by the operator is included in the restriction area, the virtual camera image and sound output unit 08108 can cause the display unit to display a virtual viewpoint image as viewed from a viewpoint the position of which is near the designated position and is outside the restriction area. This enables reducing the trouble of the user to re-designate a viewpoint to outside the restriction area.

A virtual camera control artificial intelligence (AI) unit 08109 includes a virtual viewpoint image evaluation unit 081091 and a recommended operation estimation unit 081092. The virtual viewpoint image evaluation unit 081091 acquires, from the user data server 400, evaluation information about a virtual viewpoint image output from the virtual camera image and sound output unit 08108. Here, the evaluation information is information representing the subjective evaluation of the end-user with respect to a virtual viewpoint image and is, for example, an integer score of 0 to 5 defined by comprehensive favorability rating on a scale on which 5 is perfection. Alternatively, the evaluation information can be a multidimensional evaluation value which is based on a plurality of criteria, such as powerful play and a sense of speed. The evaluation information can be a value obtained by the user database 410 tallying values directly input by one or a plurality of end-users via a user interface, such as a button, located in the end-user terminal 190. Alternatively, this tallying process can be a process of tallying evaluation values input from end-users in real time with use of, for example, a bidirectional communication function of digital broadcasting. Additionally, the evaluation information can be information that is updated in a short period of time to a long period of time, such as the number of times of broadcasting of a virtual viewpoint image selected by a broadcasting organizer or the number of times of publication by print media.

Furthermore, the evaluation information can be a value obtained by the analysis server 420 quantifying, as an evaluation score, the amount of feedback or the expression content which viewers who viewed a virtual viewpoint image wrote in, for example, web media or social media on the Internet. The virtual viewpoint image evaluation unit 081091 can be configured as a machine learning device which learns a relationship between a feature obtained from the virtual viewpoint image and evaluation information obtained from the user data server 400 and calculates a quantitative evaluation value with respect to an optional virtual viewpoint image. The recommended operation estimation unit 081092 can be configured as a machine learning device which learns a relationship between camera operation information input to the virtual camera operation unit 08101 and a virtual viewpoint image output as a result of that. The result of learning is used to obtain an operation which the operator is required to perform to output a virtual viewpoint image highly evaluated by the virtual viewpoint image evaluation unit 081091. This operation is set as a recommended operation and is then provided as auxiliary information to the operator by the feedback output unit 08105.

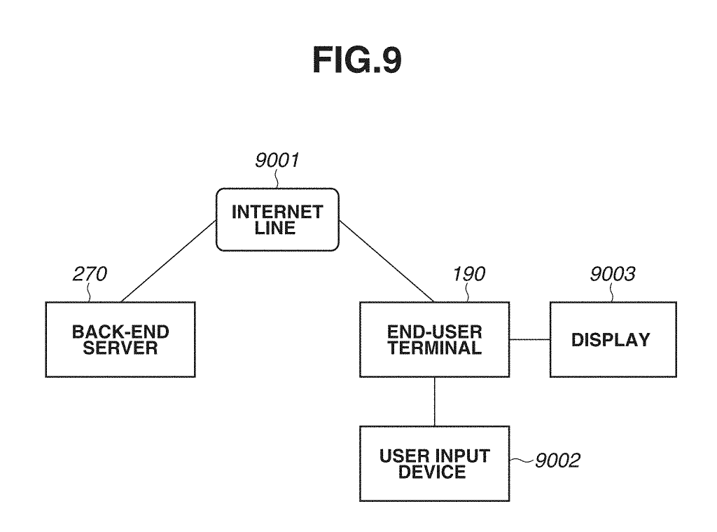

Next, the end-user terminal 190, which the viewer (user) uses, is described. FIG. 9 is a configuration diagram of the end-user terminal 190. The end-user terminal 190, on which a service application runs, is, for example, a personal computer (PC). Furthermore, the end-user terminal 190 is not limited to a PC, but can be, for example, a smartphone, a tablet terminal, or a high-definition large-screen display. The end-user terminal 190 is connected to the back-end server 270, which delivers an image, via an Internet line 9001. For example, the end-user terminal 190 (PC) is connected to a router and the Internet line 9001 via a local area network (LAN) cable or a wireless LAN.

Moreover, a display 9003, on which a virtual viewpoint image of, for example, a sports broadcasting image to be viewed by the viewer is displayed, and a user input device 9002, which receives an operation performed by the viewer to, for example, change a viewpoint, are connected to the end-user terminal 190. For example, the display 9003 is a liquid crystal display and is connected to the PC via a DisplayPort cable. The user input device 9002 is a mouse or keyboard and is connected to the PC via a universal serial bus (USB) cable.

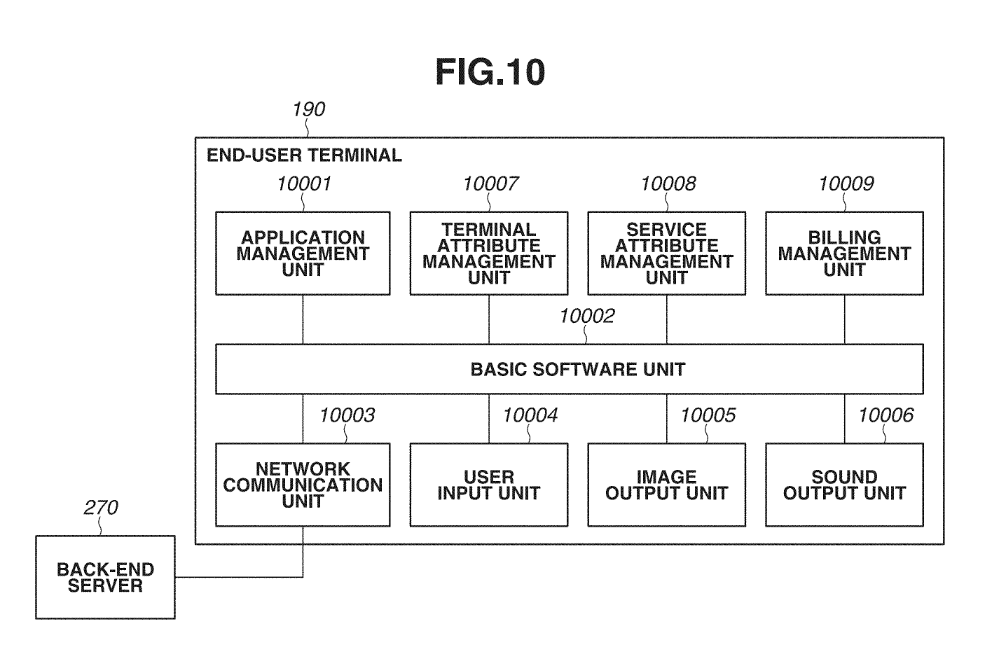

The internal function of the end-user terminal 190 is described. FIG. 10 is a functional block diagram of the end-user terminal 190. An application management unit 10001 converts user input information input from a basic software unit 10002, which is described below, into a back-end server command for the back-end server 270 and outputs the back-end server command to the basic software unit 10002. Moreover, the application management unit 10001 outputs, to the basic software unit 10002, an image drawing instruction for drawing an image input from the basic software unit 10002 onto a predetermined display region.

The basic software unit 10002 is, for example, an operating system (OS) and outputs user input information input from a user input unit 10004, which is described below, to the application management unit 10001. Furthermore, the basic software unit 10002 outputs an image and a sound input from a network communication unit 10003, which is described below, to the application management unit 10001 or outputs a back-end server command input from the application management unit 10001 to the network communication unit 10003. Additionally, the basic software unit 10002 outputs an image drawing instruction input from the application management unit 10001 to an image output unit 10005.

The network communication unit 10003 converts a back-end server command input from the basic software unit 10002 into a LAN communication signal, which is transmittable via a LAN cable, and outputs the LAN communication signal to the back-end server 270. Then, the network communication unit 10003 passes image or sound data received from the back-end server 270 to the basic software unit 10002 to enable the image or sound data to be processed. The user input unit 10004 acquires user input information which is based on a keyboard (physical keyboard or software keyboard) input or a button input or user input information input from the user input device 9002 via a USB cable, and outputs the acquired user input information to the basic software unit 10002.

The image output unit 10005 converts an image which is based on an image display instruction output from the basic software unit 10002 into an image signal and outputs the image signal to, for example, an external display or an integrated display. A sound output unit 10006 outputs sound data which is based on a sound output instruction output from the basic software unit 10002 to an external loudspeaker or an integrated loudspeaker.

A terminal attribute management unit 10007 manages a display resolution of the end-user terminal 190, an image coding codec type thereof, and a terminal type thereof (whether the end-user terminal 190 is, for example, a smartphone or a large-screen display). A service attribute management unit 10008 manages information concerning a service type which is provided to the end-user terminal 190. For example, the type of an application installed in the end-user terminal 190 or an image delivery service which is available are managed. A billing management unit 10009 manages, for example, the number of image delivery scenes receivable according to a registration settlement status or a charging amount about an image delivery service provided to the user.

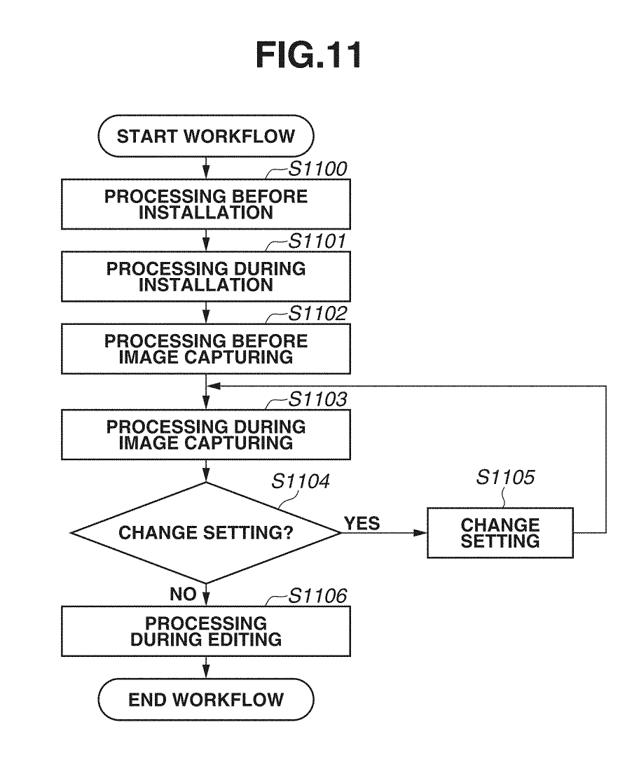

Next, a workflow in the present exemplary embodiment is described. A workflow in a case where image capturing is performed with a plurality of cameras 112 and a plurality of microphones 111 installed in a facility such as a sports arena or a concert hall is described. FIG. 11 is a flowchart illustrating an overview of the workflow. Furthermore, unless otherwise expressly stated, processing of the workflow described below is implemented by a control operation of the controller 300. In other words, control of the workflow is implemented by the controller 300 controlling other devices included in the image processing system 100 (for example, the back-end server 270 and the database 250).

Before starting of the processing illustrated in FIG. 11, the operator (user), who performs an installation or operation on the image processing system 100, collects required information (prior information) prior to the installation and makes a plan. Moreover, before starting of the processing illustrated in FIG. 11, the operator is assumed to previously install equipment in a targeted facility. In step S1100, the control station 310 of the controller 300 receives a setting which is based on the prior information from the user. Next, in step S1101, each device of the image processing system 100 performs processing for checking of system operations according to commands issued from the controller 300 based on an operation performed by the user. Next, in step S1102, the virtual camera operation UI 330 outputs an image and a sound before starting of image capturing of, for example, a game. With this, the user can confirm a sound collected by each microphone 111 and an image captured by each camera 112 before starting of, for example, a game.

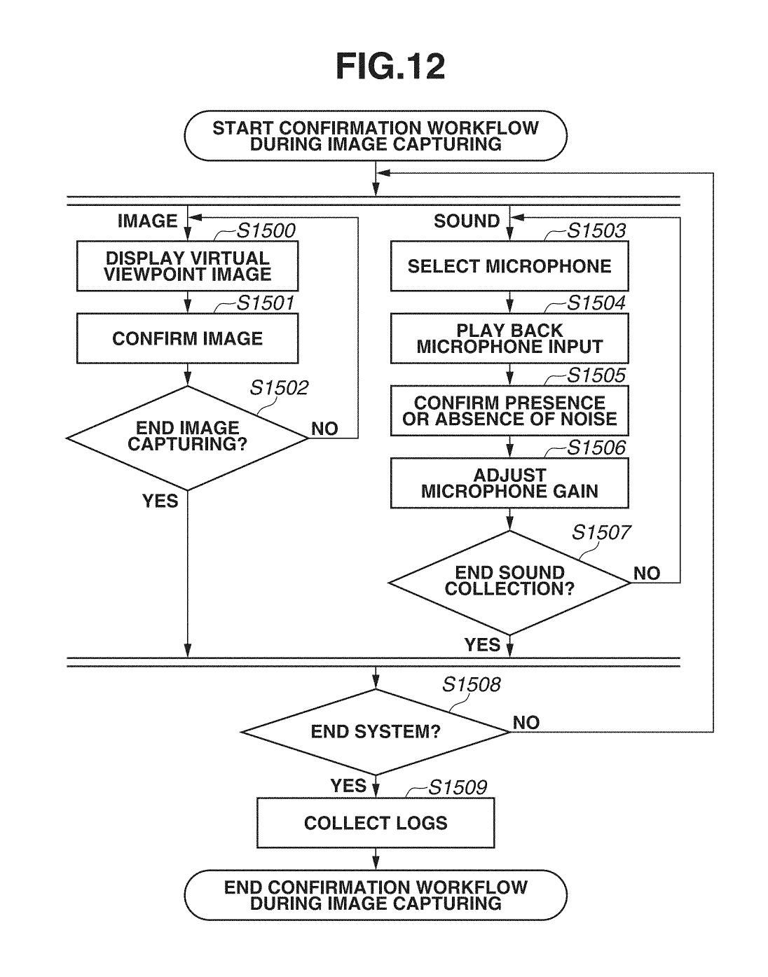

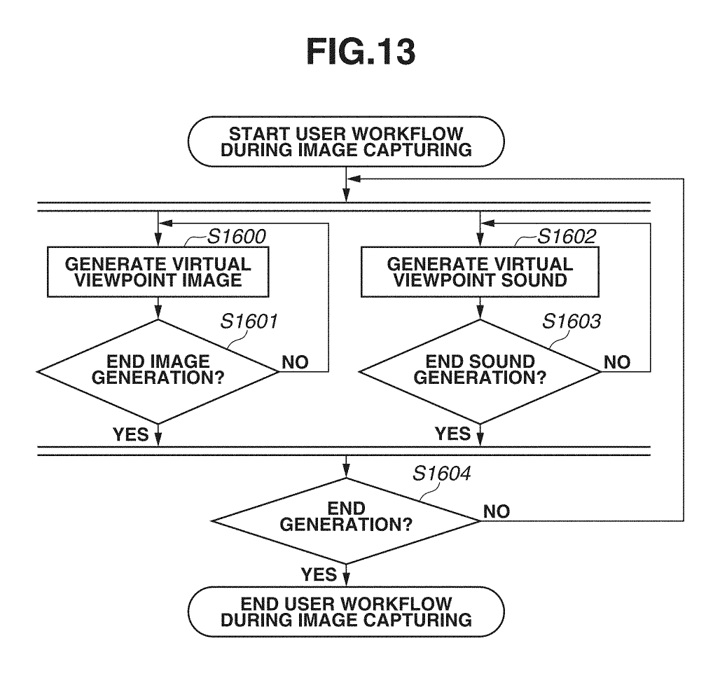

Then, in step S1103, the control station 310 of the controller 300 causes each microphone 111 to perform sound collection and causes each camera 112 to perform image capturing. While image capturing in the present step is assumed to include sound collection performed by each microphone 111, the present exemplary embodiment is not limited to this, but the image capturing can be capturing of only an image. Details of step S1103 are described below with reference to FIG. 12 and FIG. 13. Then, in the case of changing the setting performed in step S1101 or in the case of ending image capturing, the processing proceeds to step S1104. Next, in step S1104, in the case of changing the setting performed in step S1101 and continuing image capturing (YES in step S1104), the processing proceeds to step S1105, and, in the case of completing image capturing (NO in step S1104), the processing proceeds to step S1106. The determination in step S1104 is typically performed based on an input from the user to the controller 300. However, the present exemplary embodiment is not limited to this example. In step S1105, the controller 300 changes the setting performed in step S1101. The changed contents are typically determined based on a user input acquired in step S1104. In a case where changing of the setting in the present step requires stopping image capturing, image capturing is temporarily stopped and image capturing is restarted after the setting is changed. Moreover, in a case where changing of the setting does not require stopping image capturing, changing of the setting is performed in parallel with image capturing.

In step S1106, the controller 300 performs editing of images captured by a plurality of cameras 112 and sounds collected by a plurality of microphones 111. The editing is typically performed based on a user operation input via the virtual camera operation UI 330.

Furthermore, processing in step S1106 and processing in step S1103 can be configured to be performed in parallel. For example, in a case where, for example, images of a sports game or a concert are delivered in real time (for example, images of a game are delivered during the game), image capturing in step S1103 and editing in step S1106 are concurrently performed. Furthermore, in a case where a highlight image in a sports game is delivered after the game, editing is performed after image capturing is ended in step S1104.

Next, details of the above-mentioned step S1103 (processing during image capturing) are described with reference to FIG. 12 and FIG. 13.

In step S1103, system control and confirmation operations are performed by the control station 310 and an operation for generating an image and a sound is performed by the virtual camera operation UI 330.

FIG. 12 illustrates the system control and confirmation operations, and FIG. 13 illustrates the operation for generating an image and a sound. First, the description is made with reference to FIG. 12. In the above-mentioned system control and confirmation operations performed by the control station 310, a control operation for an image and a sound and a confirmation operation are independently and concurrently performed.

First, an operation concerning an image is described. In step S1500, the virtual camera operation UI 330 displays a virtual viewpoint image generated by the back-end server 270. Next, in step S1501, the virtual camera operation UI 330 receives an input concerning a result of confirmation performed by the user about the image displayed in step S1500. Then, in step S1502, if it is determined to end image capturing (YES in step S1502), the processing proceeds to step S1508, and, if it is determined to continue image capturing (NO in step S1502), the processing returns to step S1500. In other words, during a period in which image capturing is continued, steps S1500 and S1501 are repeated. Furthermore, whether to end or continue image capturing can be determined by the control station 310 according to, for example, a user input.

Next, an operation concerning a sound is described. In step S1503, the virtual camera operation UI 330 receives a user operation concerning a result of selection of microphones 111. Furthermore, in a case where the microphones 111 are selected one by one in a predetermined order, the user operation is not necessarily required. In step S1504, the virtual camera operation UI 330 plays back a sound collected by the microphone 111 selected in step S1503. In step S1505, the virtual camera operation UI 330 confirms the presence or absence of noise in the sound played back in step S1504. The determination of the presence or absence of noise in step S1505 can be performed by the operator (user) of the controller 300, can be automatically performed by sound analysis processing, or can be performed by both the operator and the sound analysis processing. In a case where the user determines the presence or absence of noise, in step S1505, the virtual camera operation UI 330 receives an input concerning a result of determination about noise. In a case where the presence of noise is confirmed in step S1505, then in step S1506, the virtual camera operation UI 330 performs adjustment of microphone gain. The adjustment of microphone gain in step S1506 can be performed based on a user operation or can be automatically performed.

Furthermore, in a case where the adjustment of microphone gain is performed based on a user operation, in step S1506, the virtual camera operation UI 330 receives a user input concerning the adjustment of microphone gain and performs the adjustment of microphone gain based on the received user input. Moreover, depending on the state of noise, an operation to stop the selected microphone 111 can be performed. In step S1507, if it is determined to end sound collection (YES in step S1507), the processing proceeds to step S1508, and, if it is determined to continue sound collection (NO in step S1507), the processing returns to step S1503. In other words, during a period in which sound collection is continued, operations in steps S1503, S1504, S1505, and S1506 are repeated. Whether to end or continue sound collection can be determined by the control station 310 according to, for example, a user input.

In step S1508, if it is determined to end the system (YES in step S1508), the processing proceeds to step S1509, and, if it is determined to continue the system (NO in step S1508), the processing proceeds to steps S1500 and S1503. The determination in step S1508 can be performed based on a user operation. In step S1509, logs acquired in the image processing system 100 are collected into the control station 310.

Next, the operation for generating an image and a sound is described with reference to FIG. 13. In the above-mentioned operation for generating an image and a sound performed in the virtual camera operation UI 330, an image and a sound are independently and concurrently generated.

First, an operation concerning an image is described. In step S1600, the virtual camera operation UI 330 issues an instruction for generating a virtual viewpoint image to the back-end server 270. Then, in step S1600, the back-end server 270 generates a virtual viewpoint image according to the instruction received from the virtual camera operation UI 330. In step S1601, if it is determined to end image generation (YES in step S1601), the processing proceeds to step S1604, and if it is determined to continue image generation (NO in step S1601), the processing returns to step S1600. The determination in step S1601 can be performed according to a user operation.

Next, an operation concerning a sound is described. In step S1602, the virtual camera operation UI 330 issues an instruction for generating a virtual viewpoint sound to the back-end server 270. Then, in step S1602, the back-end server 270 generates a virtual viewpoint sound according to the instruction received from the virtual camera operation UI 330. In step S1603, if it is determined to end sound generation (YES in step S1603), the processing proceeds to step S1604, and if it is determined to continue sound generation (NO in step S1603), the processing returns to step S1602. The determination in step S1603 can be performed in conjunction with the determination in step S1601.

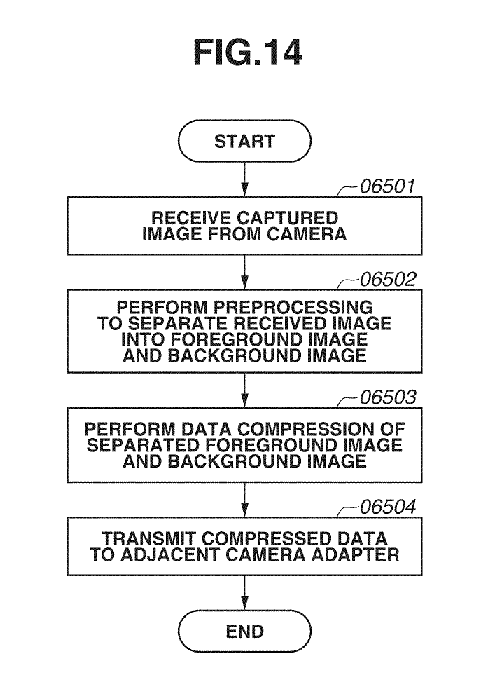

Next, in successive three-dimensional model information generation in a camera adapter 120, the flow of processing for generating and transferring a foreground image and a background image to a subsequent camera adapter 120 is described with reference to FIG. 14.

In step 06501, the camera adapter 120 acquires a captured image from a camera 112 connected to the camera adapter 120 itself.

Next, in step 06502, the camera adapter 120 performs processing for separating the acquired captured image into a foreground image and a background image. Furthermore, the foreground image in the present exemplary embodiment is an image determined based on a result of detection of a predetermined object from a captured image obtained by the camera 112. The predetermined object is, for example, a person. However, the object can be a specific person (for example, player, manager (coach), and/or umpire (judge)), or can be an object with an image pattern previously determined, such as a ball or a goal. Furthermore, a moving body can be detected as the object.

Next, in step 06503, the camera adapter 120 performs compression processing on the separated foreground image and background image. Lossless compression is performed on the foreground image, so that the foreground image keeps high image quality. Lossy compression is performed on the background image, so that the amount of transferred data thereof is reduced.

Next, in step 06504, the camera adapter 120 transfers the compressed foreground image and background image to a subsequent camera adapter 120. Furthermore, the background image can be transferred not at each frame but at intervals of some frames in a thinned-out manner. For example, in a case where a captured image is obtained at 60 fps, while the foreground image is transferred at each frame, the background image is transferred at only one frame out of 60 frames per second. This brings about a specific effect capable of reducing the amount of transferred data.

Furthermore, the camera adapter 120 can perform appending of meta-information when transferring the foreground image and the background image to a subsequent camera adapter 120. For example, an identifier of the camera adapter 120 or the camera 112, the position (x and y coordinates) of the foreground image in a frame, a data size, a frame number, and image capturing time are appended as the meta-information. Moreover, for example, gaze point group information for identifying a gaze point and data type information for identifying a foreground image and a background image can be appended. However, the content of data to be appended is not limited to these, but other types of data can be appended.

Furthermore, when transferring data via a daisy chain, the camera adapter 120 selectively processing only a captured image obtained by a camera 112 having a high correlation with a camera 112 connected to the camera adapter 120 itself enables reducing a transfer processing load in the camera adapter 120. Moreover, configuring a system in such a manner that, in daisy chain transfer, even when a failure occurs in any camera adapter 120, data transfer between camera adapters 120 does not stop enables ensuring robustness.

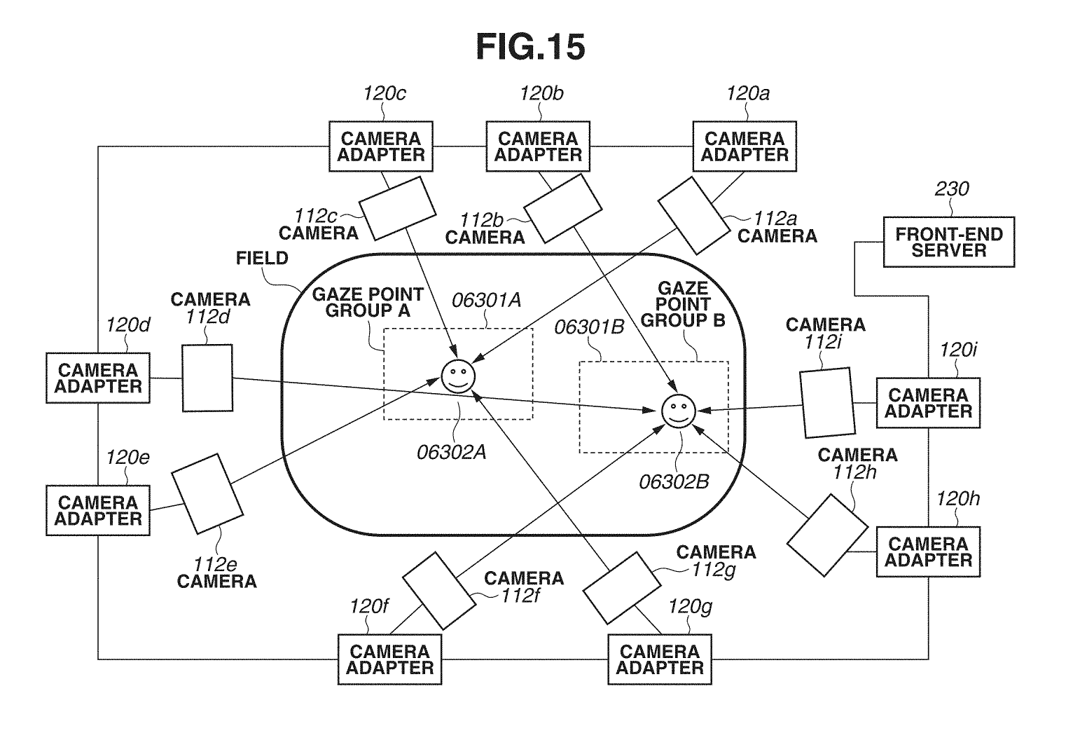

Next, control which is performed according to a gaze point group is described. FIG. 15 is a diagram illustrating the gaze point group. The cameras 112 are installed in such a manner that the respective optical axes thereof are directed to a specific gaze point 06302. The cameras 112 classified into the same gaze point group 06301 are installed in such a way to face the same gaze point 06302.

FIG. 15 illustrates an example in which two gaze points 06302, i.e., a gaze point A (06302A) and a gaze point B (06302B), are set and nine cameras (112a to 112i) are installed. Four cameras (112a, 112c, 112e, and 112g) face the same gaze point A (06302A) and belong to a gaze point group A (06301A). Moreover, the remaining five cameras (112b, 112d, 112f, 112h, and 112i) face the same gaze point B (06302B) and belong to a gaze point group B (06301B).

Here, a set of cameras 112 closest to each other (having the smallest number of connection hops) of the cameras 112 belonging to the same gaze point group 06301 is expressed as being logically adjacent. For example, the camera 112a and the camera 112b, which are physically adjacent, belong to the respective different gaze point groups 06301 and are, therefore, not logically adjacent. The camera 112c is logically adjacent to the camera 112a. On the other hand, the camera 112h and the camera 112i are not only physically adjacent but also logically adjacent. Depending on whether cameras 112 which are physically adjacent are also logically adjacent, different processing operations are performed in the camera adapter 120.

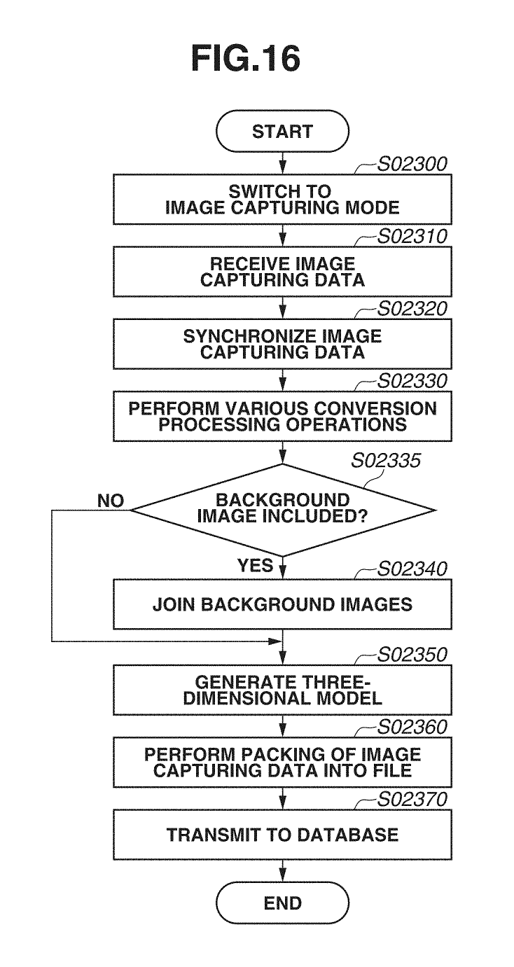

Next, an operation of the front-end server 230 in steps S1500 and S1600 of the workflows during image capturing is described with reference to the flowchart of FIG. 16.

In step S02300, the control unit 02110 receives an instruction for switching to an image capturing mode from the control station 310, and performs switching to the image capturing mode. Upon starting of image capturing, in step S02310, the data input control unit 02120 starts receiving image capturing data from the camera adapter 120.

In step S02320, the data synchronization unit 02130 buffers the image capturing data until image capturing data required for file generation is completely received. Although not expressly mentioned in the flowchart, here, whether time information appended to the image capturing data is matching or whether a predetermined number of cameras are sufficiently provided is determined. Moreover, depending on the status of a camera 112, image data may be unable to be transmitted due to a calibration in progress or error processing in progress. In this case, information indicating that an image obtained by a camera with a specified camera number is lacking is transmitted in the process of transfer to the database 250 (step S02370) in a later stage. Here, to determine the sufficient provision of a predetermined number of cameras, there is a method of waiting the arrival of image capturing data for a predetermined time. Here, in the present exemplary embodiment, to prevent or reduce the delay of a series of system processing operations, when transferring data via a daisy chain, each of the camera adapters 120 appends information indicating the presence or absence of image data corresponding to each associated camera number to the data. This enables the control unit 02110 of the front-end server 230 to make an immediate determination. It should be noted that this bring about an effect of eliminating the necessity of setting a waiting time for arrival of image capturing data.

After the data required for file generation is buffered by the data synchronization unit 02130, in step S02330, the image processing unit 02150 performs various conversion processing operations, such as development processing of RAW image data, lens distortion correction, and matching of colors or luminance values between images captured by the respective cameras of the foreground image and the background image.

In a case where the data buffered by the data synchronization unit 02130 includes a background image (YES in step S02335), then in step S02340, joining processing of background images is performed, and, in a case where the buffered data includes no background image (NO in step S02335), then in step S02350, generation processing of a three-dimensional model is performed.

More specifically, the image joining unit 02170 acquires the background images processed by the image processing unit 02150 in step S02330. Then, in step S02340, the image joining unit 02170 joins the background images in conformity with the coordinates of stadium shape data stored by the CAD data storage unit 02135 in step S02330, and transmits a joined background image to the image capturing data file generation unit 02180. In step S02350, the three-dimensional model joining unit 02160, which has received three-dimensional model data from the data synchronization unit 02130, generates a three-dimensional model of the foreground image using the three-dimensional model data and the camera parameter.

In step S02360, the image capturing data file generation unit 02180, which has received image capturing data generated by the processing performed until step S02350, shapes the image capturing data according to a file format and then performs packing of the data into a file. After that, the image capturing data file generation unit 02180 transmits the generated file to the DB access control unit 02190. In step S02370, the DB access control unit 02190 transmits, to the database 250, the image capturing data file received from the image capturing data file generation unit 02180 in step S02360.

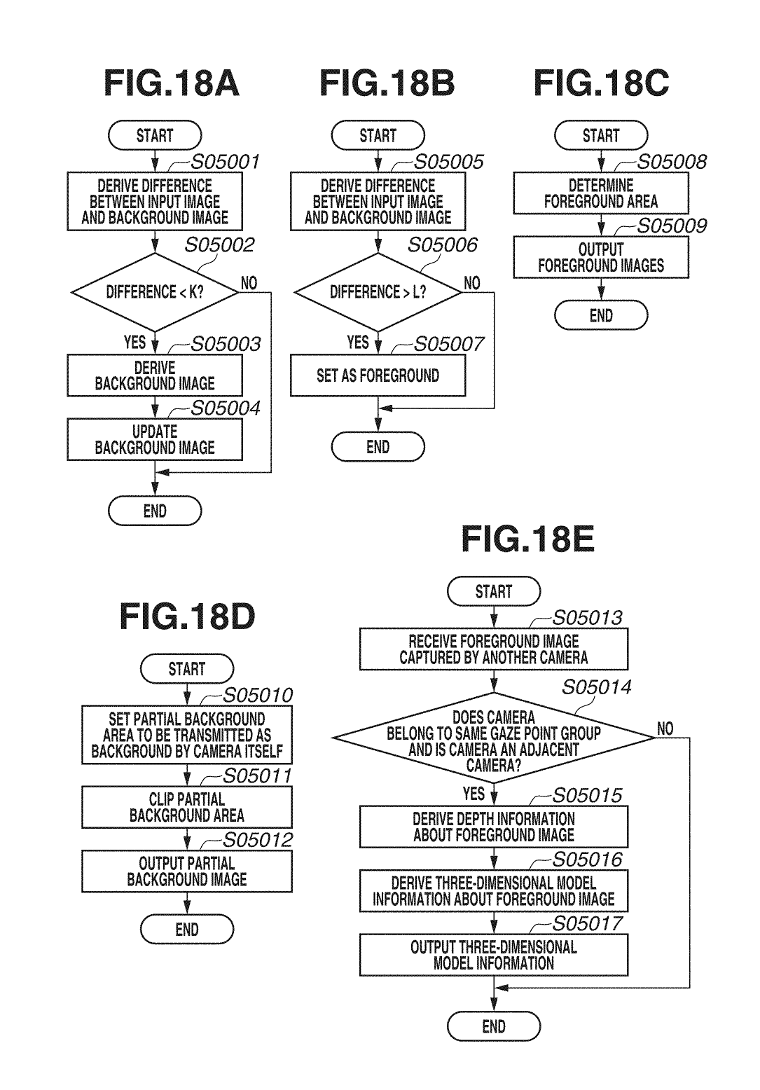

Next, processing performed by the image processing unit 06130 of the camera adapter 120 is described with reference to the flowcharts of FIGS. 18A, 18B, 18C, 18D, and 18E.

Prior to processing illustrated in FIG. 18A, the calibration control unit 06133 performs, on an input image, for example, color correction processing for preventing or reducing variation of colors for each camera and shake correction processing (electronic image stabilization processing) for stabilizing an image by reducing image shake caused by vibration of the camera. In the color correction processing, for example, processing for adding an offset value to pixel values of the input image based on the parameters received from the front-end server 230 is performed. Moreover, in the shake correction processing, the amount of shake of an image is estimated based on output data from a sensor, such as an acceleration sensor or a gyro sensor, incorporated in the camera. Then, processing for shifting the image position or rotating the image is performed with respect to an input image based on the estimated amount of shake, so that shaking between frame images is prevented or reduced. Furthermore, another method can be used as the shake correction method. For example, a method which is implemented inside the camera, such as a method using image processing in such a way as to estimate and correct the amount of movement of images by comparing a plurality of temporally consecutive frame images, a lens shift method, and a sensor shift method, can be employed.

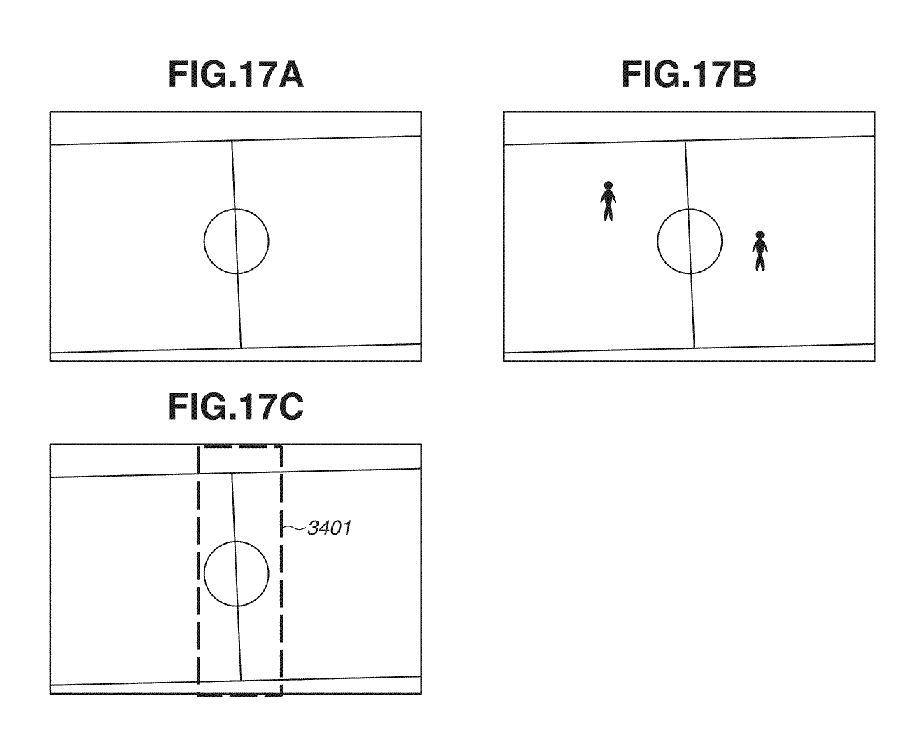

The background updating unit 05003 performs processing for updating the background image 05002 using an input image and a background image stored in a memory. FIG. 17A illustrates an example of the background image. The update processing is performed on each pixel. FIG. 18A illustrates the flow of the update processing.

First, in step S05001, the background updating unit 05003 derives a difference between each pixel of the input image and a pixel located in the corresponding position of the background image. Then, in step S05002, the background updating unit 05003 determines whether the difference is smaller than a predetermined threshold value K. If it is determined that the difference is smaller than the threshold value K (YES in step S05002), the background updating unit 05003 determines that the pixel is included in a background. Then, in step S05003, the background updating unit 05003 derives a value obtained by mixing a pixel value of the input image and a pixel value of the background image at a predetermined ratio. Then, in step S05004, the background updating unit 05003 updates a pixel value in the background image with the derived value.

On the other hand, FIG. 17B illustrates an example in which captured images of persons appear on the background image illustrated in FIG. 17A. In such a case, when attention is focused on a pixel at which a person is located, a difference of the pixel value thereof relative to the background becomes large, so that, in step S05002, the difference becomes equal to or larger than the threshold value K. In that case, since a change in the pixel value is large, it is determined that captured images of some objects other than the background appear, so that updating of the background image 05002 is not performed (NO in step S05002). Furthermore, various other methods can be conceived for the background update processing.

Next, the background clipping unit 05004 reads out a part of the background image 05002 and transmits the read-out part to the transmission unit 06120. In a case where a plurality of cameras 112 is arranged in such a way as to be able to capture an image of the entire field without any blind spot at the time of image capturing of a game, such as a soccer, in, for example, a stadium, a majority of pieces of background information is characterized by overlapping between the cameras 112. Since the background information has an enormous amount of information, the quantity of transmission can be reduced by deleting an overlapping portion of the background information to be transmitted in view of a transmission band restriction. FIG. 18D illustrates the flow of that processing. In step S05010, the background clipping unit 05004 sets a middle portion of the background image such as a partial area 3401 surrounded by a dashed line illustrated in FIG. 17C. Thus, the partial area 3401 is a background area to be transmitted by the current camera 112 itself, and background areas other than the partial area 3401 are to be transmitted by other cameras 112. In step S05011, the background clipping unit 05004 reads out the set partial area 3401 of the background image. Then, in step S05012, the background clipping unit 05004 outputs the partial background image to the transmission unit 06120. The output background images are collected to the image computing server 200 and are used as textures of a background model. The positions at which parts of the background image 05002 are clipped by the respective camera adapters 120 are set according to a predetermined parameter value in such a manner that texture information does not become insufficient for a background model. Usually, to more reduce the amount of data to be transmitted, an area to be clipped is set to a requisite minimum. This brings about an effect of reducing an enormous amount of background information to be transmitted, so that a system compatible with a high-resolution image can be configured.

Next, the foreground separation unit 05001 performs processing for detecting a foreground area (an object such as a person). FIG. 18B illustrates the flow of foreground area detection processing which is performed for each pixel. With regard to detection of a foreground, a method using background difference information is used. First, in step S05005, the foreground separation unit 05001 derives a difference between each pixel of a new input image and a pixel located in the corresponding position of the background image 05002. Then, in step S05006, the foreground separation unit 05001 determines whether the difference is larger than a threshold value L. Here, supposing that, with respect to the background image 05002 illustrated in FIG. 17A, the new input image is such an image as illustrated in FIG. 17B, the difference becomes large in each pixel of an area in which captured images of persons appear. If it is determined that the difference is larger than the threshold value L (YES in step S05006), then in step S05007, the foreground separation unit 05001 sets the pixel as a foreground. Furthermore, in a method for detecting a foreground using background difference information, various contrivances are considered to detect a foreground with a higher degree of accuracy. Moreover, with regard to foreground detection, besides, various methods using, for example, a feature quantity or machine learning can be employed.

After performing the processing illustrated in FIG. 18B for each pixel of an input image, the foreground separation unit 05001 performs processing for determining a foreground area as a block to be output. FIG. 18C illustrates the flow of that processing. In step S05008, with respect to an image in which a foreground area is detected, the foreground separation unit 05001 sets a foreground area in which a plurality of pixels are joined as one foreground image. The processing for detecting an area in which a plurality of pixels are joined is performed using, for example, a region growing method. The region growing method is a known algorithm and, the detailed description thereof is, therefore, omitted. After collecting the foreground areas as the respective foreground images in step S05008, then in step S05009, the foreground separation unit 05001 sequentially reads out and transmits the foreground images to the transmission unit 06120.

Next, the three-dimensional model information generation unit 06132 generates three-dimensional model information using a foreground image. When the camera adapter 120 receives a foreground image obtained from an adjacent camera 112, the foreground image is input to the another-camera foreground reception unit 05006 via the transmission unit 06120. FIG. 18E illustrates the flow of processing performed by the three-dimensional model processing unit 05005 when the foreground image is input. Here, in a case where the image computing server 200 collects image capturing data output from the cameras 112, starts image processing, and generates a virtual viewpoint image, since the amount of calculation is large, the time required for image generation may become long. Particularly, the amount of calculation for three-dimensional model generation may become conspicuously large. Therefore, to reduce the amount of throughput in the image computing server 200, FIG. 18E illustrates a method for sequentially generating three-dimensional model information while data is transferred between the camera adapters 120 via a daisy chain connection.

First, in step S05013, the three-dimensional model information generation unit 06132 receives a foreground image captured by another camera 112. Next, in step S05014, the three-dimensional model information generation unit 06132 checks whether the camera 112 which has captured the received foreground image belongs to the same gaze point group as that of the current camera 112 itself and is an adjacent camera. If the result of checking in step S05014 is YES, the processing proceeds to step S05015. If the result of checking in step S05014 is NO, the three-dimensional model information generation unit 06132 determines that there is no correlation with the foreground image obtained from the separate camera 112, and then ends the processing immediately. Furthermore, while, in step S05014, whether the camera 112 which has captured the received foreground image is an adjacent camera is checked, the method for determining a correlation between the cameras 112 is not limited to this. For example, even a method in which the three-dimensional model information generation unit 06132 previously acquires and sets the camera number of a camera 112 having a correlation and, only when image data captured by that camera 112 is transmitted, inputs and processes the image data can bring about a similar effect.

Next, in step S05015, the three-dimensional model information generation unit 06132 derives depth information about the foreground image. More specifically, the three-dimensional model information generation unit 06132 associates a foreground image received from the foreground separation unit 05001 with a foreground image acquired from another camera 112, and then derives depth information about each pixel of each foreground image based on the coordinate value of each associated pixel and the camera parameters. Here, for example, a block matching method is used as the method for associating images. The block matching method is a well-known method and, the detailed description thereof is, therefore, omitted. Furthermore, with regard to the method for association, besides, there are various methods, such as a method for improving performance by combining, for example, feature point detection, feature amount detection, and matching processing, and any method can be employed.

Next, in step S05016, the three-dimensional model information generation unit 06132 derives three-dimensional model information about the foreground image. More specifically, with respect to each pixel of the foreground image, the three-dimensional model information generation unit 06132 derives a world coordinate value of each pixel based on the depth information derived in step S05015 and the camera parameters stored in the camera parameter reception unit 05007. Then, the three-dimensional model information generation unit 06132 configures a set of the world coordinate value and a pixel value, and sets one piece of point data about a three-dimensional model which is composed of a point group. With the above-described processing, point group information about a part of a three-dimensional model obtained from a foreground image received from the foreground separation unit 05001 and point group information about a part of a three-dimensional model obtained from another camera 112 are obtained. Then, in step S05017, the three-dimensional model information generation unit 06132 appends a camera number and a frame number, which serve as meta-information, to the obtained three-dimensional model information (in which the time information can be, for example, time code or absolute time), and outputs the three-dimensional model information with the meta-information appended thereto to the transmission unit 06120.

With this, even in a case where the camera adapters 120 are interconnected via a daisy chain and a plurality of gaze points is set, image processing can be performed according to the correlation between the cameras 112 while data is transferred via the daisy chain, so that three-dimensional model information can be sequentially generated. As a result, an effect of increasing processing speed is brought about.

Furthermore, in the present exemplary embodiment, each processing described above is performed by hardware, such as a field-programmable gate array (FPGA) or an application specific integrated circuit (ASIC), mounted in the camera adapter 120, but can be performed by software processing using, for example, a CPU, a graphics processing unit (GPU), or a digital signal processor (DSP). Moreover, while, in the present exemplary embodiment, generation of three-dimensional model information is performed inside the camera adapter 120, generation of three-dimensional model information can be performed by the image computing server 200, to which all of the foreground images acquired from the respective cameras 112 are collected.

Next, processing which the back-end server 270 performs to generate a live image and a replay image based on the data accumulated in the database 250 and cause the end-user terminal 190 to display the generated images is described. Furthermore, the back-end server 270 in the present exemplary embodiment generates virtual viewpoint content as a live image and a replay image. In the present exemplary embodiment, the virtual viewpoint content is content generated with captured images obtained from a plurality of camera 112 used as plural-viewpoint images. Thus, the back-end server 270 generates virtual viewpoint content based on viewpoint information designated based on a user operation. Furthermore, while, in the present exemplary embodiment, an example in which sound data (audio data) is contained in the virtual viewpoint content is mainly described, sound data does not necessarily need to be contained.

When the user has operated the virtual camera operation UI 330 to designate a viewpoint, a case where there is no captured image obtained by the camera 112 to generate an image corresponding to the designated viewpoint position (the position of a virtual camera), the resolution of the captured image is not sufficient, or the image quality thereof is low can be seen. In this case, if it is not determined by the stage of image generation that the condition for providing an image to the user is not fulfilled, there is a possibility that the operability of the user becomes impaired. The following describes a method of reducing this possibility.

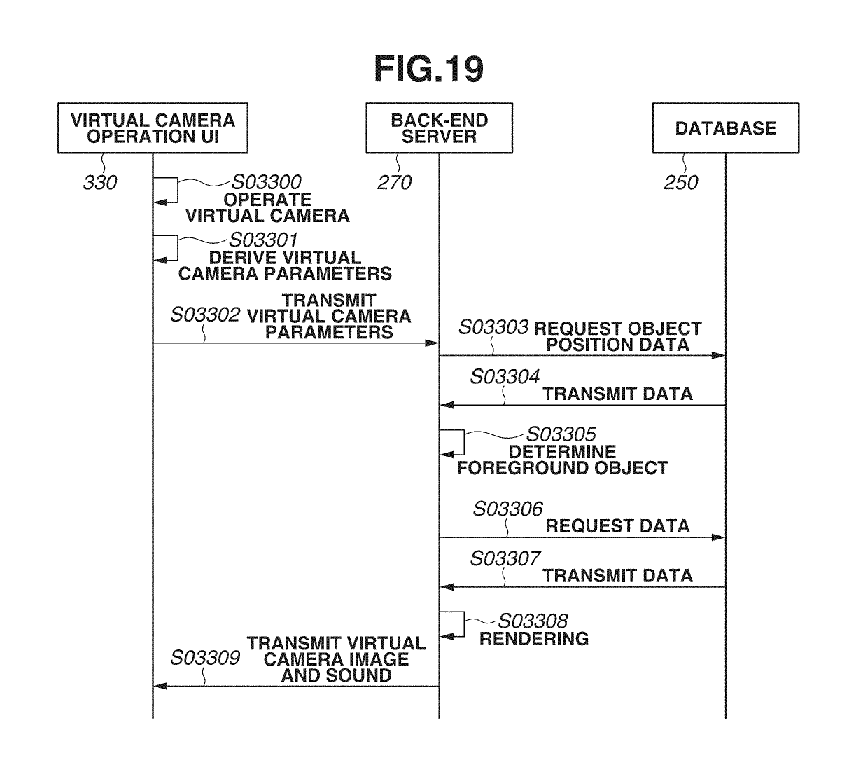

FIG. 19 illustrates the flow of processing which the virtual camera operation UI 330, the back-end server 270, and the database 250 perform from when an operation is performed on the input device by the operator (user) to when a virtual viewpoint image is displayed. First, in step S03300, the operator performs an operation on the input device to operate a virtual camera. The input device to be used includes, for example, a joystick, a jog dial, a touch panel, a keyboard, and a mouse. In step S03301, the virtual camera operation UI 330 derives virtual camera parameters indicating the position and orientation of the input virtual camera. The virtual camera parameters include, for example, an external parameter indicating, for example, the position and orientation of the virtual camera and an internal parameter indicating, for example, a zoom magnification of the virtual camera. In step S03302, the virtual camera operation UI 330 transmits the derived virtual camera parameters to the back-end server 270.

In step S03303, upon receiving the virtual camera parameters, the back-end server 270 requests a foreground three-dimensional model group from the database 250. In step S03304, in response to the request, the database 250 transmits a foreground three-dimensional model group, which includes position information about a foreground object, to the back-end server 270. In step S03305, the back-end server 270 geometrically derives a foreground object group which comes in the field of view of the virtual camera based on the virtual camera parameters and the position information about foreground objects included in the foreground three-dimensional model. In step S03306, the back-end server 270 requests a foreground image of the derived foreground object group, a foreground three-dimensional model, a background image, and a sound data group from the database 250.

In step S03307, in response to the request, the database 250 transmits data to the back-end server 270. In step S03308, the back-end server 270 generates a foreground image and a background image as viewed from a virtual viewpoint from the received foreground image, foreground three-dimensional model, and background image, and combines the foreground image and the background image to generate a full-view image as viewed from the virtual viewpoint. Moreover, the back-end server 270 performs synthesis of sound data corresponding to the virtual camera based on the sound data group, and combines the sound data with the full-view image of the virtual viewpoint to generate an image and sound of the virtual viewpoint. In step S03309, the back-end server 270 transmits the generated image and sound of the virtual viewpoint to the virtual camera operation UI 330. The virtual camera operation UI 330 displays the received image, thus implementing displaying of a captured image of the virtual camera.

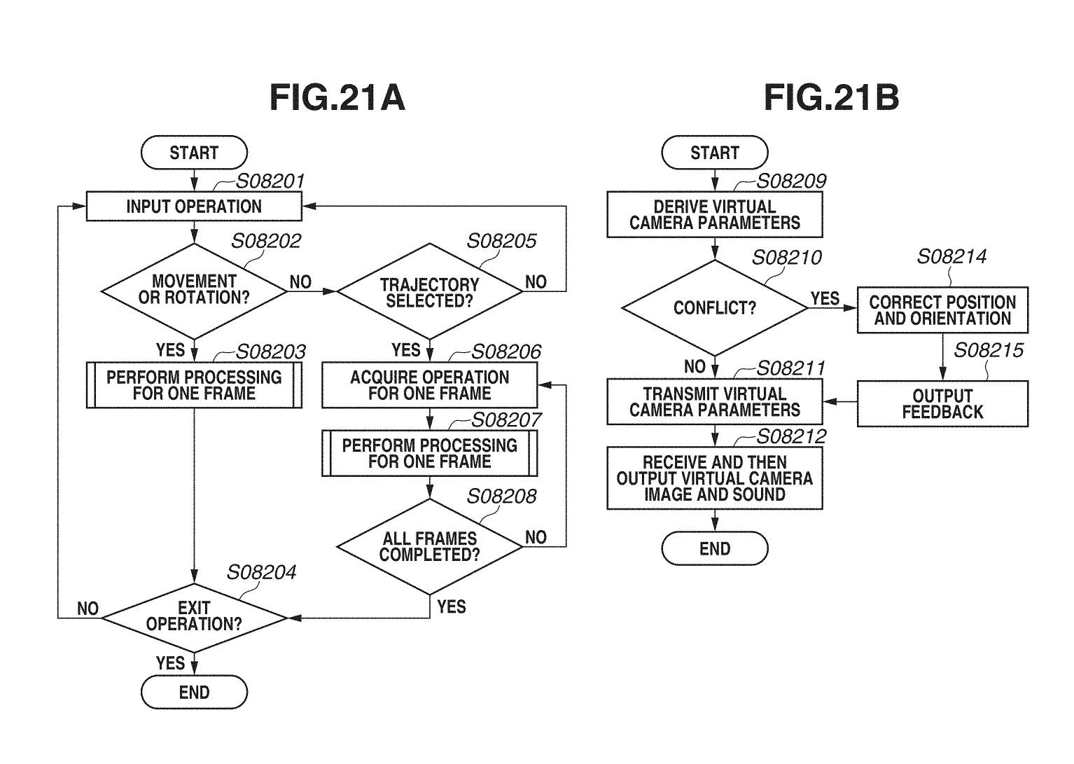

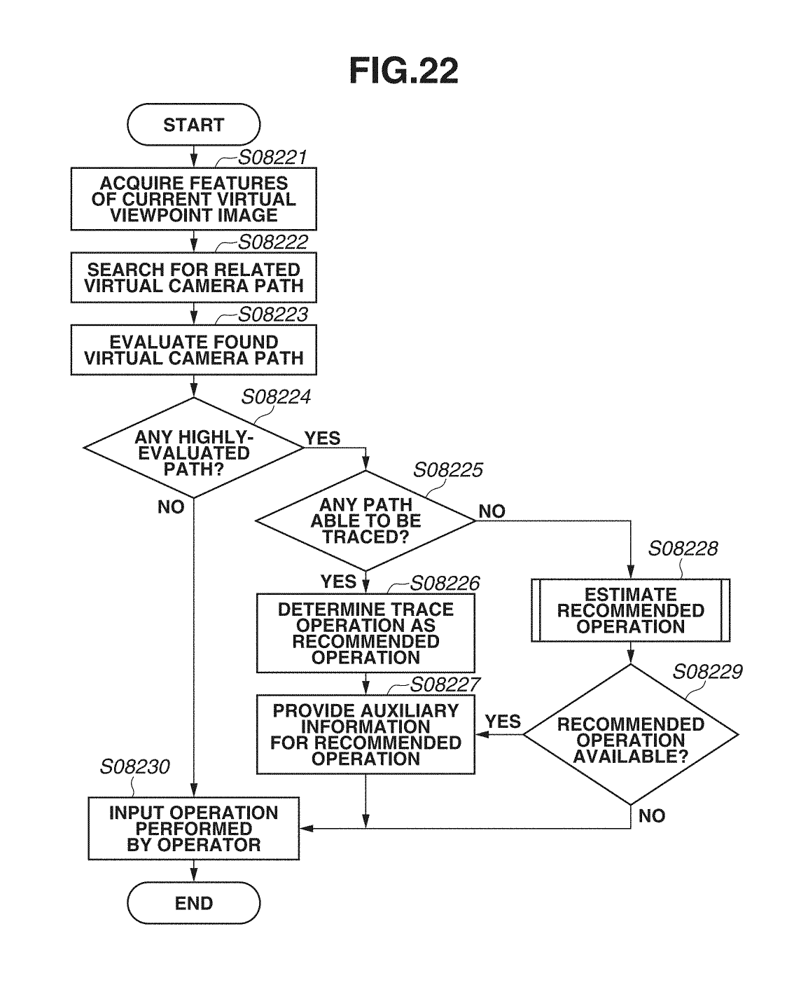

FIG. 21A is a flowchart illustrating a processing procedure which the virtual camera operation UI 330 performs to generate a live image. In step S08201, the virtual camera operation UI 330 acquires operation information input by the operator to the input device so as to operate the virtual camera 08001. Details of the processing in step S08201 are described below with reference to FIG. 22. In step S08202, the virtual camera operation unit 08101 determines whether the operation of the operator is the movement or rotation of the virtual camera 08001. Here, the movement or rotation is performed for each frame. If it is determined that the operation is the movement or rotation (YES in step S08202), the processing proceeds to step S08203. If it is not determined so (NO in step S08202), the processing proceeds to step S08205. Here, the processing branches depending on whether the operation is either a movement operation and a rotation operation or a trajectory selection operation. This enables switching, with a simple operation, between an image expression in which the viewpoint position is rotated with time stopped and an image expression in which a successive motion is expressed.

In step S08203, the virtual camera operation UI 330 performs processing for one frame, which is described with reference to FIG. 21B. In step S08204, the virtual camera operation UI 330 determines whether the user has input an exit operation. If it is determined that the exit operation has been input (YES in step S08204), the processing ends, and, if it is determined that the exit operation has not been input (NO in step S08204), the processing returns to step S08201. Next, in step S08205, the virtual camera operation unit 08101 determines whether a selection operation for a trajectory (virtual camera path) has been input by the operator. For example, the trajectory can be represented by a string of pieces of operation information about the virtual camera 08001 for a plurality of frames. If it is determined that the selection operation for a trajectory has been input (YES in step S08205), the processing proceeds to step S08206. If it is not determined so (NO in step S08205), the processing returns to step S08201.

In step S08206, the virtual camera operation UI 330 acquires an operation for a next frame from the selected trajectory. In step S08207, the virtual camera operation UI 330 performs processing for one frame, which is described with reference to FIG. 21B. In step S08208, the virtual camera operation UI 330 determines whether processing on all of the frames of the selected trajectory has been completed. If it is determined that the processing has been completed (YES in step S08208), the processing proceeds to step S08204. If it is determined that the processing has not yet been completed (NO in step S08208), the processing returns to step S08206.

FIG. 21B is a flowchart illustrating processing for one frame in steps S08203 and S08207. In step S08209, the virtual camera parameter derivation unit 08102 derives virtual camera parameters obtained after the position and orientation are changed. In step S08210, the conflict determination unit 08104 makes a conflict determination. If it is determined that there is a conflict (YES in step S08210), in other words, the virtual camera restriction is not fulfilled, the processing proceeds to step S08214. If it is determined that there is no conflict (NO in step S08210), in other words, the virtual camera restriction is fulfilled, the processing proceeds to step S08211. In this way, a conflict determination is performed by the virtual camera operation UI 330. Then, according to a result of determination, for example, processing for locking the operation unit or for giving warning by displaying a message with a different color is performed. This enables improving the immediacy of feedback to the operator, thus leading an improvement in operability of the operator.

In step S08211, the virtual camera path management unit 08106 transmits the virtual camera parameters to the back-end server 270. In step S08212, the virtual camera image and sound output unit 08108 outputs an image received from the back-end server 270. In step S08214, the virtual camera operation UI 330 corrects the position and orientation of the virtual camera 08001 in such a way as to fulfill the virtual camera restriction. For example, the latest operation input by the user is canceled and the virtual camera parameters are returned to a state obtained one frame before. With this, for example, in a case where a trajectory input is performed and a conflict occurs, the operator is enabled to interactively correct an operation input from a portion at which the conflict occurs without re-performing the operation input from the start, so that operability can be improved. In step S08215, the feedback output unit 08105 notifies the operator that the virtual camera restriction is not fulfilled. Such a notification is performed using, for example, a sound, a message, or a method of locking the virtual camera operation UI 330, but the present exemplary embodiment is not limited to this.

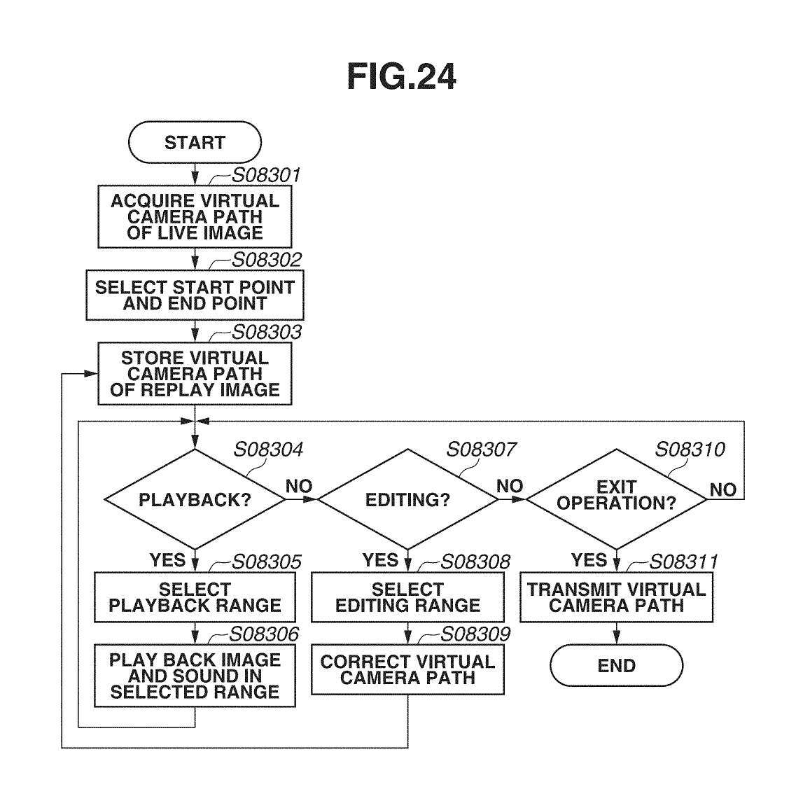

FIG. 24 is a flowchart illustrating a processing procedure performed to generate a replay image according to an operation performed on the virtual camera operation UI 330. In step S08301, the virtual camera path management unit 08106 acquires a virtual camera path 08002 of the live image. In step S08302, the virtual camera path management unit 08106 receives an operation of the operator for selecting a start point and an end point from the virtual camera path 08002 of the live image. For example, a virtual camera path 08002 obtained in a period of 10 seconds before and after a goal scene can be selected. In a case where the live image is set to 60 frames per second, 600 virtual camera parameters are included in the virtual camera path 08002 for 10 seconds. In this way, virtual camera parameter information is managed in association with each frame.

In step S08303, the virtual camera path management unit 08106 stores the selected virtual camera path 08002 for 10 seconds as an initial value of the virtual camera path 08002 of a replay image. Furthermore, in a case where the virtual camera path 08002 has been edited by processing in steps S08307 to S08309, overwrite save is performed with the result of editing. In step S08304, the virtual camera operation UI 330 determines whether the operation input by the operator is a playback operation. If it is determined that the operation is a playback operation (YES in step S08304), the processing proceeds to step S08305. If it is determined that the operation is not a playback operation (NO in step S08304), the processing proceeds to step S08307.

In step S08305, the virtual camera operation UI 330 selects a playback range according to the operator input. In step S08306, an image and sound in the selected range are played back. More specifically, the virtual camera path management unit 08106 sequentially transmits virtual camera parameters included in the virtual camera path 08002 in the selected range to the back-end server 270. Then, the virtual camera image and sound output unit 08108 outputs a virtual viewpoint image and a virtual viewpoint sound received from the back-end server 270.

In step S08307, the virtual camera operation UI 330 determines whether the operation input by the operator is an editing operation. If it is determined that the operation is an editing operation (YES in step S08307), the processing proceeds to step S08308. If it is determined that the operation is not an editing operation (NO in step S08307), the processing proceeds to step S08310. In step S08308, the virtual camera operation UI 330 specifies a range selected by the operator as an editing range. In step S08309, an image and sound in the selected editing range are played back according to processing similar to that in step S08306. However, in this instance, in a case where the virtual camera 08001 is operated via the virtual camera operation unit 08101, a result of that operation is reflected. Thus, a replay image can be edited in such a way as to become an image as viewed from a viewpoint different from that of the live image. Moreover, a replay image can be edited in such a way as to perform slow playback or stopping. For example, editing can be performed in such a way as to move a viewpoint with time stopped. In step S08310, the virtual camera operation UI 330 determines whether the operation input by the operator is an exit operation. If it is determined that the operation is an exit operation (YES in step S08310), the processing proceeds to step S08311. If it is determined that the operation is not an exit operation (NO in step S08310), the processing returns to step S08304. In step S08311, the virtual camera operation UI 330 transmits the edited virtual camera path 08002 to the back-end server 270.

FIG. 22 is a flowchart illustrating details of processing for inputting an operation performed by the operator in step S08201 illustrated in FIG. 21A. In step S08221, the virtual viewpoint image evaluation unit 081091 of the virtual camera control AI unit 08109 acquires features of a virtual viewpoint image currently output from the virtual camera image and sound output unit 08108. The features of a virtual viewpoint image includes an image-based feature which is obtained from a foreground image and a background image used for generation of a virtual viewpoint image and a geometric feature which is obtained from a virtual camera parameter and a three-dimensional model. Examples of the image-based feature include the type of a subject or identification information about an individual person contained in a foreground and a background, which is acquired by, for example, known object recognition, face recognition, or character recognition. Here, in a case where the operator is operating the virtual camera operation UI 330 to generate a live image, in order to increase the accuracy of control described below, it is desirable that a target for feature extraction be a virtual viewpoint image generated from a current captured image. However, since there is a case where a delay is contained in an output image obtained via the back-end server 270, in that case, a virtual viewpoint image output from a frame closest to the current time becomes most appropriate. Furthermore, the features of a virtual viewpoint image can include features obtained from outputs of not only the latest frame but also several past frames, or can include features obtained from outputs of all of the frames from the start output as a live image. Moreover, the features of a virtual viewpoint image can include not only features obtained from a virtual viewpoint image but also image features obtained in the above-mentioned method from actually captured images obtained by a plurality of cameras 112 and serving as materials for a virtual viewpoint image.

In step S08222, the virtual viewpoint image evaluation unit 081091 searches for a virtual camera path related to the current virtual viewpoint image using the features acquired in step S08221. As a result of this search, a plurality of related virtual camera paths is found. The related virtual camera path refers to a virtual camera path including a virtual viewpoint image having a composition similar to that of the current output image at a starting point or a halfway point among existing virtual camera paths accumulated in the virtual camera path management unit 08106. Thus, the related virtual camera path is acquired from the existing virtual camera paths available to output a virtual viewpoint image having a similar composition by performing a predetermined virtual camera operation from the current time. Furthermore, a virtual camera path including a virtual viewpoint image searched for using, for example, the above-mentioned features under the condition not including a similar composition but including the same or same type of image capturing target can be acquired. Additionally, a merely highly-evaluated virtual camera path or a virtual camera path including a virtual viewpoint image similar in image capturing situation can be searched for. Examples of the image capturing situation include time, season, temperature environment, and type of image capturing target.

In step S08223, the virtual viewpoint image evaluation unit 081091 sets an evaluation value with respect to each of a plurality of the virtual camera paths found in step S08222. This evaluation is performed by acquiring, for each of the plurality of virtual camera paths, via the user data server 400, evaluations made by the end-users about virtual viewpoint images previously output according to the found virtual camera path. More specifically, for example, an evaluation value with respect to the virtual camera path can be set by adding together evaluation values set by the end-users with respect to the respective virtual viewpoint images included in the virtual camera path. Furthermore, the evaluation value can be one-dimensional or multidimensional. As mentioned above, the virtual viewpoint image evaluation unit 081091 learns a relationship between a feature obtained from a virtual viewpoint image and evaluation information obtained from the user data server 400. The virtual viewpoint image evaluation unit 081091 can be configured as a machine learning device which calculates a quantitative evaluation value with respect to an optional virtual viewpoint image. In a case where a live image is being generated, this learning can be performed in real time. In other words, virtual viewpoint images generated by the operation of the operator until a certain point of time and end-user evaluations varying in real time with respect to the virtual viewpoint images can be immediately learned. As a result, an evaluation value calculated by the virtual viewpoint image evaluation unit 081091 with respect to the same virtual viewpoint image varies with time for evaluation. In this way, an evaluation value set is determined, where the evaluation value set contains an evaluation value for each of the plurality of virtual camera paths.

In step S08224, the virtual viewpoint image evaluation unit 081091 selects a virtual camera path highly evaluated in the evaluation value set in step S08223. If there are one or more selected highly-evaluated virtual camera paths (YES in step S08224), the processing proceeds to step S08225. Thus, not only one but also a plurality of highly-evaluated virtual camera paths can be selected. If there is no highly-evaluated virtual camera path (NO in step S08224), the processing proceeds to step S08230. In step S08225, the virtual viewpoint image evaluation unit 081091 checks whether a path able to be traced and including a virtual viewpoint image the feature of which is consistent or approximately consistent with that of the current virtual viewpoint image is present among the highly-evaluated virtual camera paths selected in step S08224. If it is determined that the path able to be traced is present (YES in step S08225), the processing proceeds to step S08226, and if it is determined that the path able to be traced is not present (NO in step S08225), the processing proceeds to step S08228. In step S08226, the virtual camera control AI unit 08109 determines that the same operation as the virtual camera operation in the path able to be traced determined to be present in step S08225 is a recommended operation for the operator. In other words, the virtual camera control AI unit 08109 performs an operation determination to set, as a recommended operation, a virtual camera operation performed to shift from a virtual viewpoint image coinciding with the current virtual viewpoint image to virtual viewpoint images of subsequent frames in the path able to be traced.

In step S08227, the virtual camera control AI unit 08109 provides (presents) auxiliary information, which enables the operator to easily input the recommended operation determined in step S08226, to the operator via the feedback output unit 08105. The method for providing the auxiliary information can be not only a method of directly expressing a recommended operation via a display unit or sound but also a method of displaying an evaluation value or evaluation content of a virtual viewpoint image generated by the recommended operation to prompt the recommended operation. Furthermore, in a case where there is a plurality of recommended operations, an interface available for selection of a recommended operation can be provided. For example, a plurality of virtual viewpoint images highly evaluated by the end-users can be displayed as virtual viewpoint images to be generated from now by a plurality of different operations, and character expressions using, for example, evaluation values or evaluation axes thereof can be superimposed on the respective virtual viewpoint images, so that the operator can easily select an intended output. Then, the processing proceeds to step S08230.

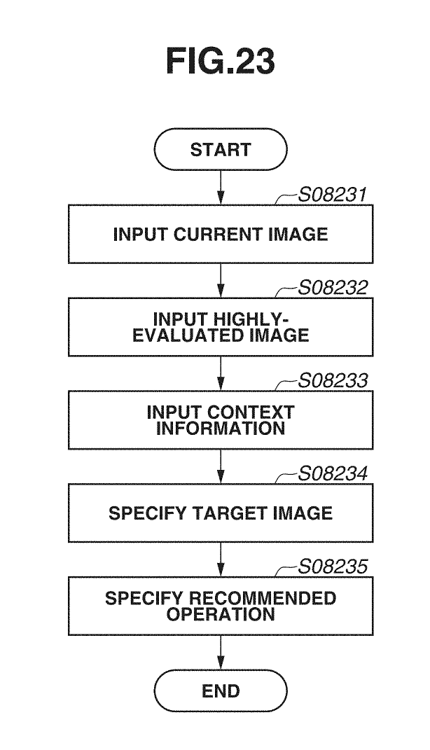

On the other hand, if, in step S08225, it is determined that the path able to be traced is not present (NO in step S08225), the processing proceeds to step S08228. In step S08228, the recommended operation estimation unit 081092 of the virtual camera control AI unit 08109 estimates a recommended operation for the operator from the features of the current virtual viewpoint image and the highly-evaluated virtual camera paths. Details of the estimation processing in step S08228 are described below with reference to FIG. 23. In step S08229, the virtual camera control AI unit 08109 determines whether the recommended operation estimated in step S08228 is available. The case where the recommended operation is unavailable includes not only the case where the recommended operation is a camera operation which is inhibited by the conflict determination unit 08104 but also the case where the recommended operation estimation unit 081092 determines that there is no recommended operation. If it is determined that the recommended operation is available (YES in step S08229), the processing proceeds to step S08227, in which the virtual camera control AI unit 08109 provides auxiliary information, which enables the operator to easily input the recommended operation estimated in step S08228, to the operator. If it is determined that the recommended operation is unavailable (NO in step S08229), the processing proceeds to step S08230.

In step S08230, the operator operates the virtual camera via the virtual camera operation unit 08101 while referring to the auxiliary information provided in step S08227, and the processing then ends. Here, instead of the operator actually inputting the recommended operation, the recommended operation can be configured to be automatically input. Whether the recommended operation is automatically input can be selected by the operator or can be determined based on, for example, the difficulty or time of the operation. Furthermore, if there is no highly-evaluated virtual camera path in step S08224 or if it is determined that the recommended operation is unavailable in step S08229, the operator inputs the virtual camera operation to the virtual camera operation unit 08101 without any auxiliary information, and the processing in the present flowchart then ends.

FIG. 23 is a flowchart illustrating details of processing for estimating a recommended operation in step S08228 illustrated in FIG. 22. In step S08231, the virtual camera control AI unit 08109 inputs the features acquired in step S08221 as information about the current image to the recommended operation estimation unit 081092. In step S08232, the virtual camera control AI unit 08109 inputs a virtual viewpoint image included in the highly-evaluated virtual camera path selected in step S08224 as information about a highly-evaluated image to the recommended operation estimation unit 081092.

In step S08233, the virtual camera control AI unit 08109 inputs context information to the recommended operation estimation unit 081092. The context information refers to information which is related to the evaluation of a virtual viewpoint image and which is obtained from other than virtual viewpoint images. For example, in the case of a virtual viewpoint image in which the image capturing target is a sporting event, the context information is data concerning, for example, the performance of each sports player or a team thereof. Furthermore, the context information can be data concerning, for example, the opening date and time and the venue of a game or the purpose of a game, such as a regional preliminary or a world championship final game. Moreover, the context information can include evaluations or impressions by end-users or viewers concerning virtual viewpoint images which are collected and accumulated by the user data server 400. The context information can be information which is fixed during image capturing or information which varies in real time. For example, the context information can include the development state of a game, the performance of the day of each game player, reactions at present of spectators or viewers.

In step S08234, the recommended operation estimation unit 081092 performs image determination to determine a target image based on the input information. The target image refers to a virtual viewpoint image the value of outputting of which is determined to be high in consideration of the context information input in step S08233 among the highly-evaluated images input in step S08232. For example, in a case where the highly-evaluated images include a virtual viewpoint image which contains a plurality of players and a virtual viewpoint image which is obtained by performing image capturing of a specific player in closeup, the value of outputting of a virtual viewpoint image which enables the image of a player in which viewers are highly interested to be captured in a large size can be determined to be high as the context information. Alternatively, the weather can be used as the context information, so that the value of outputting of a virtual viewpoint image having a composition which contains a high proportion of the blue sky during the fine weather can be determined to be high. A group of real-time viewers can be used as the context information, so that the value of outputting of an image of the region of face of a specific player can be determined to be high with respect to young viewers. High status information such as live score can be manually input by the operator or can be automatically interpreted by the user data server 400 as the context information. Furthermore, the target image can be one or a plurality of images. Processing for specifying the target image can be performed with use of a machine learning device which receives the current image, the highly-evaluated images, and the context information and has learned to select a target image the value of outputting of which is high from among the highly-evaluated images. This learning can be progressively updated according to end-user evaluations performed with respect to virtual viewpoint images collected and accumulated by the user data server 400, and, for example, learning can be performed in real time with end-user evaluations obtained via an interactive communication function of digital broadcasting.

In step S08235, the recommended operation estimation unit 081092 specifies, as a recommended operation, an operation which the operator is required to input to generate the target image specified in step S08234 as a virtual viewpoint image. Alternatively, in a case where there is no past operation performed to generate a target image from the current virtual viewpoint image, the recommended operation estimation unit 081092 determines that there is no recommended operation. This specifying operation can be performed by a known machine learning device which has learned changes of a virtual viewpoint image caused by an operation of the operator, in other words, changes of feature amounts between virtual viewpoint images obtained before and after the operation. This learning can be previously performed based on operations performed by a skilled operator, or the learning content can be progressively updated in real time based on operations performed by an operator who uses the virtual camera operation UI 330. In that case, since cases where a recommended operation becomes able to be estimated are accumulated, the rate of specifying a recommended operation increases with operation times. Furthermore, an operation which a large number of operators performed can be determined to be an operation which is high in effect, so that the quality of a recommended operation can be improved. After the specified recommended operation or the absence of a recommended operation is output by the recommended operation estimation unit 081092, the flowchart of FIG. 23 ends.

As already mentioned above, each of the virtual viewpoint image evaluation unit 081091 and the recommended operation estimation unit 081092, which constitute the virtual camera control AI unit 08109, can be configured with one or more machine learning devices capable of real-time learning. This configuration enables supporting generation of a virtual viewpoint image that can be highly evaluated in response to a plurality of situations varying in real time, such as operations of the operator and end-user evaluations.

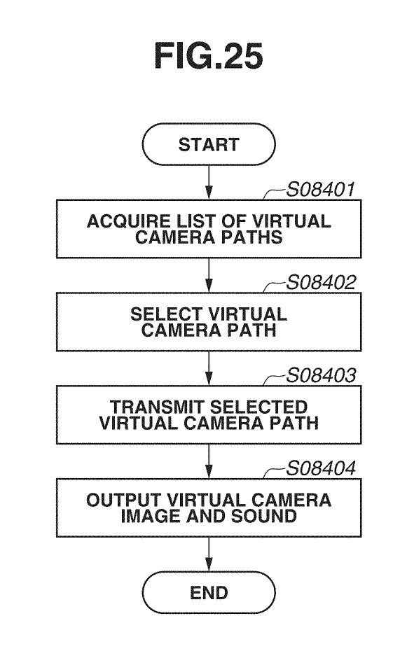

FIG. 25 is a flowchart illustrating a processing procedure for enabling the user to select and view an intended virtual camera image from among a plurality of virtual camera images generated with use of the virtual camera operation UI 330. For example, the user views a virtual camera image using the end-user terminal 190. Furthermore, the virtual camera path 08002 can be accumulated in the image computing server 200 or can be accumulated in a web server (not illustrated) other than that.

In step S08401, the end-user terminal 190 acquires a list of virtual camera paths 08002. Each virtual camera path 08002 can have, for example, a thumbnail or a user evaluation appended thereto. Moreover, in step S08401, the acquired list of virtual camera paths 08002 is displayed on the end-user terminal 190. In step S08402, the end-user terminal 190 acquires designation information concerning a virtual camera path 08002 selected by the user from among the list. In step S08403, the end-user terminal 190 transmits the virtual camera path 08002 selected by the user to the back-end server 270. The back-end server 270 generates a virtual viewpoint image and a virtual viewpoint sound based on the received virtual camera path 08002, and transmits the generated virtual viewpoint image and virtual viewpoint sound to the end-user terminal 190. In step S08404, the end-user terminal 190 outputs the virtual viewpoint image and virtual viewpoint sound received from the back-end server 270.

In this way, a list of virtual camera paths is accumulated to enable playing back an image based on a virtual camera path afterward, so that it becomes unnecessary to always continue accumulating virtual viewpoint images and it becomes possible to reduce the cost of an accumulation device. Furthermore, in a case where image generation for a high-priority virtual camera path is requested, that request can be responded to by lowering the order of image generation for a low-priority virtual camera path. Moreover, it should be noted that, in a case where a virtual camera path is released via a web server, a virtual viewpoint image can be provided to or shared by end-users connected to the web server, so that an effect of improving service performance for the user is brought about.

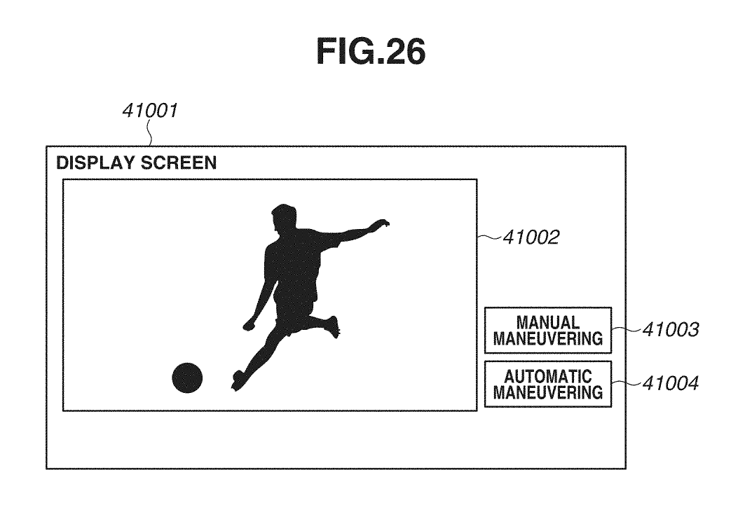

A screen which is displayed on the end-user terminal 190 is described. FIG. 26 illustrates an example of a display screen 41001 which the end-user terminal 190 displays. The end-user terminal 190 sequentially displays images input from the back-end server 270 at a region 41002, which is used for image display, thus enabling the viewer (user) to view a virtual viewpoint image of, for example, a soccer game. The viewer can switch viewpoints of images by operating a user input device according to the displayed image. For example, when the user moves the mouse to the left, an image the viewpoint of which faces in the leftward direction in the displayed image is displayed. When the user moves the mouse upward, an image obtained by looking upward in the displayed image is displayed.

A button 41003 and a button 41004, serving as graphical user interfaces (GUIs), which are operable to switch between manual maneuvering and automatic maneuvering are provided on a region other than the region 41002 for image display. The viewer can perform an operation on the button 41003 or 41004 to select whether to directly change the viewpoint for viewing or to perform viewing at a previously set viewpoint. For example, a certain end-user terminal 190 can upload, at appropriate times, viewpoint operation information, which indicates a result of switching of the viewpoint by user's manual maneuvering, to the image computing server 200 or a web server (not illustrated). Then, the user who operates another end-user terminal 190 can acquire the viewpoint operation information and view a virtual viewpoint image corresponding thereto. Moreover, a rating with respect to viewpoint operation information to be uploaded can be performed to enable the user to select and view, for example, an image corresponding to highly favored viewpoint operation information, so that a specific effect of enabling even a user inexperienced in an operation to readily use the present service is brought about.

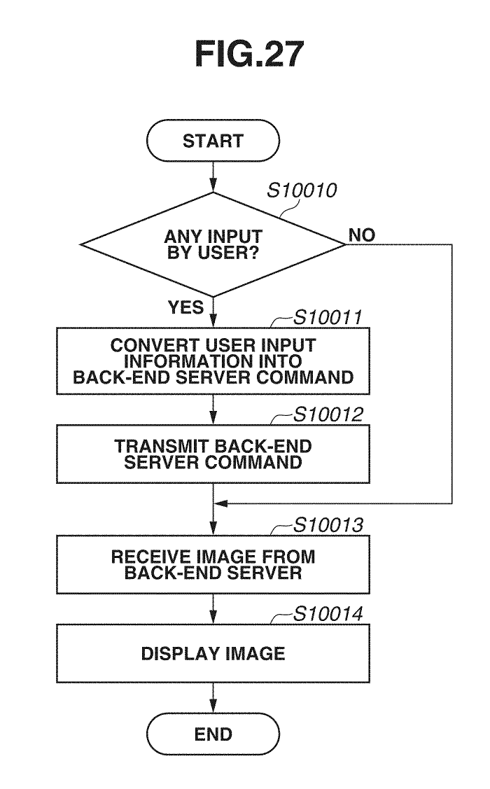

Next, an operation of the application management unit 10001 performed when the viewer selects manual maneuvering and performs a manual maneuvering operation is described. FIG. 27 is a flowchart illustrating manual maneuvering processing performed by the application management unit 10001. In step S10010, the application management unit 10001 determines whether there is an input by the user. If it is determined that there is an input by the user (YES in step S10010), then in step S10011, the application management unit 10001 converts the user input information into a back-end server command, which is recognizable by the back-end server 270. On the other hand, if it is determined that there is no input by the user (NO in step S10010), the processing proceeds to step S10013.

Next, in step S10012, the application management unit 10001 transmits the back-end server command to the back-end server 270 via the basic software unit 10002 and the network communication unit 10003. After the back-end server 270 generates an image with the viewpoint thereof changed based on the user input information, then in step S10013, the application management unit 10001 receives the image from the back-end server 270 via the network communication unit 10003 and the basic software unit 10002. Then, in step S10014, the application management unit 10001 displays the received image at a predetermined image display region 41002. With the above-mentioned processing performed, the viewpoint of an image is changed by manual maneuvering.

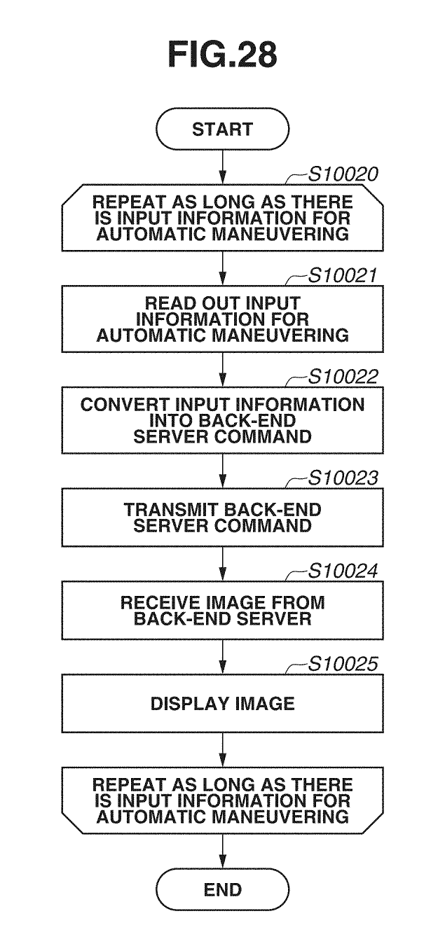

Subsequently, an operation of the application management unit 10001 performed when the viewer (user) selects automatic maneuvering is described. FIG. 28 is a flowchart illustrating automatic maneuvering processing performed by the application management unit 10001. In a case where, in step S10020, there is input information for automatic maneuvering, then in step S10021, the application management unit 10001 reads out the input information for automatic maneuvering. In step S10022, the application management unit 10001 converts the read-out input information for automatic maneuvering into a back-end server command, which is recognizable by the back-end server 270.

Next, in step S10023, the application management unit 10001 transmits the back-end server command to the back-end server 270 via the basic software unit 10002 and the network communication unit 10003.

The back-end server 270 generates an image with the viewpoint thereof changed based on the user input information. Then, in step S10024, the application management unit 10001 receives the image from the back-end server 270 via the network communication unit 10003 and the basic software unit 10002. Finally, in step S10025, the application management unit 10001 displays the received image at a predetermined image display region. The application management unit 10001 repeatedly performs the above-mentioned processing as long as there is input information for automatic maneuvering, so that the viewpoint of an image is changed by automatic maneuvering.

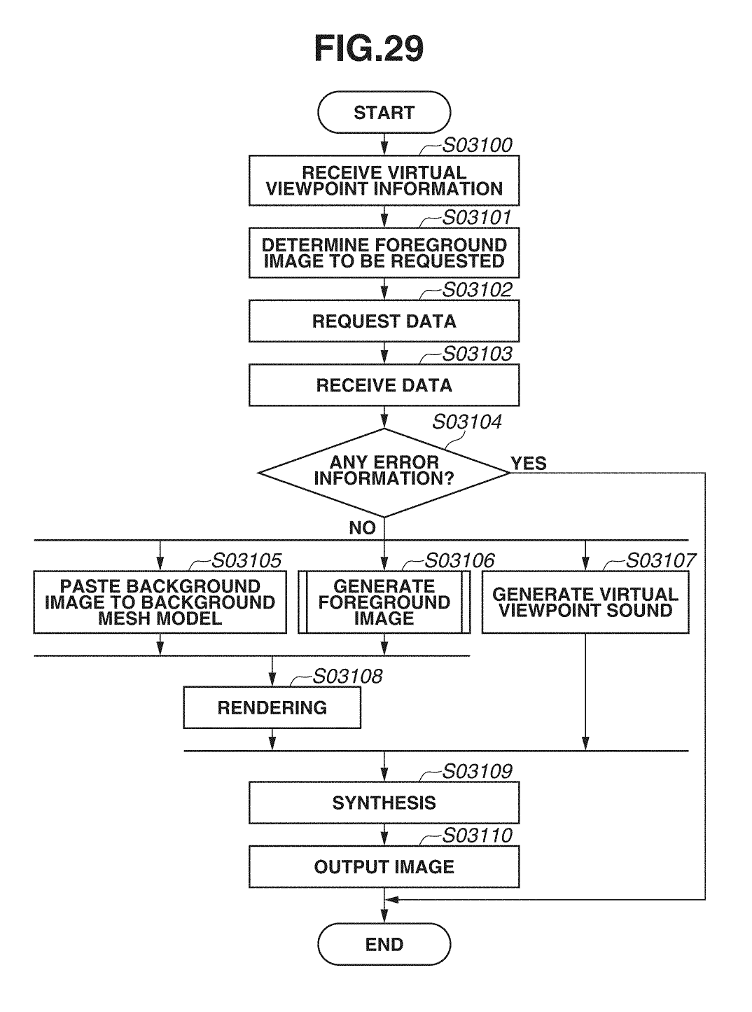

FIG. 29 illustrates the flow of processing performed by the back-end server 270 to generate a virtual viewpoint image for one frame. First, in step S03100, the data reception unit 03001 receives virtual camera parameters from the controller 300. As mentioned above, the virtual camera parameters are data indicating, for example, the position and orientation of a virtual viewpoint. In step S03101, the foreground object determination unit 03010 determines a foreground object required to generate a virtual viewpoint image based on the received virtual camera parameters and the position of the foreground object. The foreground object determination unit 03010 three-dimensionally and geometrically finds a foreground object which comes in the field of view as viewed from a virtual viewpoint. In step S03102, the request list generation unit 03011 generates a request list of a foreground image of the determined foreground object, a foreground three-dimensional model group, a background image, and a sound data group, and transmits the request list to the database 250 via the request data output unit 03012. The request list is the content of data which is requested from the database 250.

In step S03103, the data reception unit 03001 receives the requested information from the database 250. In step S03104, the data reception unit 03001 determines whether information indicating an error is included in the information received from the database 250. Here, examples of the information indicating an error include the overflow of the amount of image transfer, failure of image capturing, and failure of save of an image to a database. This error information is information stored in the database 250.

If, in step S03104, it is determined that the information indicating an error is included (YES in step S03104), the data reception unit 03001 determines that it is impossible to generate a virtual viewpoint image, and thus ends the processing without outputting data. If, in step S03104, it is determined that the information indicating an error is not included (NO in step S03104), the back-end server 270 performs generation of a background image and generation of a foreground image in a virtual viewpoint and generation of a sound corresponding to the viewpoint. In step S03105, the background texture pasting unit 03002 generates a texture-pasted background mesh model from a background mesh model acquired after start-up of the system and retained by the background mesh model management unit 03013 and a background image acquired from the database 250.

Furthermore, in step S03106, the back-end server 270 generates a foreground image according to a rendering mode. Moreover, in step S03107, the back-end server 270 generates a sound by synthesizing a sound data group in such a way as to simulate a hearing manner at a virtual viewpoint. In synthesis of the sound data group, the respective magnitudes of pieces of sound data to be combined are adjusted based on the virtual viewpoint and the acquisition position of sound data. In step S03108, the rendering unit 03006 generates a full-view image as viewed from the virtual viewpoint by cropping the texture-pasted background mesh model generated in step S03105 to a field of view as viewed from the virtual viewpoint and combining the foreground image with the cropped background mesh model.

In step S03109, the synthesis unit 03008 integrates the virtual sound generated in generation of a virtual viewpoint sound (step S03107) and the full-view image as viewed from the virtual viewpoint obtained by rendering, thus generating virtual viewpoint content for one frame. In step S03110, the image output unit 03009 outputs the generated virtual viewpoint content for one frame to the controller 300 and the end-user terminal 190, which are outside the back-end server 270.

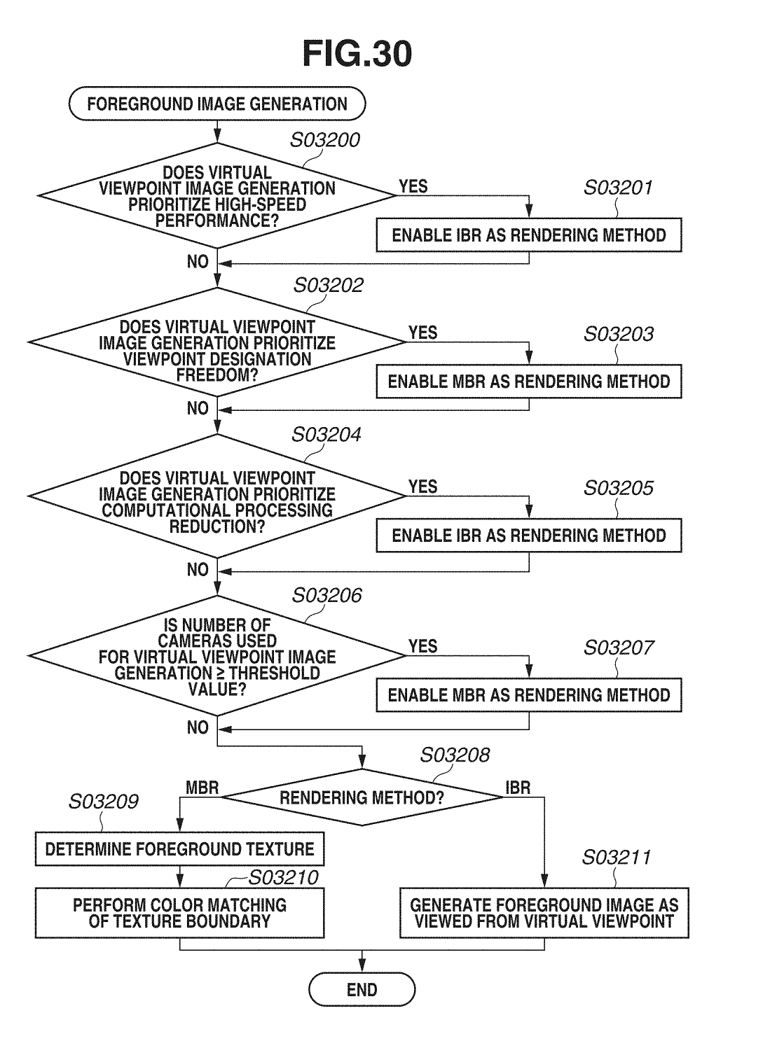

Next, performing flexible control determination compatible with a request for generation of various virtual viewpoint images so as to increase the use cases to which the present system can be applied is described. FIG. 30 illustrates the flow of foreground image generation. Here, in generation of a virtual viewpoint image, an example of a guideline for selecting any one of a plurality of rendering algorithms so as to respond to a request corresponding to an image output destination is described.

First, the rendering mode management unit 03014 of the back-end server 270 determines a rendering method. The requirement item for determining the rendering method is set by the control station 310 to the back-end server 270. The rendering mode management unit 03014 determines the rendering method according to the requirement item. In step S03200, the rendering mode management unit 03014 checks whether a request prioritizing high-speed performance has been made in virtual viewpoint image generation performed by the back-end server 270 based on image capturing by the camera 112. The request prioritizing high-speed performance is equivalent to a request for low-delay image generation. If the result of checking in step S03200 is YES, then in step S03201, the rendering mode management unit 03014 enables IBR as the rendering method.

Next, in step S03202, the rendering mode management unit 03014 checks whether a request prioritizing the freedom of designation of a viewpoint concerning virtual viewpoint image generation has been made. If the result of checking in step S03202 is YES, then in step S03203, the rendering mode management unit 03014 enables MBR as the rendering method. Next, in step S03204, the rendering mode management unit 03014 checks whether a request prioritizing computational processing reduction has been made in virtual viewpoint image generation. The request prioritizing computational processing reduction is made, for example, in the case of configuring the system at low cost without using much computer resource. If the result of checking in step S03204 is YES, then in step S03205, the rendering mode management unit 03014 enables IBR as the rendering method. Next, in step S03206, the rendering mode management unit 03014 checks whether the number of cameras 112 used for virtual viewpoint image generation is equal to or greater than a threshold value. If the result of checking in step S03206 is YES, then in step S03207, the rendering mode management unit 03014 enables MBR as the rendering method.

In step S03208, the back-end server 270 determines which of MBR and IBR the rendering method is based on mode information managed by the rendering mode management unit 03014. Furthermore, in a case where none of processing operations in steps S03201, S03203, S03205, and S03207 is performed, a default rendering method, which is previously determined at the time of start-up of the system, is assumed to be used.

If, in step S03208, it is determined that the rendering method is model-based rendering (MBR in step S03208), then in step S03209, the foreground texture determination unit 03003 determines a foreground texture based on the foreground three-dimensional model and the foreground image group. Then, in step S03210, the foreground texture boundary color matching unit 03004 performs color matching of a boundary of the determined foreground texture. Since the texture of the foreground three-dimensional model is extracted from a plurality of images of the foreground image group, this color matching is performed to deal with a difference in texture color caused by a difference in image capturing state of each foreground image.

If, in step S03208, it is determined that the rendering method is image-based rendering (IBR in step S03208), then in step S03211, the virtual viewpoint foreground image generation unit 03005 performs geometric transform, such as perspective transformation, on each foreground image based on the virtual camera parameters and the foreground image group, thus generating a foreground image as viewed from a virtual viewpoint. Furthermore, the user can be allowed to optionally change the rendering method during operation of the system, or the system can be configured to change the rendering method according to the state of a virtual viewpoint. Moreover, rendering methods serving as candidates can be changed during operation of the system. This enables not only setting a rendering algorithm concerning generation of a virtual viewpoint image at the time of start-up but also changing the rendering algorithm according to the situation, so that various requests can be dealt with. Therefore, even when an image output destination requests a different requirement (for example, the priority of each parameter), such a requirement can be flexibly dealt with.

Furthermore, while, in the present exemplary embodiment, any one of IBR and MBR is used as the rendering method, the present exemplary embodiment is not limited to this, but, for example, a hybrid method using both methods can be used. In the case of using the hybrid method, the rendering mode management unit 03014 determines a plurality of generation methods to be used in each of a plurality of division regions obtained by dividing a virtual viewpoint image, based on information acquired by the data reception unit 03001. In other words, a partial region of a virtual viewpoint image for one frame can be generated based on MBR, and another partial region thereof can be generated based on IBR. For example, there is a method in which IBR is used for an object, for example, which is glossy, has no texture, or has a non-convex surface to avoid a decrease in the accuracy of a three-dimensional model and MBR is used for an object located close to a virtual viewpoint to prevent an image from becoming planar. Moreover, for example, with respect to an object located near the center of an image screen, which is intended to be displayed in a clear manner, an image can be generated based on MBR, and, with respect to an object located on the periphery, an image can be generated based on IBR to reduce a processing load. This enables controlling, in more detail, a processing load related to generation of a virtual viewpoint image and the image quality of the virtual viewpoint image.

Furthermore, while appropriate settings for the system, such as a gaze point, a camerawork, and transmission control may vary with games, if the operator manually performs the setting for the system each time a game takes place, the trouble of the operator may become large, so that simplification of the setting is required. Therefore, the image processing system 100 provides a contrivance for reducing the trouble of the operator, which performs setting of the system for generating a virtual viewpoint image, by automatically updating settings of devices targeted for setting changes. This contrivance is described as follows.

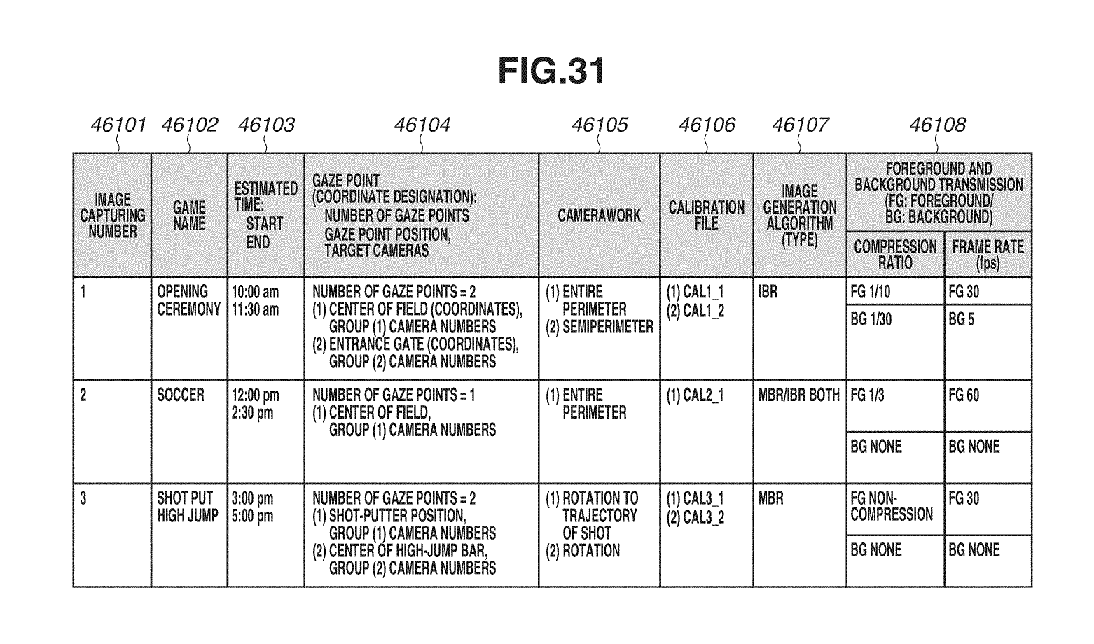

FIG. 31 illustrates an information list, which is generated in the above-mentioned post-installation workflow, concerning operations which are set to devices configuring the system in a pre-image capturing workflow. The control station 310 acquires game information concerning a game targeted for image capturing by a plurality of cameras 112 based on an input operation performed by the user. Furthermore, the method of acquiring the game information is not limited to this, but, for example, the control station 310 can acquire game information from another device. Then, the control station 310 associates the acquired game information with the setting information about the image processing system 100 and retains the associated pieces of information as the above-mentioned information list. Hereinafter, the information list concerning operations is referred to as a “setting list”. The control station 310 operates as a control device which performs setting processing of the system based on the retained setting list, so that the trouble of the operator, who performs setting of the system, can be reduced.

The game information, which the control station 310 acquires, includes at least one of, for example, the type and the start time of a game targeted for image capturing. However, the game information is not limited to this but can be other information concerning a game. Image capturing number 46101 indicates a scene corresponding to each game targeted for image capturing, and estimated time 46103 indicates estimated start time and estimated end time of each game. Prior to start time of each scene, a change request corresponding to the setting list is transmitted from the control station 310 to each device.

Game name 46102 indicates the name of each game type. Gaze point (coordinate designation) 46104 includes the number of gaze points of the cameras 112a to 112z, the coordinate position of each gaze point, and camera numbers corresponding to the respective gaze points. The image capturing direction of each camera 112 is determined according to the position of the corresponding gaze point. Camerawork 46105 indicates a range of camera paths taken when a virtual viewpoint is operated by the virtual camera operation UI 330 and the back-end server 270 to generate an image. A designation-allowable range of viewpoints concerning generation of a virtual viewpoint image is determined based on the camerawork 46105. Calibration file 46106 is a file in which values of camera parameters related to position adjustment of a plurality of cameras 112 concerning generation of a virtual viewpoint image, which are derived in the calibration during installation, are stored, and is generated for each gaze point.

Image generation algorithm 46107 indicates a setting as to which of IBR, MBR, and the hybrid method using both is used as the rendering method concerning generation of a virtual viewpoint image that is based on a captured image. The rendering method is set by the control station 310 to the back-end server 270. For example, game information indicating the type of a game corresponding to the number of players equal to or less than a threshold value, such as the shot put or high jump of “image capturing number=3” is associated with setting information indicating the MBR method, which generates a virtual viewpoint image using a three-dimensional model generated based on a captured image. This increases the freedom of designation of a viewpoint in a virtual viewpoint image of a game with a small number of participating players. On the other hand, in the case of a game with a large number of participating players, such as the opening ceremony of “image capturing number=1”, since generating a virtual viewpoint image using the MBR method causes a processing load to become large, the game information is associated with setting information indicating the IBR method, which is capable of generating a virtual viewpoint image with a smaller processing load.

Foreground and background transmission 46108 indicates settings of a compression ratio and a frame rate (the unit of which is fps) with respect to each of a foreground image (expressed as FG) and a background image (expressed as BG), which are separated from a captured image. Furthermore, the foreground image is a foreground image which is generated based on a foreground area extracted from a captured image to generate a virtual viewpoint image and which is transmitted inside the image processing system 100, and the background image is a background image which is similarly generated based on a background area extracted from a captured image and which is then similarly transmitted.

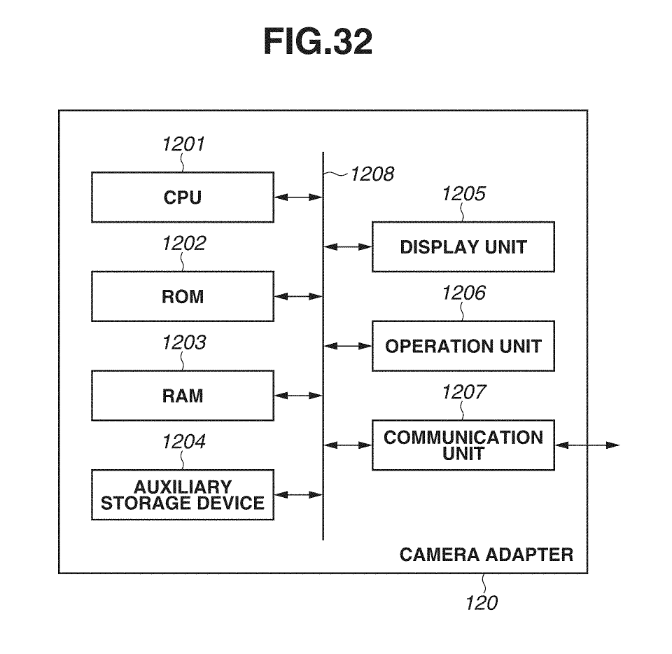

Next, a hardware configuration of each device configuring the present exemplary embodiment is described in more detail. As mentioned above, in the present exemplary embodiment, an example in which hardware, such as FPGA and/or ASIC, is mounted in the camera adapter 120 and each of the above-described processing operations is performed by such hardware has been mainly described. This also applies to various devices included in the sensor system 110, the front-end server 230, the database 250, the back-end server 270, and the controller 300. However, at least one of the above devices can be configured to perform processing in the present exemplary embodiment via software processing using, for example, a CPU, GPU, or DSP. FIG. 32 is a block diagram illustrating a hardware configuration of the camera adapter 120 used to implement the functional configuration illustrated in FIG. 2 via software processing. Furthermore, devices, such as the front-end server 230, the database 250, the back-end server 270, the control station 310, the virtual camera operation UI 330, and the end-user terminal 190, can be configured to have the hardware configuration illustrated in FIG. 32. The camera adapter 120 includes a CPU 1201, a ROM 1202, a RAM 1203, an auxiliary storage device 1204, a display unit 1205, an operation unit 1206, a communication unit 1207, and a bus 1208.

The CPU 1201 controls the entirety of the camera adapter 120 using a computer program and data stored in the ROM 1202 and the RAM 1203. The ROM 1202 stores a program and parameters which are not required to be changed. The RAM 1203 temporarily stores, for example, a program or data supplied from the auxiliary storage device 1204 and data supplied from outside via the communication unit 1207. The auxiliary storage device 1204 is configured with, for example, a hard disk drive, and stores content data, such as a still image or a moving image.

The display unit 1205 is configured with, for example, a liquid crystal display, and displays, for example, a graphical user interface (GUI) used for the user to operate the camera adapter 120. The operation unit 1206 is configured with, for example, a keyboard or a mouse, and inputs various instructions to the CPU 1201 in response to an operation performed by the user. The communication unit 1207 performs communication with an external device, such as the camera 112 or the front-end server 230. For example, in a case where the camera adapter 120 is connected to an external device via wired connection, for example, a local area network (LAN) cable is connected to the communication unit 1207. Furthermore, in a case where the camera adapter 120 has a function to perform wireless communication with an external device, the communication unit 1207 is equipped with an antenna. The bus 1208 is used to interconnect the various units of the camera adapter 120 and to transmit information.

Furthermore, for example, a part of processing to be performed by the camera adapter 120 can be performed by an FPGA, and another part of the processing can be performed by software processing with use of a CPU. Moreover, each constituent element of the camera adapter 120 illustrated in FIG. 32 can be configured with a single electronic circuit or can be configured with a plurality of electronic circuits. For example, the camera adapter 120 can include a plurality of electronic circuits operating as the CPU 1201. The plurality of electronic circuits concurrently performing processing to be performed by the CPU 1201 enables increasing the processing speed of the camera adapter 120.

Furthermore, while, in the present exemplary embodiment, the display unit 1205 and the operation unit 1206 are located inside the camera adapter 120, the camera adapter 120 does not need to include at least one of the display unit 1205 and the operation unit 1206. Moreover, at least one of the display unit 1205 and the operation unit 1206 can be located outside the camera adapter 120 as another device, and the CPU 1201 can operate as a display control unit which controls the display unit 1205 and as an operation control unit which controls the operation unit 1206.

The same applies to another device included in the image processing system 100. Moreover, for example, the front-end server 230, the database 250, and the back-end server 270 can be configured not to include the display unit 1205, and the control station 310, the virtual camera operation UI 330, and the end-user terminal 190 can be configured to include the display unit 1205. Furthermore, in the above-described exemplary embodiment, an example in which the image processing system 100 is installed at a facility, such as a sports arena or a concert hall, has been mainly described. Examples of the facility include an amusement park, a park, a racetrack, a bicycle racetrack, a casino, a swimming pool, a skating rink, a ski resort, and a live music club. Moreover, an event implemented in each of various facilities can be an indoor event or can be an outdoor event. Additionally, the facility in the present exemplary embodiment also includes a facility which is built on a temporary basis (for a limited time only).

Various embodiments of the present disclosure can also be implemented with use of a computer-readable program which implements one or more of the functions of the above-described exemplary embodiment. In other words, various embodiments can also be implemented by supplying a program to a system or apparatus via a network or a storage medium and causing one or more processors included in the system or apparatus to read out and execute the program. Furthermore, various embodiments can also be implemented by a circuit which implements one or more functions (for example, an ASIC).

As described above, according to the above-described exemplary embodiment, a virtual viewpoint image can be readily generated irrespective of, for example, the scale of an apparatus configuring the system, such as the number of cameras 112, and the output resolution or output frame rate of a captured image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the scope of the present invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-004681 filed Jan. 13, 2017, which is hereby incorporated by reference herein in its entirety.

What is claimed is:

1. An image processing apparatus comprising:
a generation unit configured to generate a virtual viewpoint image corresponding to a virtual viewpoint based on images captured from a plurality of viewpoints;
a storage unit configured to store, for each of a plurality of virtual viewpoints, a trajectory of previous movement of the each virtual viewpoint and information about a virtual viewpoint image corresponding to the each virtual viewpoint;
a search unit configured to search for a trajectory associated with a current virtual viewpoint image from previous trajectories stored in the storage unit, and obtain a search result comprising a plurality of trajectories;
an evaluation unit configured to make an evaluation of the search result obtained from the search for the associated trajectory conducted by the search unit; and
a selection unit configured to select, based on the evaluation, at least one trajectory from among the plurality of trajectories contained in the search result.

2. The image processing apparatus according to claim 1, further comprising:
a reception unit configured to receive an evaluation by a user of a virtual viewpoint image corresponding to a virtual viewpoint included in the trajectory associated with the current virtual viewpoint image;
an acquisition unit configured to acquire a feature of the corresponding virtual viewpoint image; and
a learning unit configured to learn a relationship between the feature of the corresponding virtual viewpoint image and the evaluation,
wherein the evaluation unit makes an evaluation of the trajectory based on the relationship, learned by the learning unit, between the feature of the virtual viewpoint image corresponding to the virtual viewpoint included in the associated trajectory and the evaluation.

3. The image processing apparatus according to claim 2, wherein the search unit searches for a trajectory associated with the current virtual viewpoint image from the previous trajectories based on the feature of the current virtual viewpoint image acquired by the acquisition unit.

4. The image processing apparatus according to claim 3, wherein the search unit searches for a trajectory including a virtual viewpoint image having a composition similar to that of the current virtual viewpoint image from the previous trajectories.

5. The image processing apparatus according to claim 3, wherein the search unit searches for a trajectory including a virtual viewpoint image of which a type of a targeted subject for image capturing is equal to that of the current virtual viewpoint image, from the previous trajectories.

6. The image processing apparatus according to claim 2, wherein the acquisition unit acquires, as the feature, an image feature from the current virtual viewpoint image.

7. The image processing apparatus according to claim 2, wherein the acquisition unit acquires, as the feature, an image feature from a plurality of virtual viewpoint images including the current virtual viewpoint image.

8. The image processing apparatus according to claim 2, wherein the acquisition unit acquires, as the feature, an image feature from a plurality of virtual viewpoint images based on which the current virtual viewpoint image was generated.

9. The image processing apparatus according to claim 6, wherein the acquisition unit acquires, as the image feature, a type of a subject.

10. The image processing apparatus according to claim 1, further comprising:
an operation determination unit configured to determine an operation which alters the current virtual viewpoint image based on the trajectory selected by the selection unit, as a recommended operation; and
a presentation unit configured to present information about the recommended operation to a user.

11. The image processing apparatus according to claim 10, wherein the presentation unit outputs the recommended operation to the user via display or sound.

12. The image processing apparatus according to claim 10, wherein the presentation unit displays a virtual viewpoint image obtained according to the recommended operation.

13. The image processing apparatus according to claim 10, further comprising an image determination unit configured to determine a targeted virtual viewpoint image based on the trajectory selected by the selection unit,
wherein the operation determination unit determines an operation which alters the current virtual viewpoint image to be the targeted virtual viewpoint image, as the recommended operation.

14. The image processing apparatus according to claim 13, further comprising an input unit configured to input context information concerning the virtual viewpoint image,
wherein the image determination unit determines the targeted virtual viewpoint image based on the context information and a virtual viewpoint image corresponding to a virtual viewpoint included in the selected trajectory.

15. The image processing apparatus according to claim 14, wherein the context information includes information concerning an image capturing target or an image capturing situation.

16. The image processing apparatus according to claim 1, further comprising an execution unit configured to execute an operation which varies the current virtual viewpoint image based on the trajectory selected by the selection unit.

17. An image processing method comprising:
generating a virtual viewpoint image corresponding to a virtual viewpoint based on images captured from a plurality of viewpoints;
storing, for each of a plurality of virtual viewpoints, a trajectory of previous movement of the each virtual viewpoint and information about a virtual viewpoint image corresponding to the each virtual viewpoint, in a storage unit;
searching for a trajectory associated with a current virtual viewpoint image from previous trajectories stored in the storage unit, and obtaining a search result comprising a plurality of trajectories;
making an evaluation of the search result obtained from the search for the associated trajectory; and
selecting, based on the evaluation, at least one trajectory from among the plurality of trajectories contained in the search result.

18. A non-transitory computer-readable storage medium storing computer-executable instructions that, when executed by a computer, cause the computer to perform an image processing method comprising:
generating a virtual viewpoint image corresponding to a virtual viewpoint based on images captured from a plurality of viewpoints;
storing, for each of a plurality of virtual viewpoints, a trajectory of previous movement of the each virtual viewpoint and information about a virtual viewpoint image corresponding to the each virtual viewpoint in a storage unit;
searching for a trajectory associated with a current virtual viewpoint image from previous trajectories stored in the storage unit, and obtaining a search result comprising a plurality of trajectories;
making an evaluation of the search result obtained from the search for the associated trajectory; and
selecting, based on the evaluation, at least one of the trajectories from among the plurality of trajectories contained in the search result.

19. An image processing system comprising:
the image processing apparatus according to claim 1;
a plurality of image capturing apparatuses configured to provide images captured from a plurality of viewpoints; and
a display device configured to display the virtual viewpoint image.
